(19) United States
(12) Patent Application Publication
(10) Pub. No.: US 2016/0093000 A1
(43) Pub. Date: Mar. 31, 2016

(54) NOVEL CLOUD-BASED ART INVENTORY MANAGEMENT SYSTEM, INCORPORATING TECHNIQUES, METHODS AND DEVICES

(71) Applicant: Collectrium Inc., New York, NY (US)

(72) Inventors: Boris Pevzner, New York, NY (US); Timothy Kompanchenko, New York, NY (US); David La Cross, New York, NY (US); David Romacho, New York, NY (US)

(21) Appl. No.: 14/863,428

(22) Filed: Sep. 23, 2015

Related U.S. Application Data
(60) Provisional application No. 62/055,335, filed on Sep. 25, 2014.

(51) Int. Cl. G06Q 50/00; H04L 29/08; G06Q 30/02

(52) U.S. Cl. CPC G06Q 50/01; G06Q 30/0278; G06Q 30/0206; H04L 67/10

(57) ABSTRACT

The present invention teaches a novel mobile-enabled secure, interactive, scalable, multi-platform cloud-based system for monitoring, managing, organizing, sharing, evaluating and/or promoting unique art objects, and the like, and interconnecting members of the art world, such as artists, galleries, museums, collectors, auction houses, art fairs, institutions, and art organizations. The cloud-based portfolio management tool provides unique capabilities for collectors to be able to engage interactively with their art, in a manner that permits the fusing of such management with market history and insurance data. Features include label generation upon recognition, capturing of screens, social media communications, virtually placing recognized art on real and/or virtual walls to provide augmented reality through virtual galleries, manual and automatic sizing of art work images, creating of virtual perspectives via tilting of a device camera, smart framing of art images, use of tags/markers, using place holders upon recognition of visual tags, scaling images of art works, automatic mirroring, and providing of financial data and summaries, including automatic conversions to users' home currency.

This application claims the benefit of priority pursuant to 35 U.S.C. 119(e) from a U.S. Provisional Patent Application having Application No. 62/055,335 filed Sep. 25, 2014, the text of which is fully incorporated by reference herein as if repeated below.

### BACKGROUND OF THE INVENTION

### Introduction

The present invention relates generally to the monitoring and management of art collections and their inventory, and more particularly to a novel secure, interactive, scalable, multi-platform cloud-based inventory management system with unique capabilities for collectors of art to be able to engage interactively with their art works in a manner that permits fusing of such management with market and insurance data. The present invention has been designed to change and improve upon the manner in which art collectors engage with their art works, virtually instantaneously visually fusing such works with valuable market and insurance data. Collectors are able to see at a glance the market value or worth of their art works, as well as the history associated with the works. This invention provides to collectors and their agents a highly valuable mobile art portfolio analysis tool capable of use with mobile devices such as, without limitation, iPads and the like.

Our invention further facilitates enhanced peer to peer trading of art, incorporating and enjoying the demanded confidentiality and security features prevalent and accepted in the often anonymous private marketplace of the art world. Privacy is protected.

By providing the foregoing, the present invention yet further provides the ability to overcome concerns, such as attempting to identify art works in portfolios, understanding changes in the value of art works needed to be insured and their potential impact upon insurance premiums, understanding the nature and content of what art works are in storage at any given time, and the impact upon bankers seeking to understand and evaluate the financial implications of fluid market valuations.

As will be described below, this invention provides recognition technology that permits virtual viewing of art object on collectors' walls and in their spaces, including the capability to virtually re-size, perspective-adjust, and move about such works.

The references herein to art and art works are meant to mean and include, by way of example and without limitation, paintings, sculptures, posters, and a host of other original valuable art and decorative objects which may be pari of limited or unlimited editions. The system according to the present invention is adapted to interconnect members of the art world, whose artists, galleries, collectors, museums, art fairs, and art organizations have a genuine need for the benefits provided here. Users of the system of the present invention will be better able to organize, seek, discover, share, evaluate, and promote art. The present system can be used via the Web and/or with mobile devices, and provides support for private-labeling and secure application programming interface (API)-level access.

It is contemplated that the system according to the present invention will be used by and will benefit, among others, collectors of art, art dealers, art galleries, art fairs, auction organizations, museums, insurance organizations, storage entities, framers, shippers, appraisers, public relations experts, bankers and financial institutions, wealth management individuals and entities, and contemporary art networks. The present invention has the potential to revolutionize the manner in which such individuals and organizations interact with one another and with others within their own organizations.

While the present patent specification is being written to describe, by way of example only, a cloud-based inventory management system for use with art objects, such as unique one-of-a-kind fine art, it is within the scope of the present invention for this novel system to be used to manage other tangible and intangible objects and properties.

It is emphasized here that the art objects to be managed are themselves unique, and not fungible. It is suggested, without limitation, for purposes of this specification, that the system according to the present invention actually comprises multiple systems, techniques, methods and devices which to some may be characterized as coming under the umbrellas of software, data and sendees. The present invention provides an enhanced user friendly cloud-based capability in its use with mobile devices such as, without limitation, tablets and smartphones, operating on any number of platforms, such as by way of example only, iPhones and iPads and Android devices.

The present invention has been designed to assist the aforementioned members of the art world with curator issues, invoices, insurance, dimensioning, cataloguing, brokering, shipping, consignments, loans, sales, purchases, restoration, exhibitions, visualizing, financial management, valuation, appraisals, public relations, making of offers, customer relations, framing, ownership factors, and dealership issues, to name but a few as examples.

### Prior Art

Systems or products exist which purport to provide art management and art inventory-capabilities, but which do not provide the novel combination of features associated with the present invention. These have not been studied in-depth or evaluated, but are presented here to illustrate information of interest only, and what is apparently commercially available via the Internet. By way of example, Artwork Archive purports to provide art inventory software for artists and collectors. Its Website is located at https://www.artworkarchive.com. Xanadu promotes “ARTsala,” which was previously known as ArtTracker, at its Website located at www.xanadugallery.com/arttracker/. GalleryManager, located at www.gallerymanager.com, advertises software which promises inventory management from a Web-based perspective. Managed Artwork, found at www.managedartwork.com/inventorymanagement.cfm advertises software to be used by galleries and artists for providing art inventory management on a relatively primitive scale when compared to the features of the present invention. My Art Collection, located at www.my-artcollection.com, promises to manage one's art collection. ArtVault Software, located at www.artvaultsoftware.com, advertises art collection software for use by galleries, museums, institutions, collectors and artists.

Another company of which the inventors herein are aware is Collector Systems, located at http://www.collectorsystems.com/. It purports to include a cloud-based system established in 2004. It does not teach, provide to its users, or suggest, the novel combination of features of the present invention.

In addition to the foregoing, patents have been issued by the U.S. Patent and Trademark Office for software and hardware combinations used in non-relevant inventory management. No known patents disclose and claim the combination of novel features of the present invention.

Examples of prior art inventory-related patents, not relevant to the invention disclosed and claimed herein, are U.S. Pat. No. 7,548,878 entitled Software and Hardware Component Audit and Inventory Management System, granted on Jun. 16, 2009 to O'Halloran, et al., and the following U.S. patents cited therein: U.S. Pat. No. 4,456,790; 4,887,206; 5,285,494; 5,717,595; 5,761,432; 5,832,511; 5,870558; 5,951,642; 5,958,012; 6,021,492; 6,073,214; 6,346,885; 6530,018; 6,664,897; 6,694,359; 6,694,366; 6,735,498; 6,779,024; and 6,844,813. Copies of these patents should be available to the reader at www.uspto.gov.

While the aforementioned prior art may be interesting, none, either taken alone or in any combination with one another, provide the many advantages of the novel methods and techniques of the present invention. And it is fair to say that the current state of the art of inventory management approaches are relatively antiquated, being localized and often based upon desktop Filemaker database-based systems.

### Note

This specification, taken together with the accompanying drawings, FIGS. 1-141, attempt to provide for the reader an omnibus collection of features of the present invention. One skilled in the art will be able to view and understand the drawings, without the need for excessive unnecessary narrative. Without implying relative degrees of importance, features of the present invention are set forth herein corresponding to the order of the drawings annexed hereto. The reader should not interpret their order as order of importance.

The drawings include photographs, graphics, and captured screen shots from both mobile devices and desktop computers on which access to Websites have enabled use of the subject system.

Throughout the drawings and this description, reference has been made to “Collectrium, Inc.,” the entity to which the present invention has been assigned and which has been authorized by the inventors to commercialize the invention. The use of Collectrium to illustrate features should merely be construed as an example of a user of the present system, without limitation.

Where the drawings include text and descriptive indicia, this specification has not been burdened with repeating said information.

### BRIEF SUMMARY OF THE INVENTION

The present invention has been designed to change and improve upon the manner in which art collectors engage with their art works and the fusion of such art works with data available in the marketplace. Collectors are able to see at a glance the market value or worth of their art works, as well as the history associated with the works. This invention provides to the collector an art portfolio analysis tool. From a technical standpoint, the present invention contemplates a novel cloud-based mobile-enabled secure, interactive, scalable, multi-platform system capable of managing, organizing, seeking, discovering, sharing, evaluating and/or promoting unique art objects, and the like, and interconnecting members of the art world, such as, without limitation, artists, galleries, museums, collectors, art fairs, and art organizations and institutions. In general terms, the system comprises (a) unique and novel software, which provides functionality, (b) data which augments user data with that in the system's database, and (c) real time synchronized services. A user friendly interface provides an efficient and effective visual experience and ease of use.

Collectors are able to organize their collections with secure access from anywhere at any time. They will be able to more easily discover new art works for possible acquisition, and will be able to easily interact with increasing numbers of other collectors who may enjoy matching art interests.

Galleries and dealers are able to track their inventories and client bases. Similarly, they are able to easily track art shows and art fairs. New client leads are made more accessible. Mobile apps are “white-labeled” so as to be customized within a private label environment. Examples of reputable galleries whose activities may be helped by the system according to the present invention include: David Zwirner, Tony Shafrazi, Casey Kaplan, Mike Weiss, Gazelli Art House, Lisson Gallery, Hauser & Wirth, David Nolan, Eli Klein, David Lusk, Heather James, Jen Bekman Projects, Hamiltonian Gallery, PUF Art Scandinavia, DeBuck Gallery, Ethan Cohen, Amstel Gallery, Ricco Maresca Gallery, Mindy Solomon, Samuel Owen Gallery, and thousands more.

Fairs and exhibitions are able to publish their inventories on art fair sites and apps, with online reservations enabled. Integrated social networking data tracking permits views and reviews, “likes,” and published comments. Examples of art fairs include, in no special order of importance, VOLATA, NADA, Art Amsterdam, Art San Diego, Art Stage Singapore, Art Moscow, Arte BA, ZONA MACO, SP Arte, SOFA, Art Expo Chicago, Metro Show NYC, SCOPE, Art Asia, Aqua Miami, Contemporary Istanbul, PULSE, (e)merge, Art Hamptons, SF Fine Art, Art Paris, Houston Fine Art, Olympia Fine Art & Antiques, Art Miami, and United Art Fair India, to name but a few.

Partners and other channels facilitated by the system according to the present invention include insurance companies, appraisers, movers, storage facilities, photographers, catalogers, cleaning and restoration services, and wealth management financial and legal practitioners.

The present invention provides novel methods and techniques for utilizing mobile devices such as tablets and/or smartphones, as can be seen in the accompanying drawings and descriptions thereof.

### DESCRIPTION OF THE DRAWINGS/FIGURES

FIG. 1 is a perspective schematic representation of aspects of the art world favorably interactively affected by features of the present invention;

FIG. 2 is a graphical representation illustrating the interconnection of “partnership” relationships possible with the present invention, including graphical representations of what are referred to as accession and deaccession considerations;

FIG. 3 illustrates graphically the tool, inventory and monetization factors enjoyed by the commercializing entity Collectrium, Inc., utilizing the system according to the present invention;

FIG. 4 is a graphical illustration of Collectrium's technical architecture possible with the system according to the present invention;

FIG. 5 illustrates the enterprise-grade security processes enjoyed at every level by the system according to the present invention;

FIG. 6 is an illustration of an iPad's use of what has been coined as the term “augmented reality”, wherein the camera of the iPad is utilized in a manner described below;

FIG. 7 graphically illustrates the “flow” of a preferred process according to the present invention, wherein the steps of acquisition, analysis and planning, transformation and transcription, data loading and questions and answers, and acceptance are carried through three (3) tiers, Tiers 1, 2 and 3;

FIG. 8 is an illustration of the present system's scalability, including references to the roles of resources and tools;

FIG. 9 illustrates planned Tier 1 improvements possible with the system according to the present invention;

FIG. 10 illustrates planned Tier 2 improvements possible with the system according to the present invention;

FIG. 11 illustrates planned Tier 3 improvements possible with the system according to the present invention;

FIG. 12 is an illustration of representative Tier 1 case study onboarding of a New York gallery client X into the system according to the present invention;

FIG. 13 is an illustration of a representative Tier 1 case study onboarding of a Chicago gallery client Y into the system according to the present invention;

FIG. 14 is an illustration of a representative Tier III case study onboarding of a private family collection client Z into the system according to the present invention;

FIG. 15 is a graphical illustration of a typical inventive system master job which monitors and runs transformations on source data, with error reporting;

FIG. 16 illustrates an example of a Kettle ETL detail view of a typical inventive system transformation process step, in which data is extracted from a source, problematic characters are stripped, and system user-specific identifications are created and mapped to the target structure;

FIG. 17 illustrates the augmenting of a system user experience with art market data which might be publicly available from a variety of sources;

FIG. 18 is an overview graphical flow illustration of data gathering methods capable of use with the system according to the present invention;

FIG. 19 is an illustration of a Diego oil art work auction result data record, to be used with the system according to the present invention;

FIG. 20 illustrates technology data gathering methods using the inventive system, including the use of “agents” and design goals;

FIG. 21, further to FIG. 20, illustrates additional data gathering methods using target sites;

FIG. 22 illustrates the inventive system's use of extended artist biographical data, using the artist Andy Warhol as an example;

FIG. 23, further to FIG. 22, illustrates an sample Andy Warhol database record;

FIG. 24 illustrates a sample auction results record within the inventive system, wherein the work of artist Alberto Giacometti is shown;

FIG. 25 is an illustration of what the system identifies as an “about” record, wherein data relating to the artist Alberto Giacometti is set forth using various forms of media;

FIG. 26 is an illustration similar to that of FIG. 25, setting forth “news” directed to the artist Alberto Giacometti;

FIG. 27 illustrates inventive system reference data API, wherein methods are described for accessing information about artists, auction results, galleries and other art-industry service providers;

FIG. 28 is a tabular illustration setting forth available resources for collecting reference data to be used in the system according to the present invention;

FIG. 29 illustrates examples of inventive system API requests and user goals;

FIGS. 30 through 40 are meant to illustrate features of the present invention associated with the attribute “Identify,” selected from the system software's home screen, illustrated below;

FIG. 30 is an illustration of a user of the subject system raising an iPad Mini in front of a wall on which a work of art is situated above a tag (marker);

FIG. 31 is a close-up of the iPad Mini's screen on which the art work of FIG. 30 appears on the device's screen and has been recognized by the system's software database;

FIG. 32 is a view similar to that of FIG. 31, wherein the device is close enough to the work of art that the system will permit its recognition;

FIG. 33 is a view similar to that of FIG. 32, but where the work of art has been recognized by the system according to the present invention, and has also generated a label beneath the work's image, setting forth predetermined information from the system's database; note the user's thumb touching (clicking on) the work's image;

FIG. 34 illustrates the result of the user's touching of the work's image in FIG. 33, resulting in the popping up of a great deal more information about the subject work of art. This additional information may, for example, include the full name of the artist, the title of the work of art, the date the work was created, the medium in which the art was created, the dimensions of the work, a summary/provenance associated with the work, and an optional artist biography that has been created in the style and format the system has been programmed to define.

FIG. 35 is an illustration similar to FIG. 34, but with the user's finger in the process of clicking on a camera icon virtual shutter button, thereby permitting the capturing of the screen image containing information. Similarly, in FIG. 36 there is an illustration of how the user's finger is clicking on an email icon (beneath the user's finger but not visible here), thereby facilitating the sending of an email copy of the captured image to a recipient, such as the sending of an email by an Agent to a client Collector or a specialist. FIG. 37 is an alternative view similar to that of FIG. 36, but showing the remote device in the hands of a user, with the art image on the screen. FIG. 38 is yet another alternative view similar to FIG. 37.

FIG. 39 is presented to illustrate the ability of the user to click on a “Favorites” virtual button, to thereby add that link. And FIG. 40 is simply another view of the device, showing the art work and label on the screen;

In FIG. 41, an effort is made to illustrate the system software's home page menu, organized by common attributes. That menu is visible in similar view FIG. 42, wherein a “Groups” menu choice has been clicked and the art work groupings have popped up along the left side of the screen. FIG. 43 is a view similar to that of FIG. 41, wherein an effort has been made to be able to discern the menu items more clearly,

At this point of the user's surveying of a gallery, for example, he may want to call up a work of art that has been in a collector's collection. FIG. 44 is an illustration wherein the particular work of Senza Titolo No. 1 (1989) has been selected by the user. This selection has been made merely as a representative example. Any one or more other works may be selected. At this point, the user would like to see what that selected work would look like on a wall in the room where the user is located. FIG. 45 illustrates the user virtually placing the selected work of art on such a real wall of the room, thereby trying out how to the eye of the user the work would look on that wall. That work, when selected, was not framed, and the user may wish to view the work framed when virtually placed upon the wall. With this in mind, FIG. 46 illustrates the system's user selecting a virtual frame for that work of art from a frame collection in the database depicted in thumbnail images along the bottom of the iPad's screen. Any number of frame designs and styles may be stored in the system's database for these purposes.

Now that the user has chosen the work and has chosen the frame for that work, the size of the framed work may not be appropriate or desired by the user. He may wish to size or re-size that framed image. FIG. 47 illustrates the system user's manually changing the size of the virtual framed work on the wall image, via spreading/contracting the thumb and forefinger. This manual manipulation of the image size is but one choice for this system. In addition to this technique of manually sizing, the scope of the system of this invention contemplates relatively “automatic” sizing by way of the use of a tag (or marker, illustrated and described in more detail below) and/or by use of camera trigonometric ratios and triangulation (capitalizing upon knowledge of the distance from the camera to the wall, the height, and the tilting of the camera);

FIG. 48 illustrates the finally framed and sized virtual image of the work on the room wall, with an ability of the user to capture that total image for archiving or transmittal via email or other social media to persons of interest, such as a client Collector. FIG. 49 is another view of the finally framed and sized virtual image of the work virtually “installed” on the wall;

Reference to a tag or marker has previously been made. It is within the scope of this invention to create or assemble a “family” of tags of different sizes, corresponding to the different sizes of works of art to be included and used with this system. FIGS. 50 and 51 taken together represent photographs of an example of a tag (or marker) of known, size, which has been referred to with respect to FIG. 47 above. This tag and its dimensions have been stored in the system's database, for these purposes. Before discussing more about the use of tags according to the present invention, FIGS. 50 and 51 show a system user virtually placing an art work, image onto a “camera roll” image of a wall that has been stored in the user's database, rather than a live real wall. This permits virtually “hanging” a semi-transparent image of the work (to aid in more accurate placement and its visualization) while simultaneously in real time compensating for the viewing angle of the wall through camera tilting, providing a perspective view of the art image, and allowing ambient conformity or coordination of the virtual work's image with its virtual surroundings. We thus see in this paragraph that the inventive system is able to create a virtual gallery, with semi-transparent images of works, while providing perspective compensation of a viewing angle, and also providing a blending of the framed work with ambient surroundings of either a real or a virtual room.

Turning now back to the tags, FIGS. 52 through 60 provide illustrations of the use of tags (markers) in accordance with the virtual gallery features of the system of the present invention. FIG. 52 is presented to once again illustrate the home screen of a beta version of the system software according to the present invention, with a menu item “Virtual Gallery” shown;

FIG. 53 illustrates the Virtual Gallery having been selected by the user by clicking on that menu item, and with the system user placing a tag on the wall within the field of view of the iPad Mini's camera. FIG. 54 illustrates the system's “recognition” of the tag of FIG. 53 by the invention system, and its putting a “place holder” into the spot on the iPad screen previously occupied by an image of that tag. The popping up of the place holder signals to the user that the tag has been recognized by the system, with the resulting change in the screen's image from that of the tag to that of the place holder. FIG. 54 also illustrates the user's thumb in the process of its selecting an image of a work of art from the system's database collection, shown in thumbnail images along the bottom of the screen.

FIG. 55 illustrates the user having slid a thumbnail image of a stored work of art from the bottom of the screen to and over the place holder on the iPad Mini's screen, such that a larger clearer image of the art work now occupies the place formerly held by the place holder. Both the thumbnail image of the selected art work and its larger now centrally located image on the iPad's screen can be seen in FIG. 55, thus further illustrating a keying or assignment of that work's image to the tag in question. The size of the tag corresponds to the size of that work.

FIG. 56 is presented to illustrate the system user's ability to now frame the selected art work from a database inventory of frames, shown along the bottom of the iPad screen. After sliding a chosen frame from the thumbnail to the center of the screen occupied by a larger image of the work, the chosen frame “attaches” to the work. FIG. 57 shows the iPad screen with the art work framed and scaled in size, due to predetermined knowledge and correlation of the tag's dimensions.

FIG. 58 illustrates an application of what will be referred to here as “Augmented Reality,” which denotes a virtual placing of a dynamically framed art work on the location of a wall where a tag has been placed, thereby permitting the user to view and photograph the virtual image for then current real time use or for later use by the user and/or an Agent working with a client/Collector. FIG. 59 illustrates a system user having clicked on a camera icon in order to record the augmented reality virtual image of the art work on the wall, as described above. And FIG. 60 illustrates the dynamically virtually framed image resulting from “smart framing;”

FIGS. 61-141 are presented to illustrate computer screen shots of the system software according to the present invention, depicting features of the inventory management Website's aspects of this invention, and include, for example in FIG. 61 a screen image of an eclectic collector's art collection, including art, designs, and furnishings;

FIGS. 62-141 are presented to illustrate the results of a system user progressively clicking on menu items provided by the present invention, and include bold red arrows to identify the portion(s) of screen shots accessible to the user. Adjacent Figs. correspond in a number of instances to the result of a user's clicking on the item to which the bold red arrow points.

FIG. 142 is an illustration of a screen shot in which the user of the present invention is able to click on “consignments” in order to have access to consignment data of interest.

As will be obvious from examining the Figs., a number of them include camera photographs of an individual using the system with a mini iPad. Other Figs, are camera photographs of what appears on the screen of the mini iPad. In an effort to help the reader ascertain some, not all, of the text that appears on the mini iPad screen, care has been taken to replace such text or using arrows point to such text with reference numbers. These reference numbers are set forth in the attached Appendix A, which is a two-column table in which the left column contains such reference numbers, and the right column contains text corresponding to the location of the reference numbers in the Figs. No effort has been made to do so for all text on screens, since it is not necessary to understand the present invention. The most obvious illustration of this is text in data streams.

### DETAILED DESCRIPTION OF THE INVENTION

### The Art Markets

It is estimated that art work currently in the hands of private collectors now exceeds two trillion dollars. Global art markets which have impact upon such art work are complex, diverse, lucrative and are rapidly growing in size and stature. The growth of these art markets are fueled by increasing numbers of new collectors in emerging markets. By some estimates, such growth may have reached 10-12% annually.

Primary and secondary art markets, as a whole, while perhaps representing one of the last large legal unregulated markets, are fragmented. By some estimates, there currently are in excess of thirty thousand (30,000) fine art galleries and some three hundred thousand (300,000) small art and collectibles dealers. The number of art fairs has grown to some two hundred (200), and there are more than three thousand (3,000) regional art festivals. These markets are relatively inefficient, rather opaque in that their inventories are largely hidden from view, and are underserved by state of the art technology. Buyers and sellers are haphazardly matched or mismatched.

There is a need for a mobile-enabled, secure, scalable, multi-platform cloud-based system capable of managing, organizing, seeking, discovering, sharing, evaluating and/or promoting unique art objects, and the like, and interconnecting members of the art world, such as, without limitation, artists, galleries, museums, collectors, art fairs, and art organizations and institutions. This need requires secure, controlled access, with greater degrees of transparency.

### Discission of Art Management Features

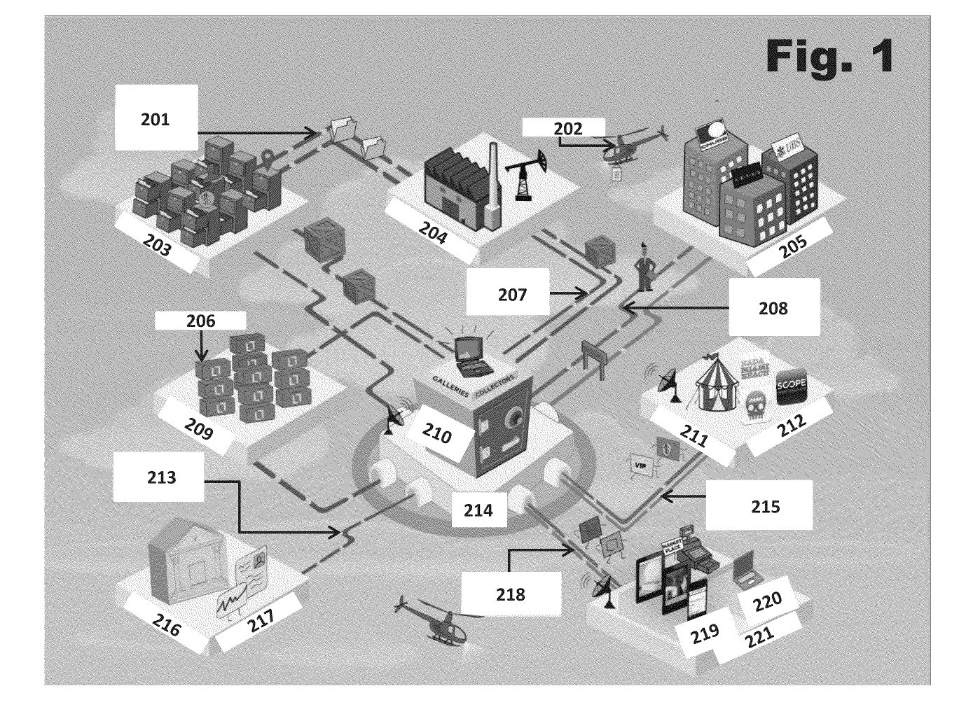

Referring now in a bit more detail to the drawings, FIG. 1 is meant to illustrate the interactivity that can and does occur between elements of the art market. Galleries and collectors are shown at the “hub” of activity, linked by two-way highways with art fairs and exhibitions, what are referred to as “partners,” not to be confused with the legal definition of that term, data processing, a database of artwork data, backup systems, and reports and provenance. There is no legal connection between users of the present invention and such partners. The database is adapted to contain price histories of works, an inventory of images, provenance, exhibition and auction histories, social data, news stories, commentary, and many other categories of useful information to be tapped into using the system according to the present invention.

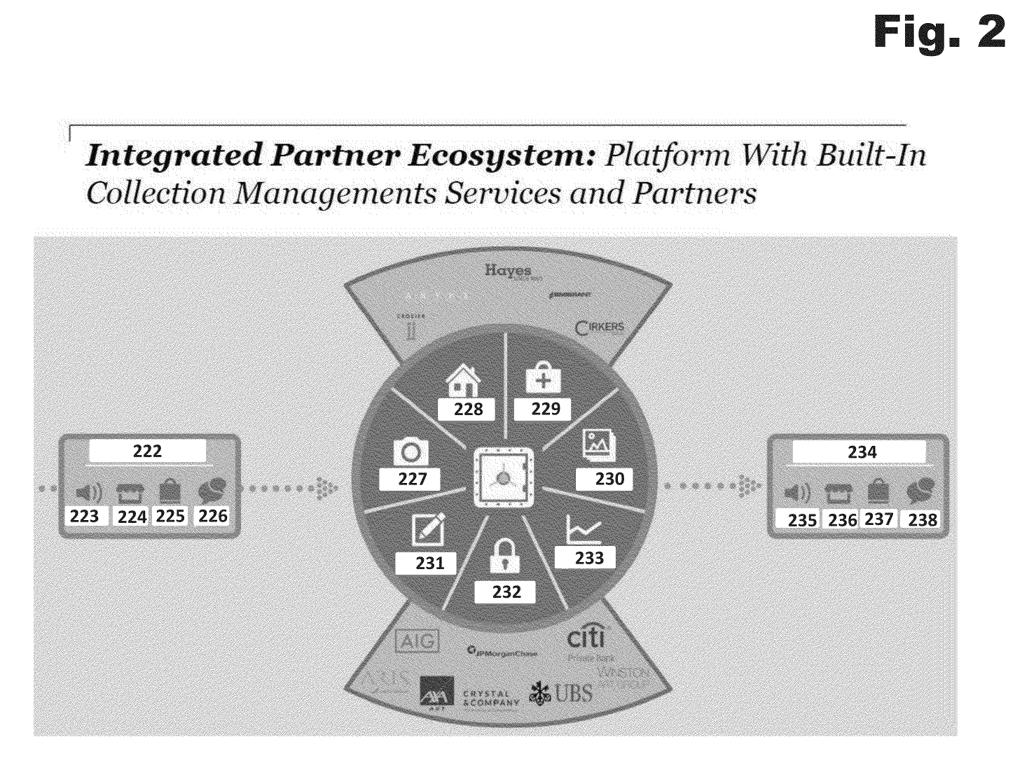

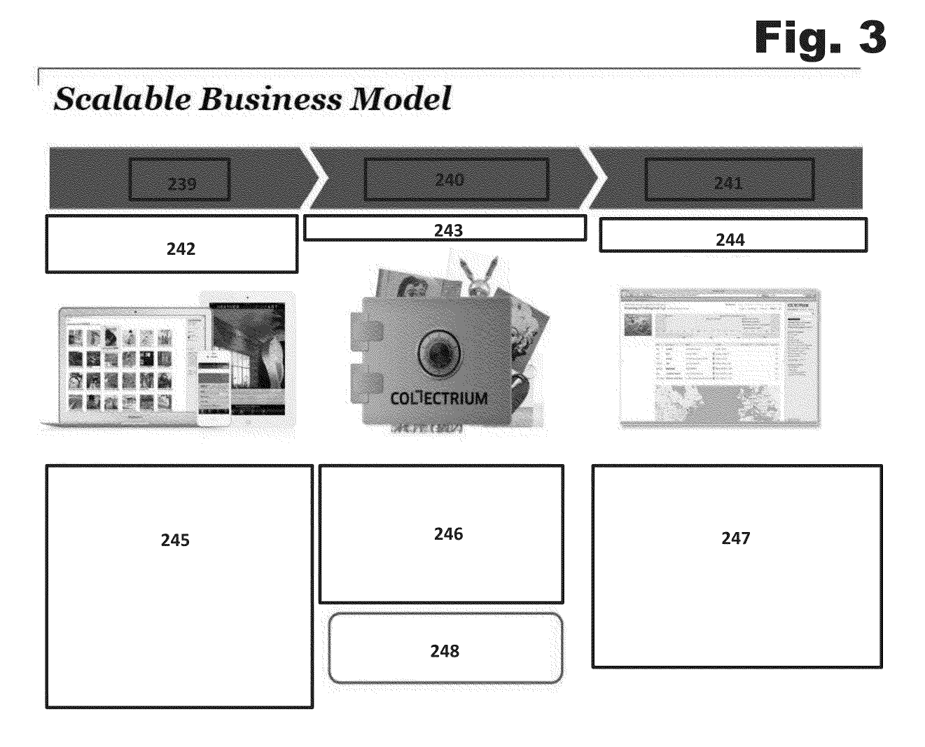

FIG. 2 illustrates the types of partners users of the present system may interact with. They include shipping and storage entities, cleaning and restoration services, art fairs, exhibitions, financial management experts, insurance companies, experts skilled in appraisals and valuations, and photographers, to name but a few by way of example. Accession, or the acquisition of art works, will involve auction purchases, gifts, galleries and dealers, and private purchases. On the other end, deaccession will involve the auctioning off of parts of a collection, gifting, galleries, dealers, and the private sales of art works. It is emphasized here that users of the present invention will be able to cooperate and interact with these “partners” in a far more effective manner, due to the presence of novel features of the invention.

FIG. 3 illustrates the manner in which the present invention provides tools for members of the art world, an enormous database of art information, and access to secondary market transactions for art collectors, galleries, dealers and artists. In FIG. 3, the factors enjoyed by the commercializing entity Collectrium are graphically presented.

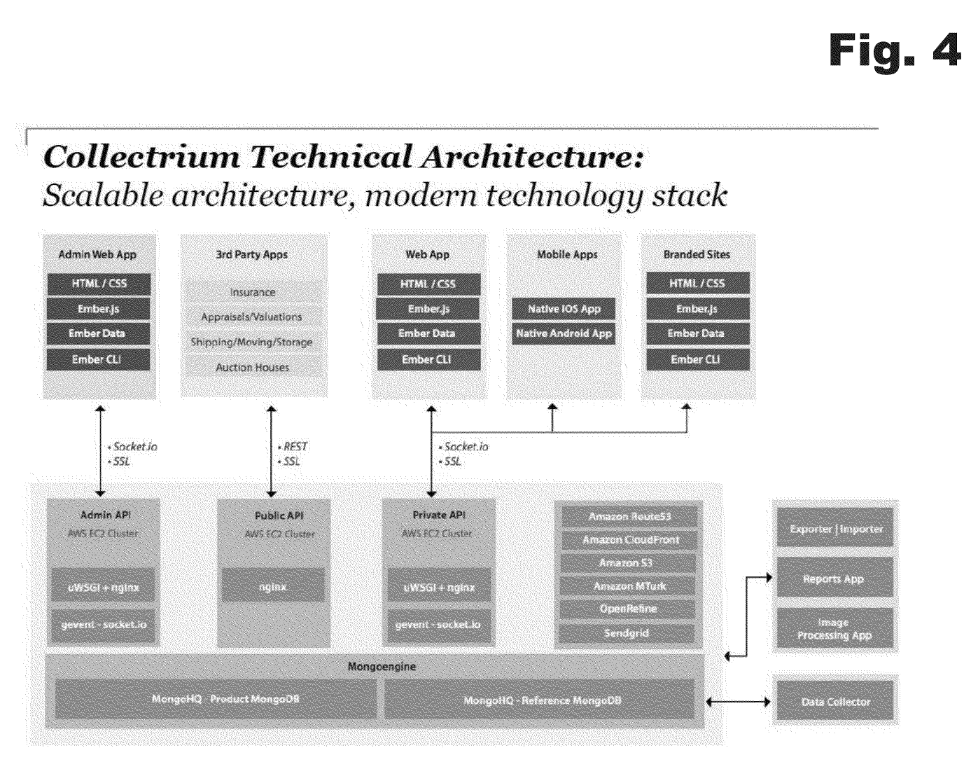

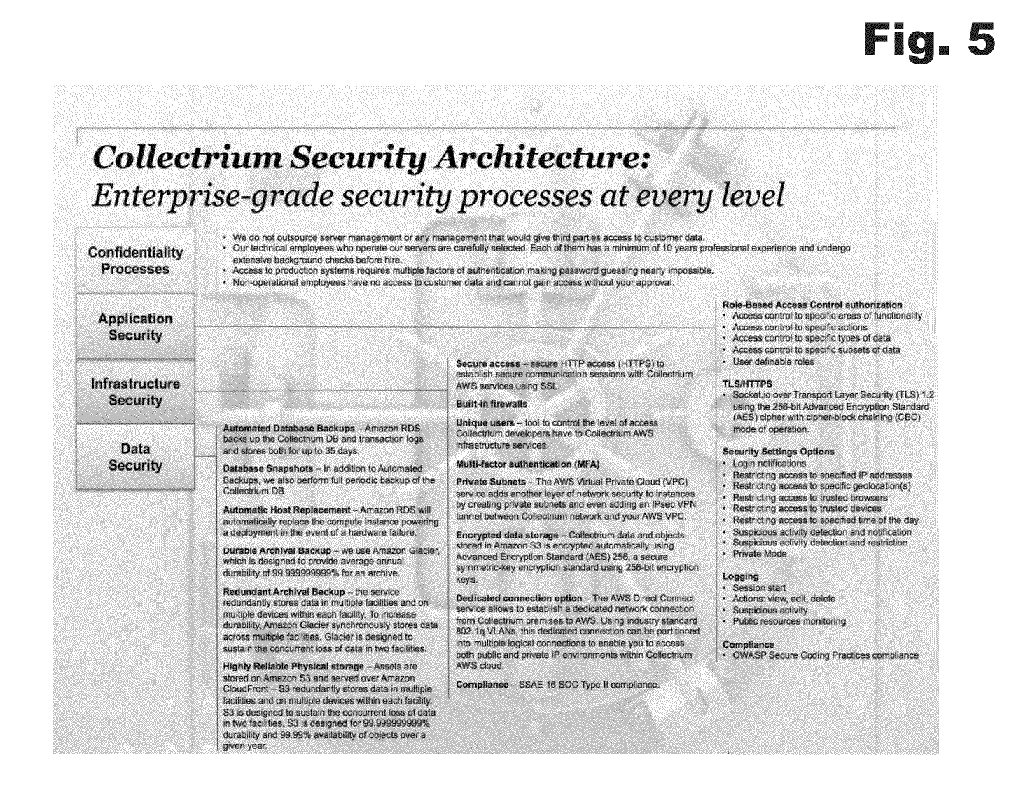

The scalable technical architecture associated with the present invention is graphically illustrated in FIG. 4. Similarly, the enterprise-grade security architecture of the subject system is confirmed and elaborated upon within FIG, 5.

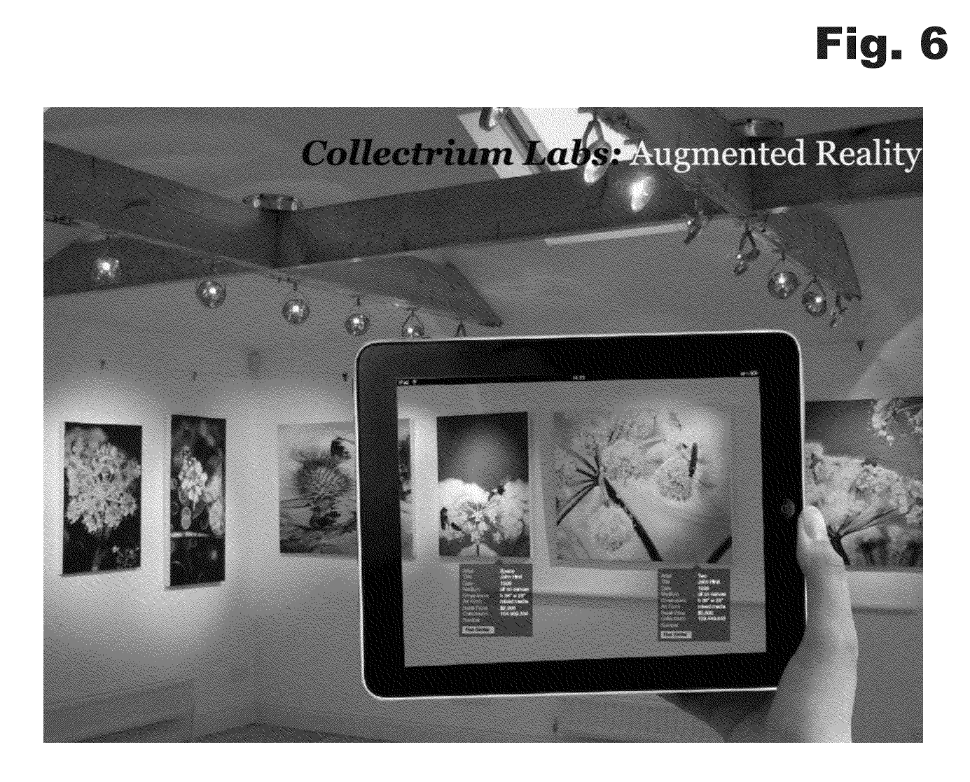

The present invention utilizes mobile devices, such as tablets and smartphones, for example. No preference between Apple, Android, or other platform is made here, although, for ease of presentation in this specification, an iPad is used throughout many of the drawings. A full size iPad table is shown in FIG. 6 in connection with what is referred to herein and in the claims as “augmented reality.” The use of an iPad is illustrated in more detail in the drawings, by way of the commercially available computer program known as “Jing” capturing of paused video images.

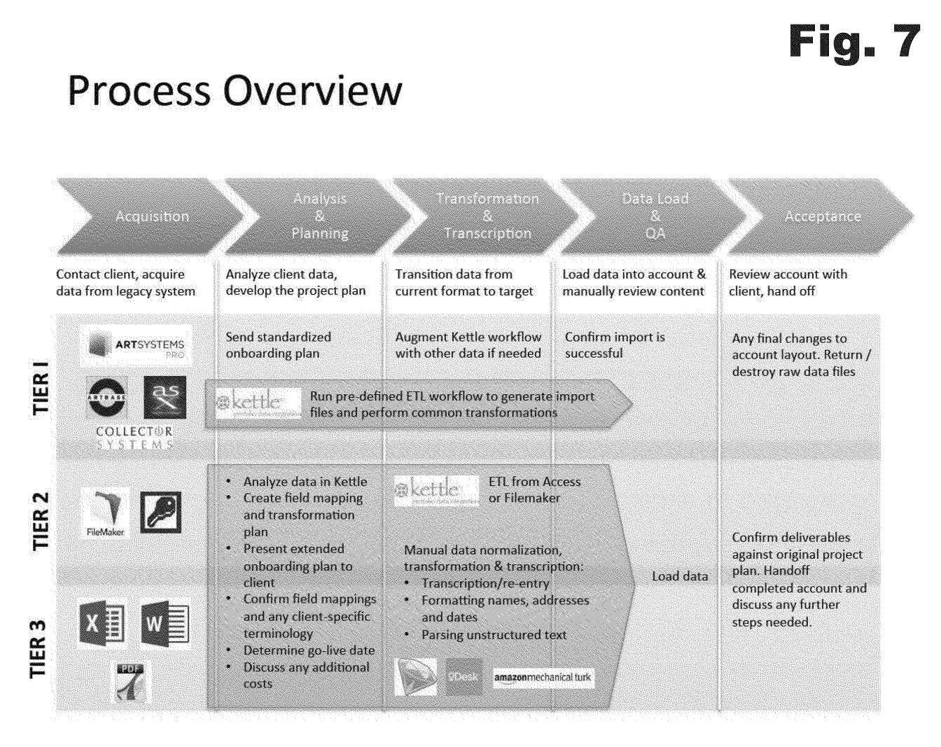

The process flow associated with the present invention is illustrated in FIG. 7, including the steps of acquisition, analysis and planning, transformation and transcription, data loading and questions and answers, and acceptance. These steps are carried through three Tiers 1, 2 and 3.

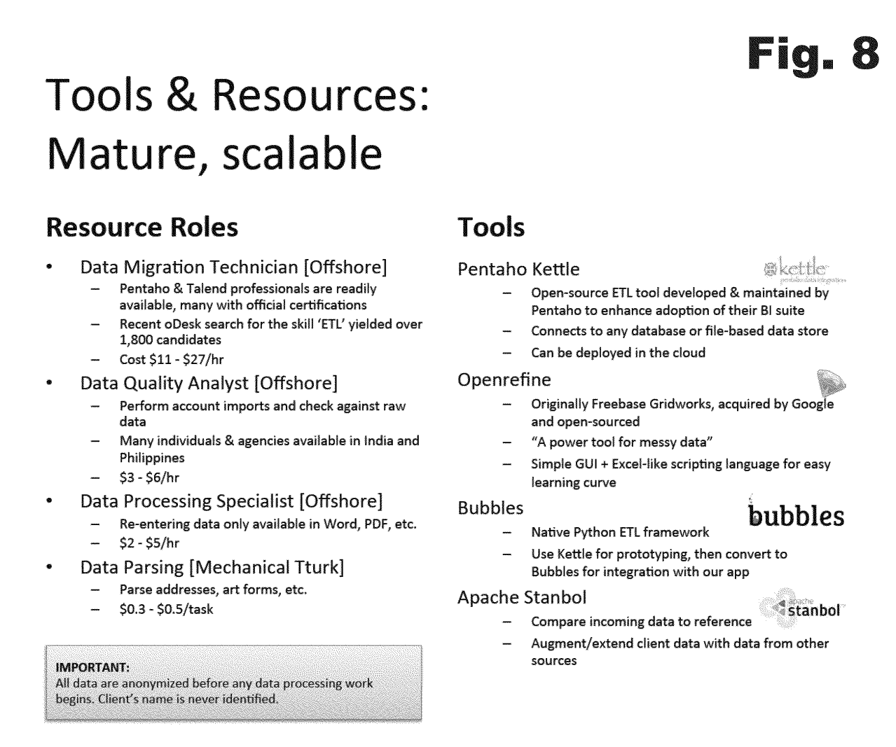

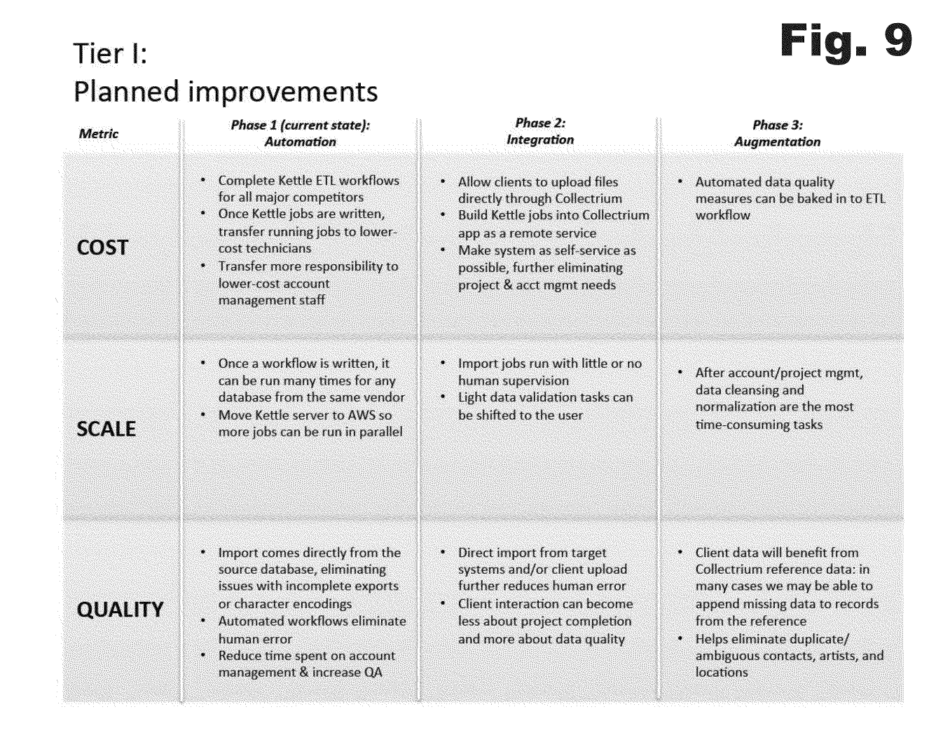

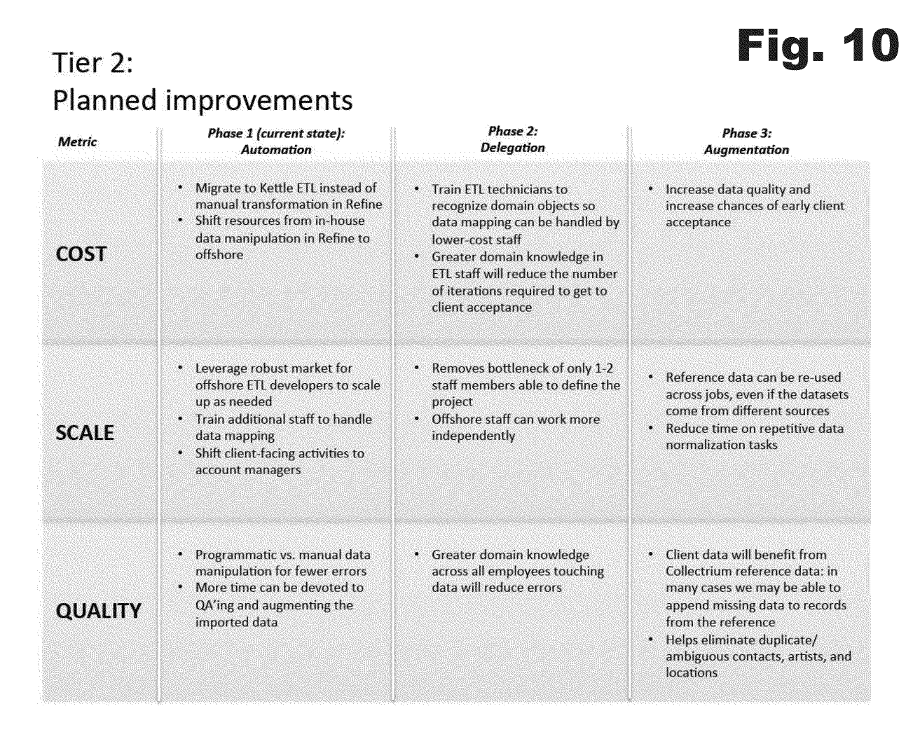

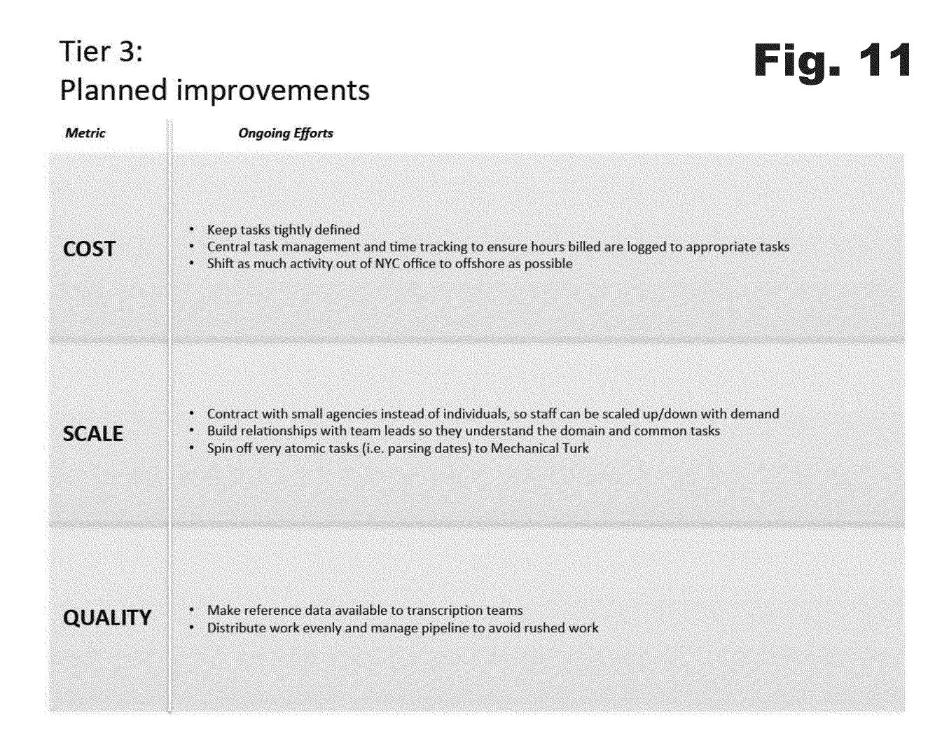

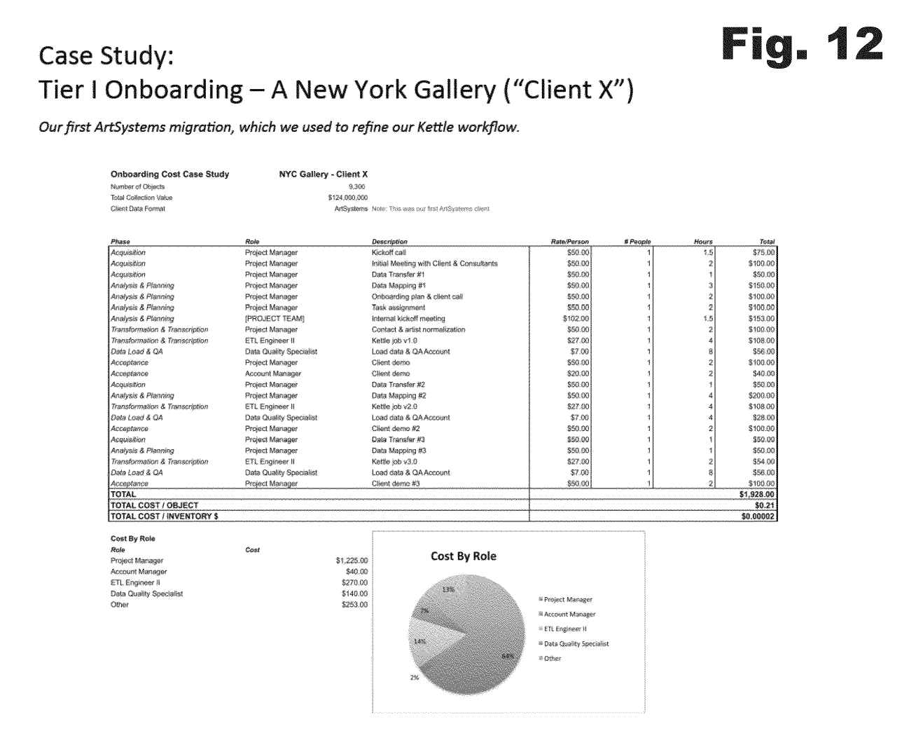

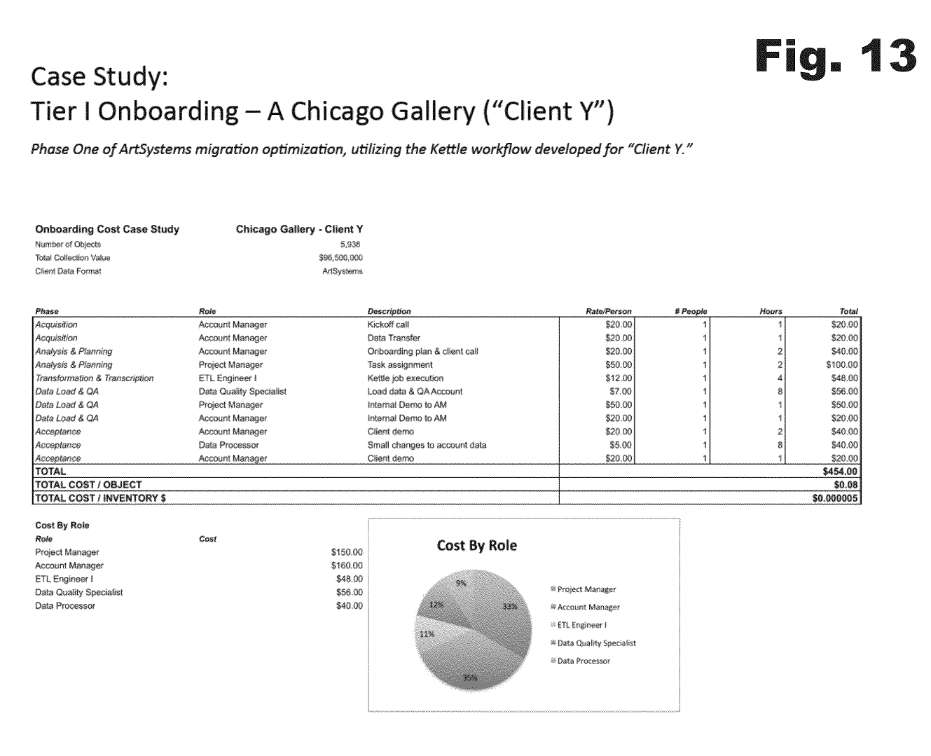

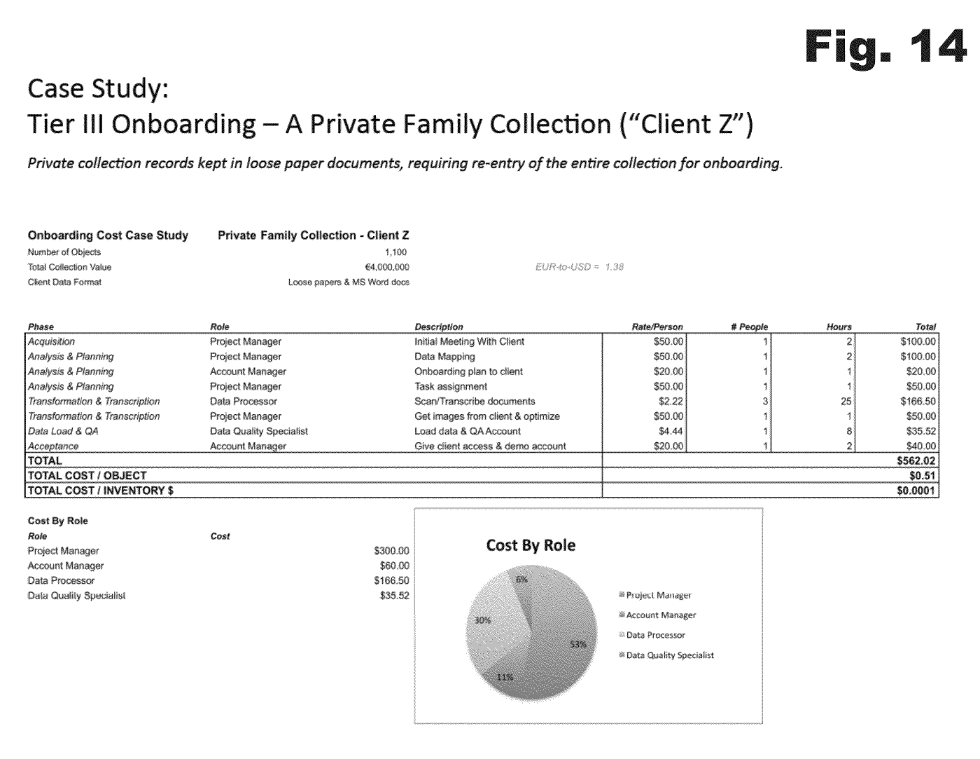

Tools and resources are illustrated within FIG. 8, while FIGS. 9, 10 and 11 are meant to cany the reader through Tiers 1, 2 and 3, respectively. FIG. 12 illustrates a representative Tier 1 case study associated with a New York gallery, client X, wherein onboarding into the system occurs. FIG. 13 illustrates a representative Tier 1 case study, onboarding of a Chicago gallery, client Y, into the system of the present invention. And FIG. 14 yet further illustrates a representative Tier III case study onboarding of a private family collection, client Z, into the system of the present invention. These are samples and examples, and are not to be construed as limitations.

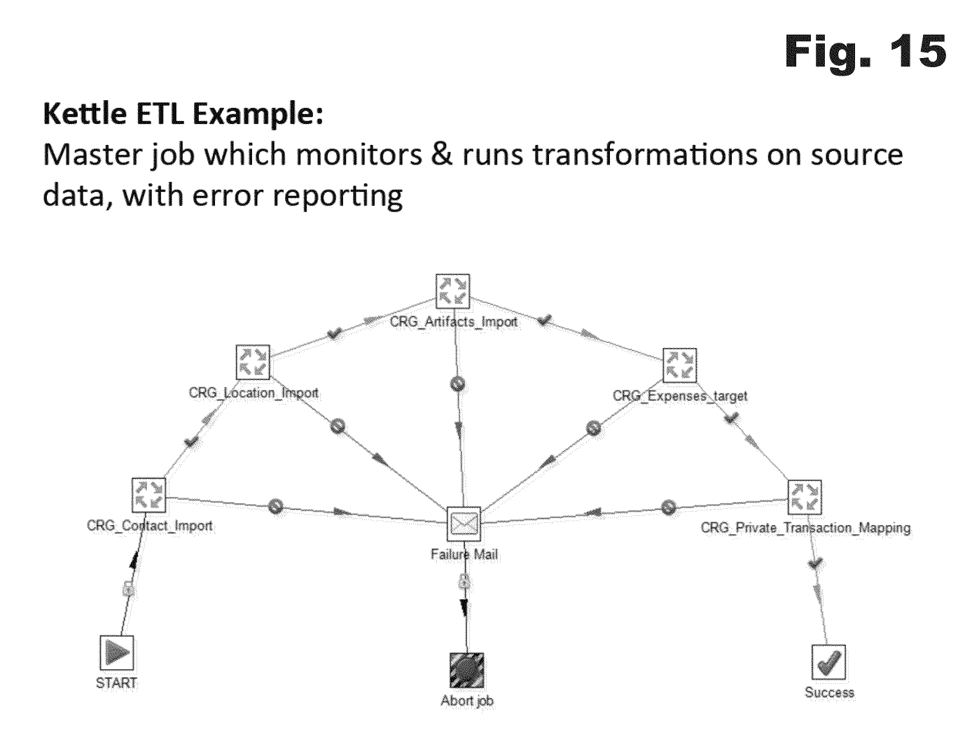

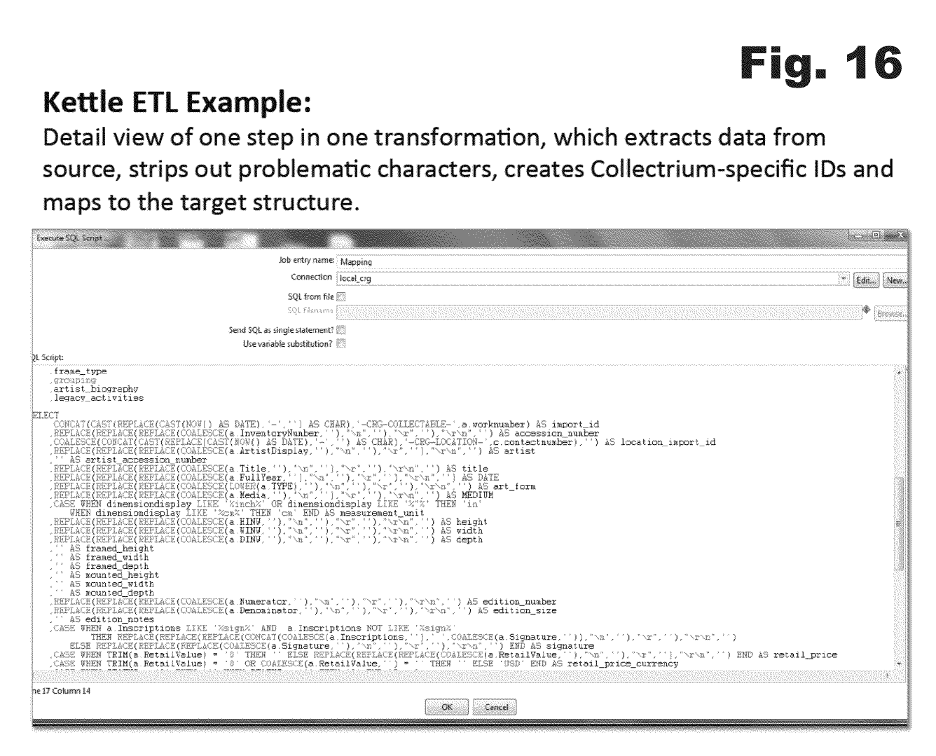

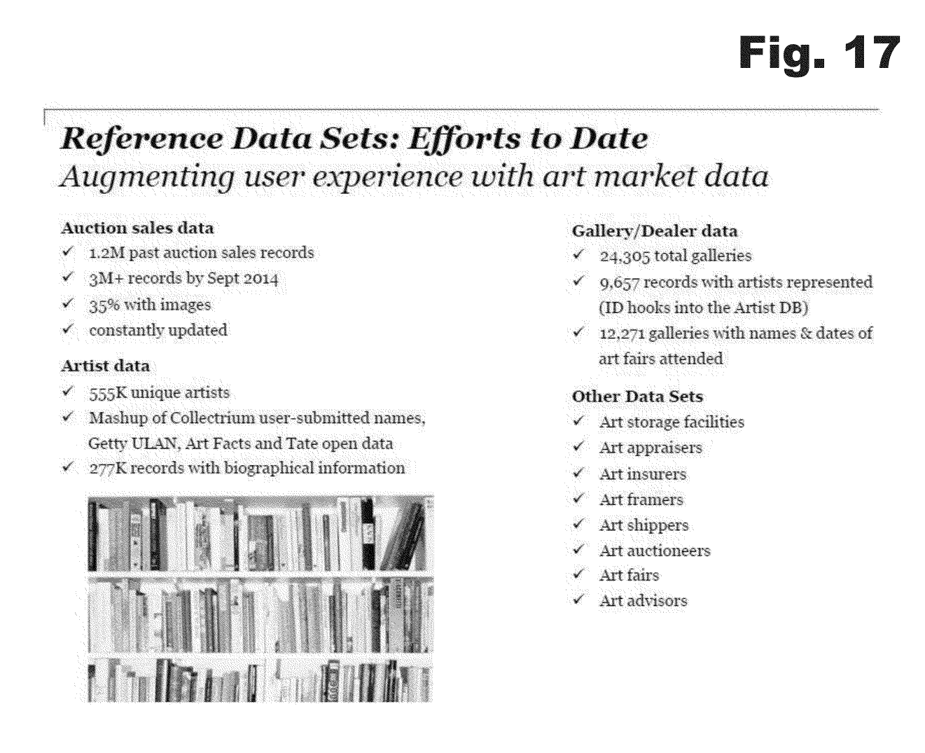

FIG. 15 illustrates flow associated with a master job using the present invention, in which transformations on source date, with error reporting, are monitored and run. A Kettle ETL detail view of a system transformation process step is illustrated in FIG. 16, wherein data is extracted from a source, problematic characters are stripped, and system user-specific identifications are created and mapped to a target structure.

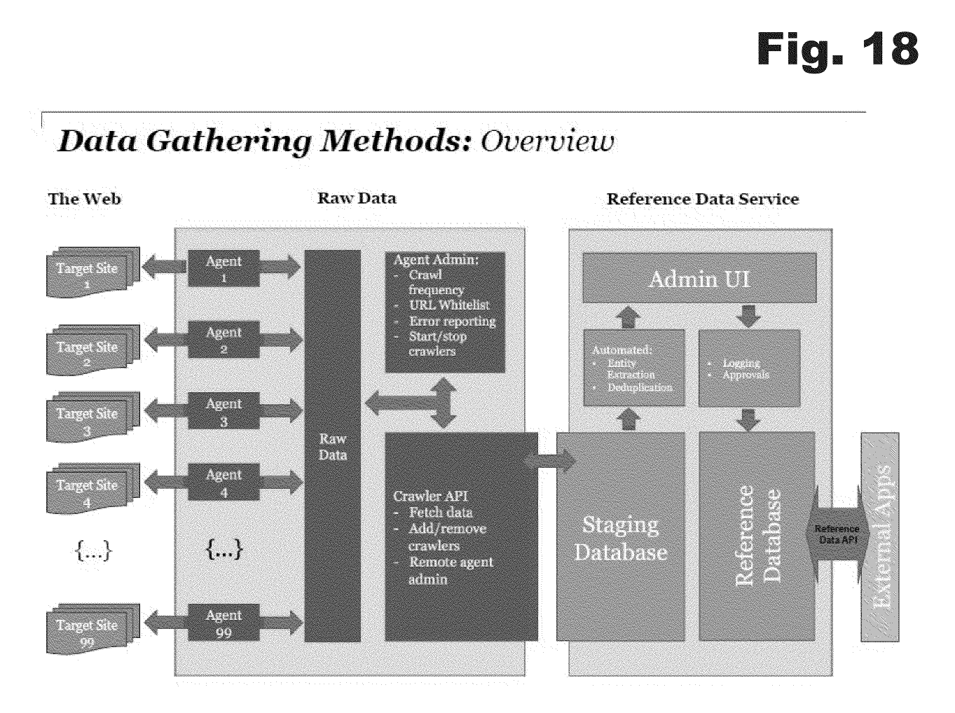

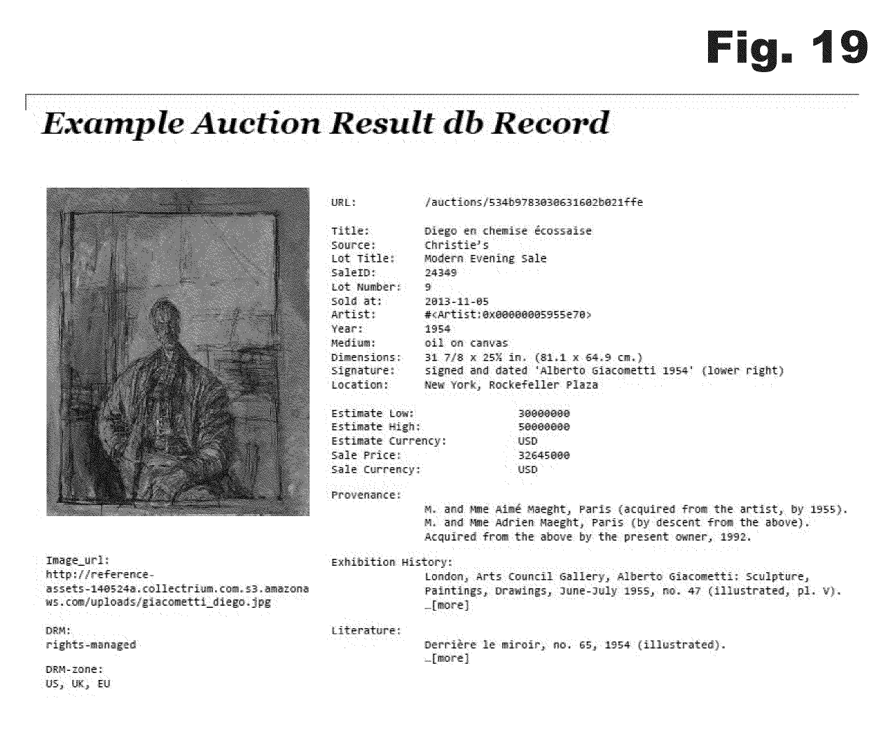

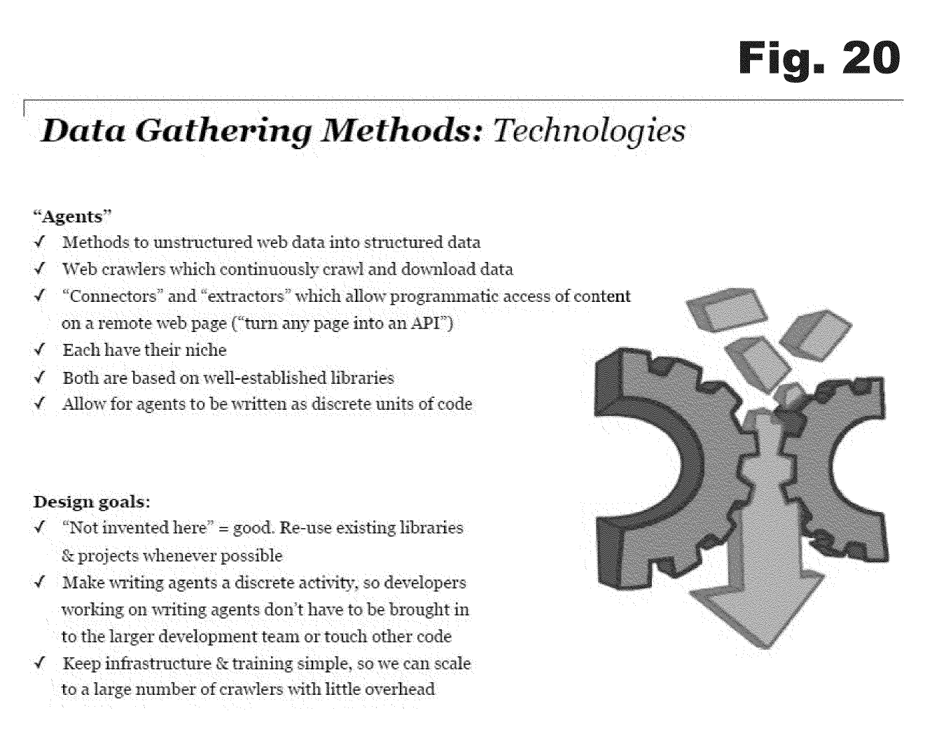

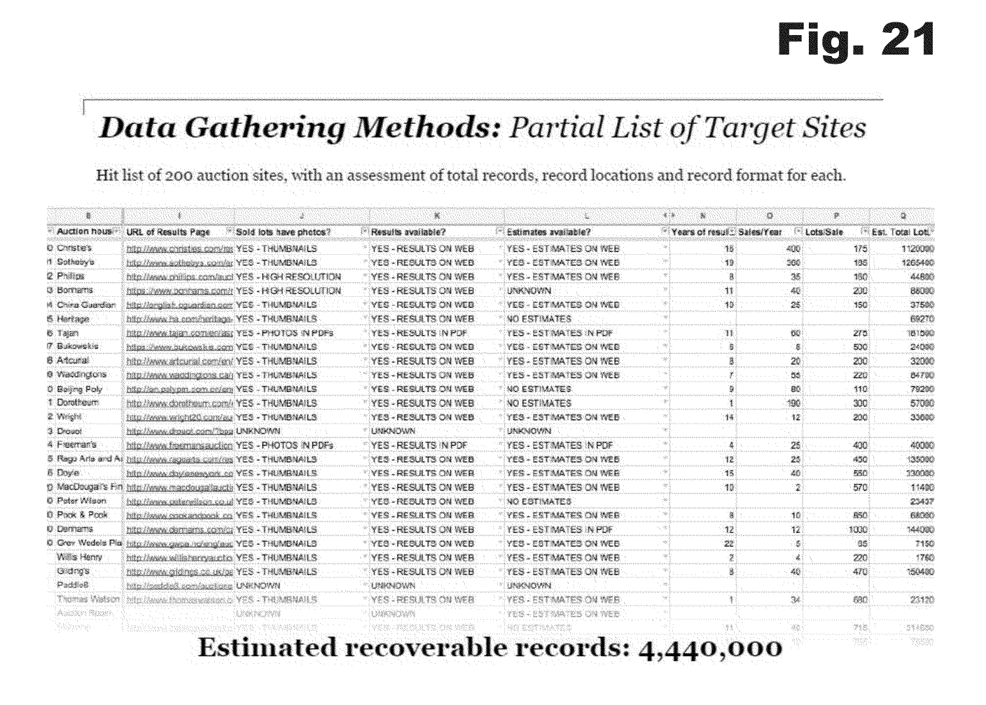

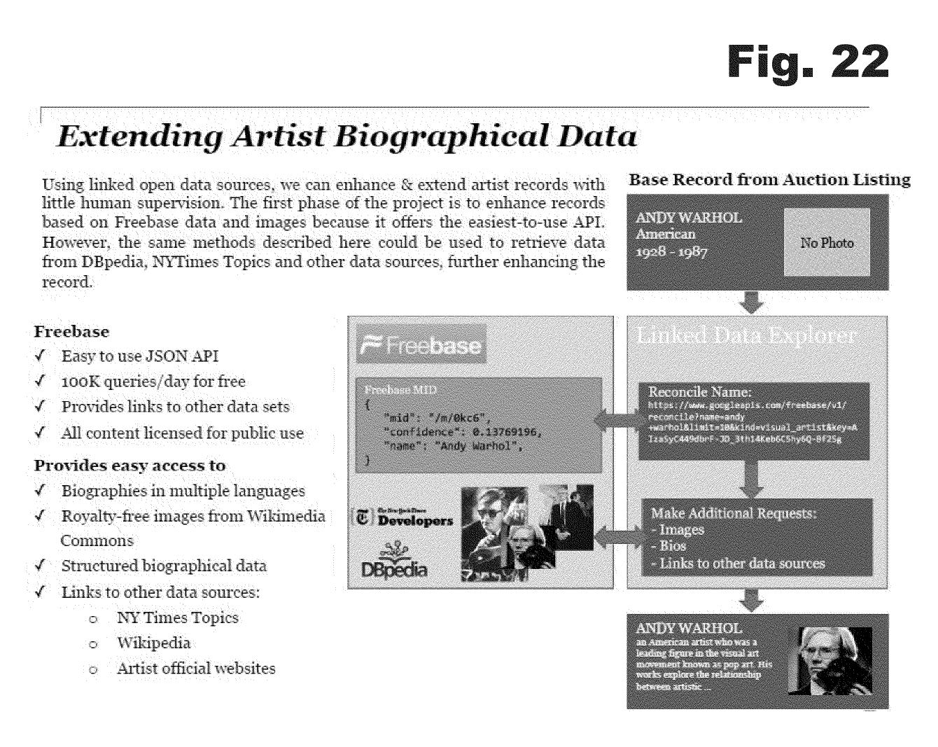

FIG. 17 illustrates the augmentation of a system user experience, wherein art market data is utilized from a variety of sources. Such data may originate from auction sales data, artist data, gallery and dealer data, and a host of other sources of data such as art storage facilities, appraisers, insurers, framers, shippers, auctioneers, art fairs and advisors. Other data gathering methods are shown graphically within FIG. 18. FIG. 19 illustrates a database record associated with a Diego oil art work, wherein auction result data is recorded for use with the present system. Yet further data gathering methods, including technologies, are illustrated in FIG. 20, including the use of “agents” and design goals. A partial list of target data gathering sites are shown in FIG. 21 to illustrate yet additional data gathering methods. These include a hit list of some 200 auction sites. FIG. 22 is meant to illustrate how extending artist biographical data may be used with the system of the present invention.

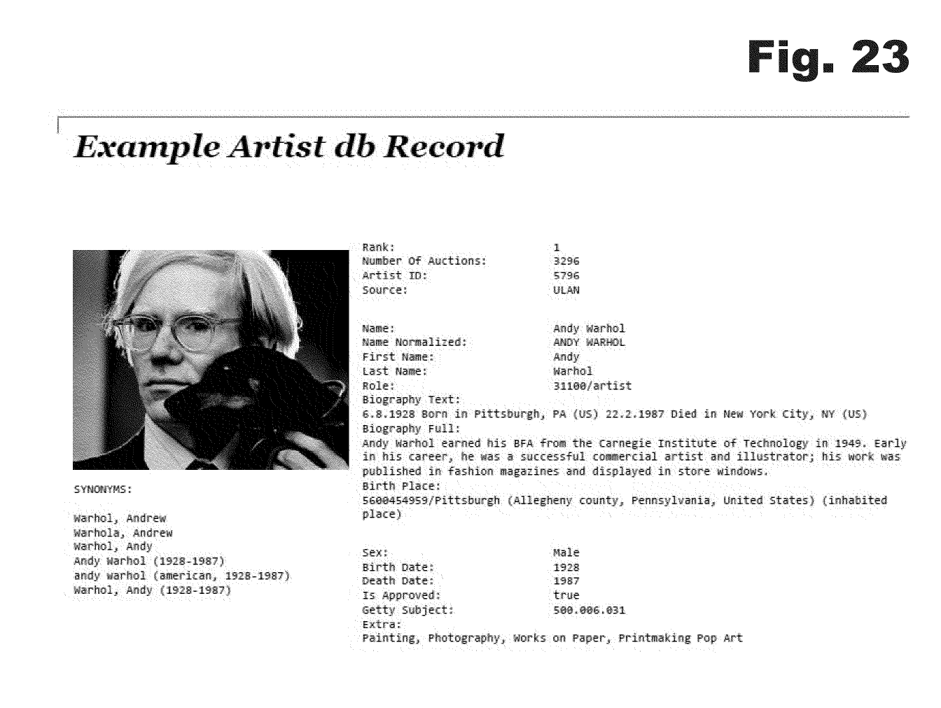

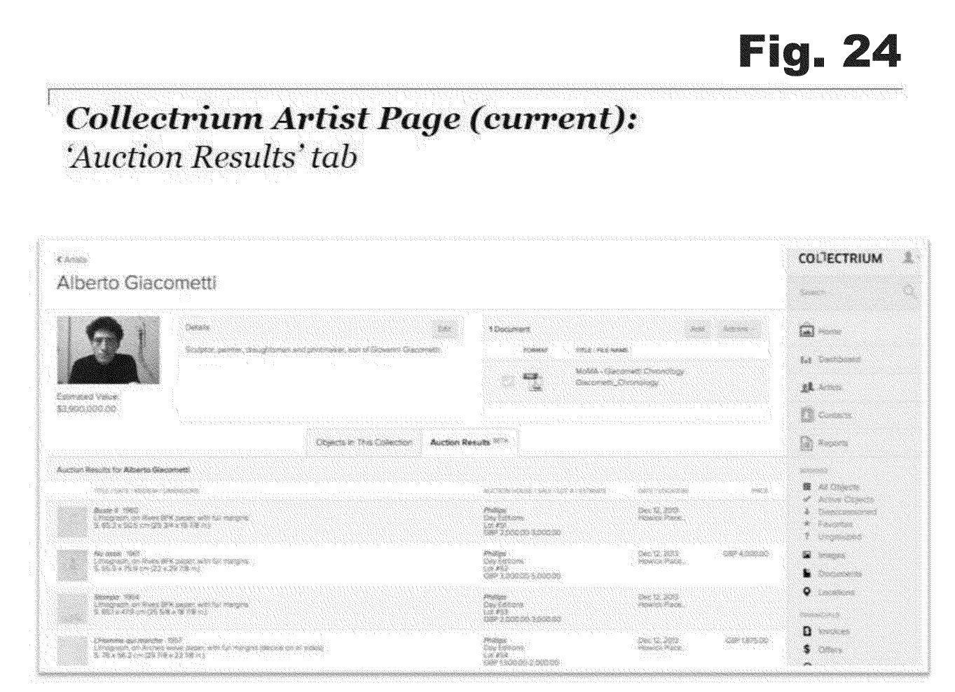

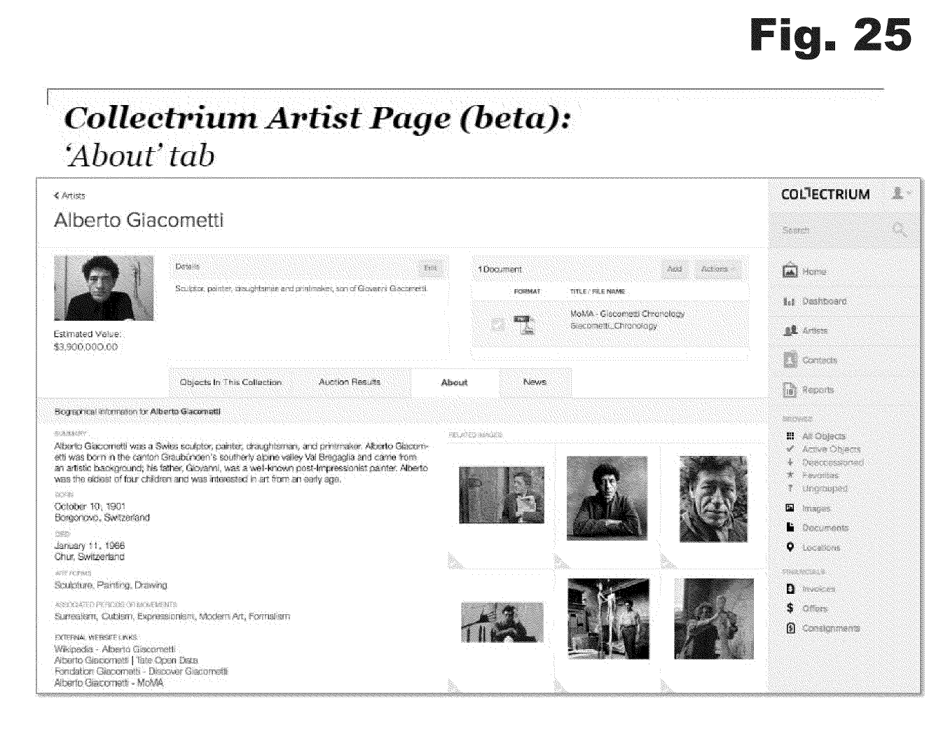

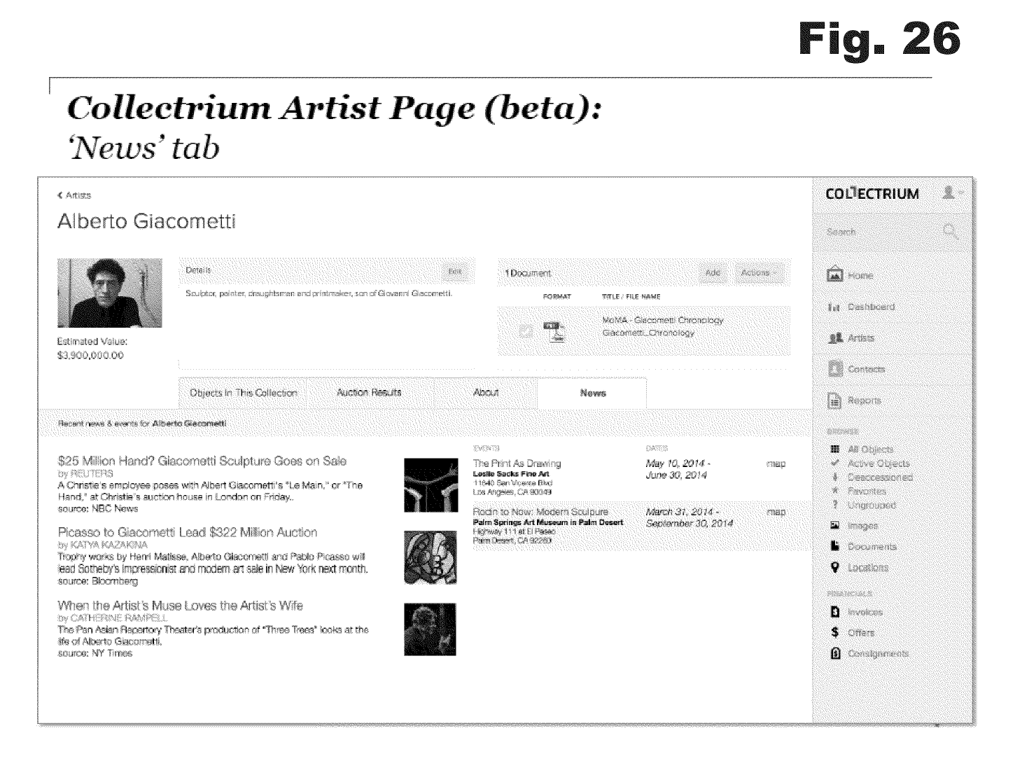

Database record associated with artists are used with the present invention. FIG. 23 illustrates an example of such a record for Andy Warhol, while FIG. 24 illustrates a sample current auction result record for the artist Alberto Giacometti. FIGS. 25 and 26 illustrate how the system may use “about” and “news” records for the artist Giacometti.

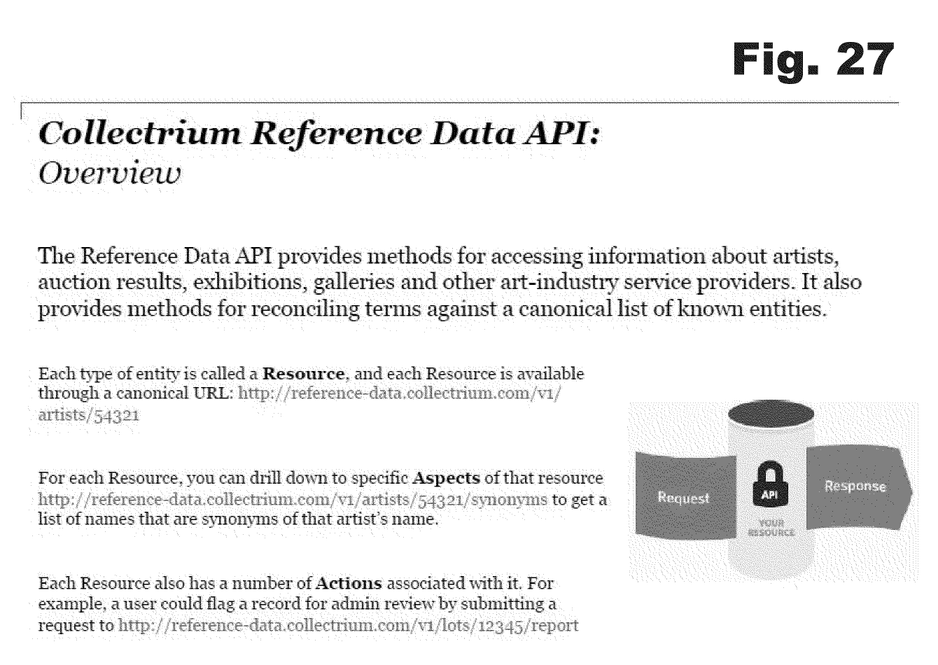

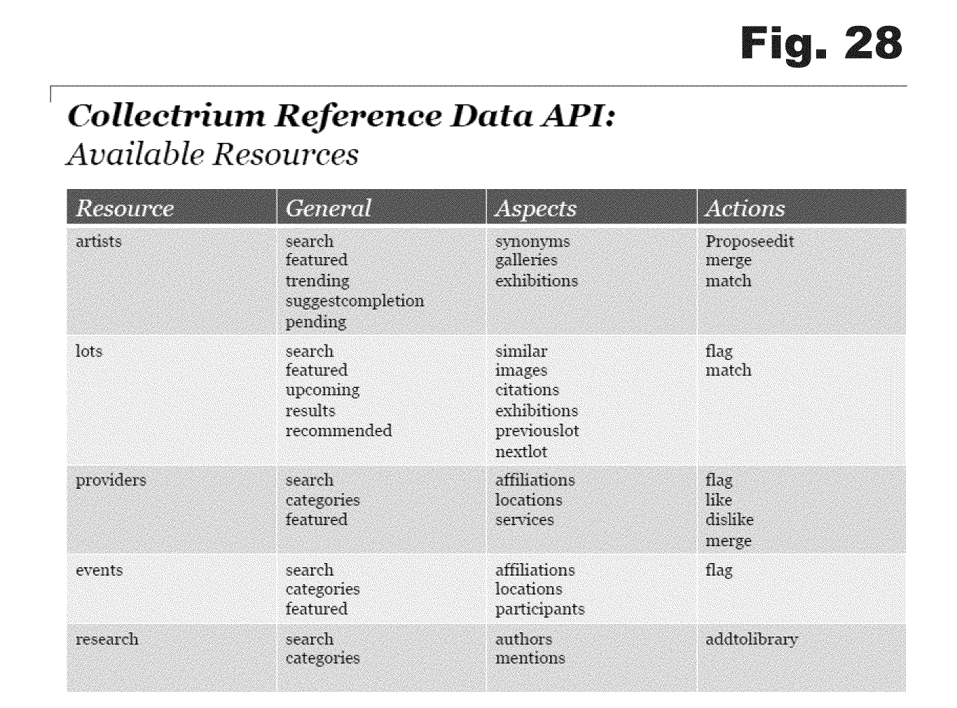

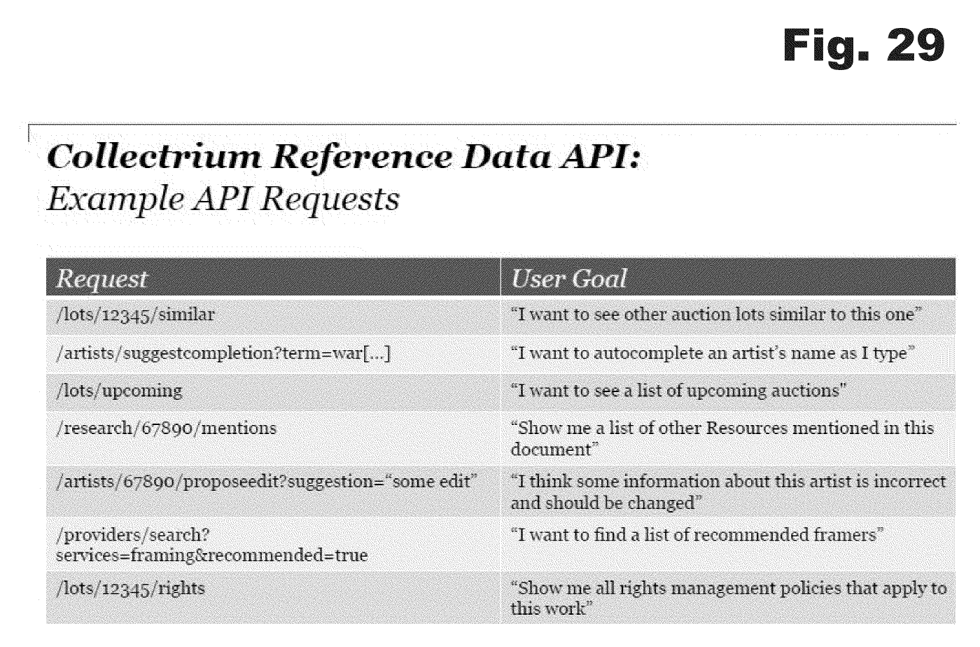

FIG. 27 illustrates a reference data API, showing methods for accessing information about artists, auction results, galleries and other providers, while FIG. 28 in table format illustrates available resources for reference data API. FIG. 29 yet further illustrates sample API requests and their associated user goals.

### Discussion of Augmented Reality & Related Features

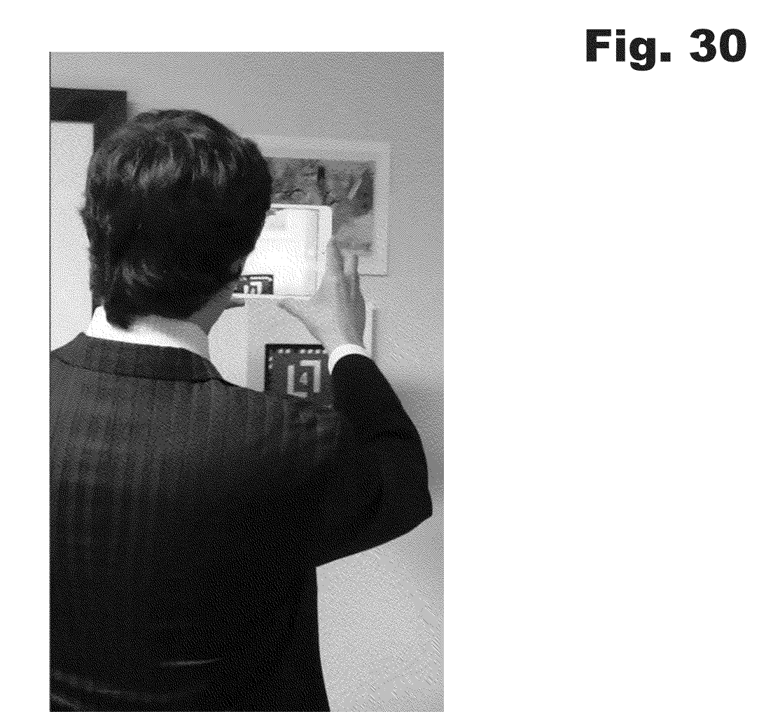

FIGS. 30 through 60, inclusive, are presented here to illustrate how a user of the present invention is able to utilize a mobile device, in order to enjoy features not found elsewhere in the art. Since it is not possible to present video imaging of mobile device aspects of this invention, the reader is invited to view the following drawings as snapshots along the path of such a presentation.

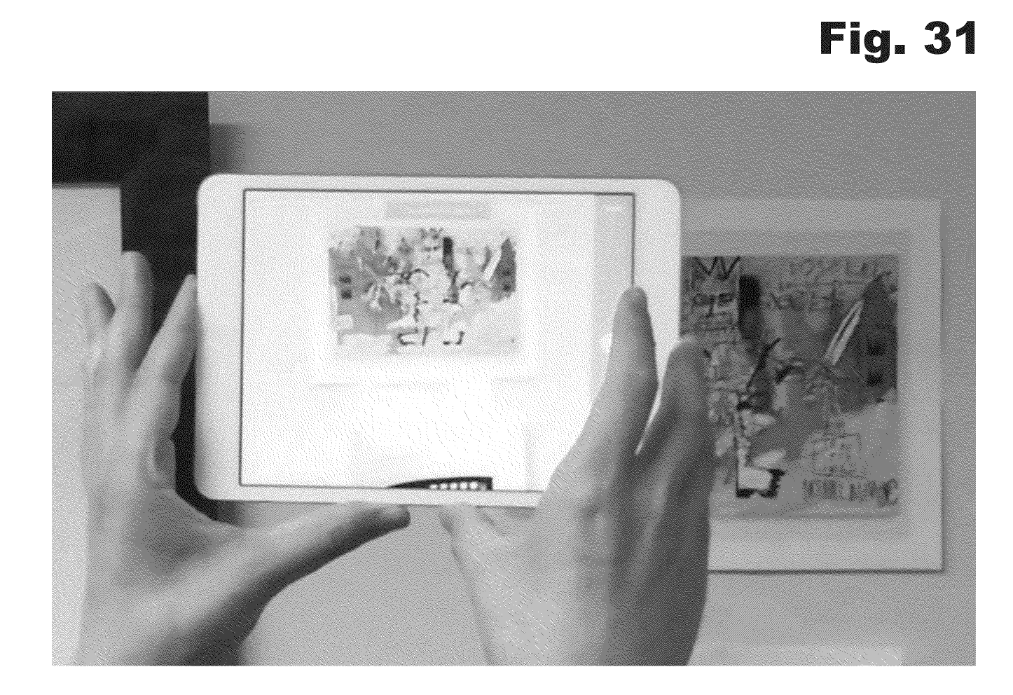

In FIG. 30, a system user (the principal inventor) is shown holding an iPad Mini in front of a work of art that has been mounted on a conference room wall above a visual tag (described later). The user is behaving in a manner consistent with his viewing art works on walls of a gallery, for example. FIG. 31 is a close-up of the iPad Mini's screen on which the art work of FIG. 30 appears on the device's screen. The art work is in the process of being “recognized” by the system software via images of that art work stored within the system's database. The database referred to here will be constantly updated with all kinds of information, and its contents, depending upon the privileges associated with system users, will be mirrored on all stationary and mobile devices connected to the system.

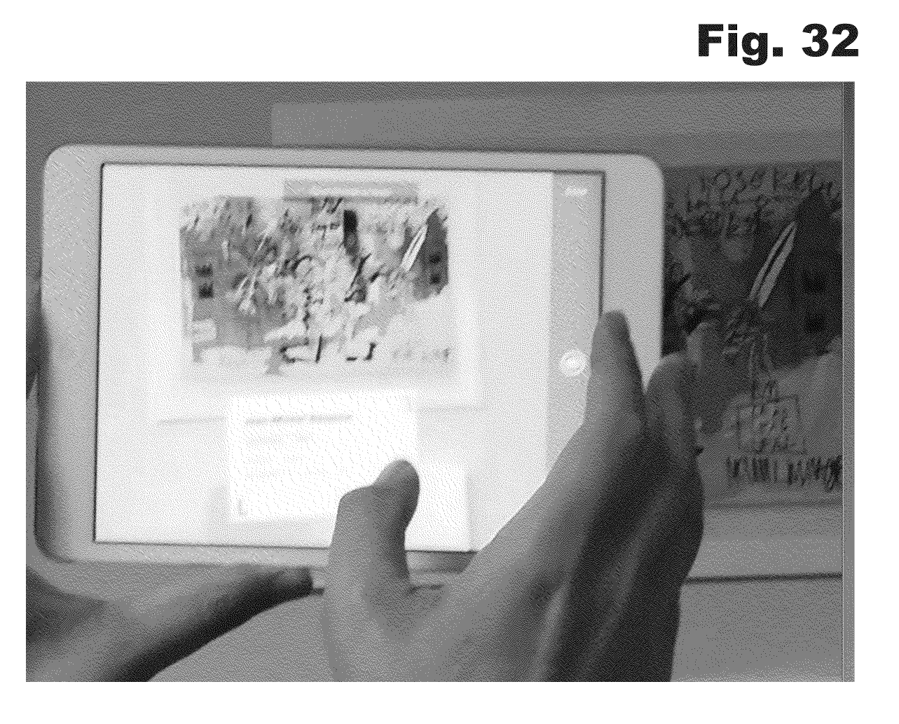

FIG. 32 is a view similar to that of FIG. 31, wherein the device is close enough to the work of art that the system will permit its recognition and, in fact, the system has recognized the art work and has placed a virtual label beneath the work's image on the iPad screen. In FIG. 32, the label just referred to is seen beneath the right hand thumb of the user's hand, as shown.

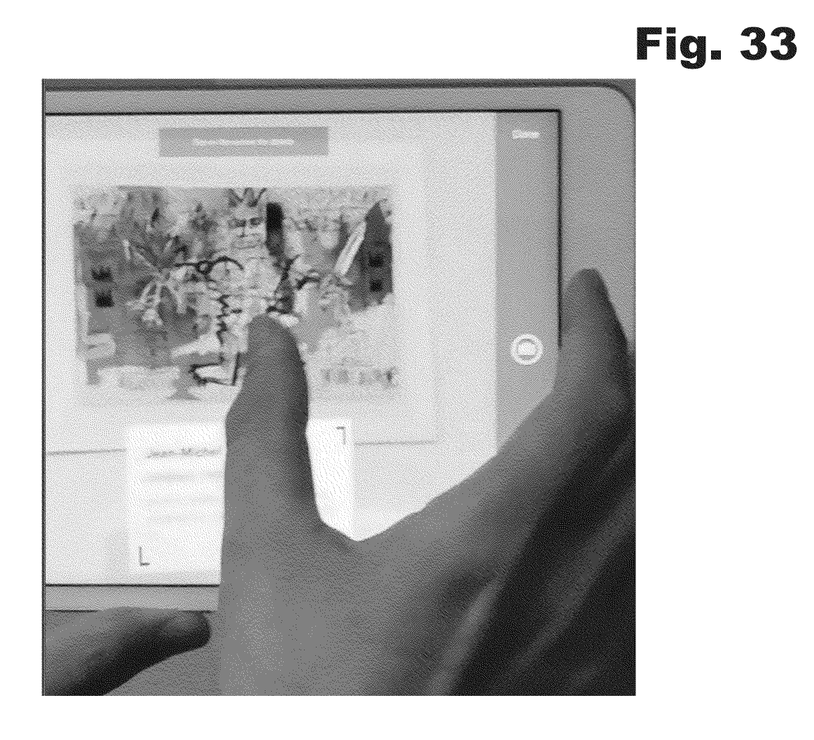

FIG. 33 is a view similar to that of FIG. 32, but where the work of art has been recognized by the system according to the present invention, and has also generated a label beneath the work's image, setting forth predetermined information from the system's database; note the user's thumb touching (clicking on) the work's image;

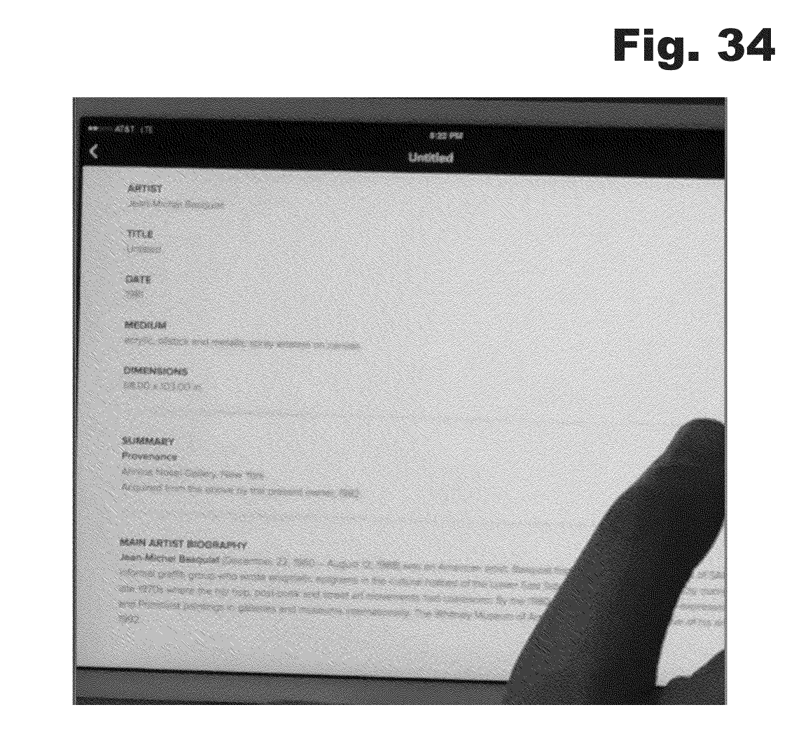

FIG. 34 illustrates the result of the user's touching of the work's image in. FIG. 33, resulting in the popping up of a great deal more information about the subject work of art;

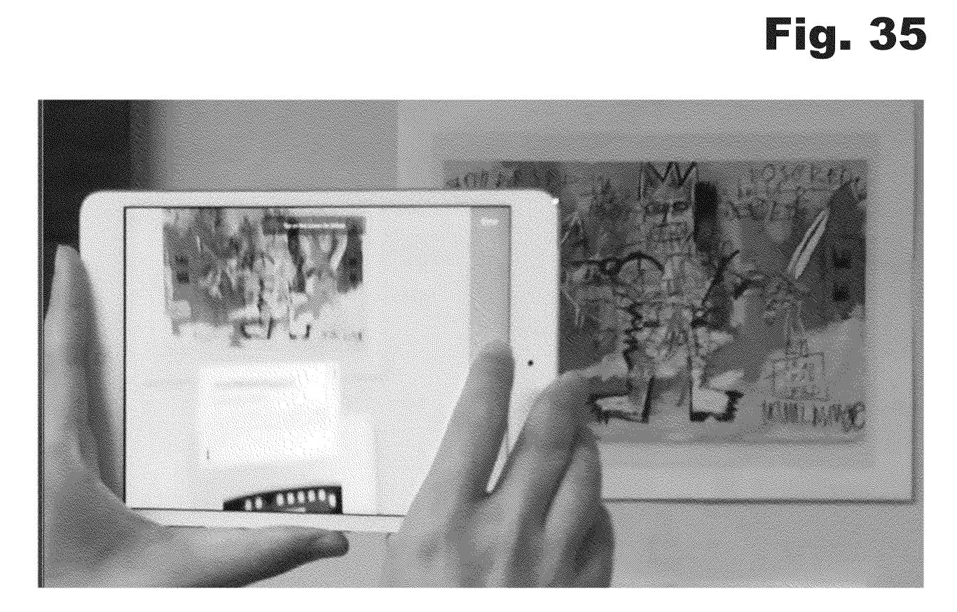

FIG. 35 is an illustration similar to FIG. 34, but with the user's finger in the process of clicking on a camera icon virtual shutter button, thereby permitting the capturing of the screen image containing information such as, without limitation, information about the art work, the gallery, the artist, and a history of financial dealings involving the art work;

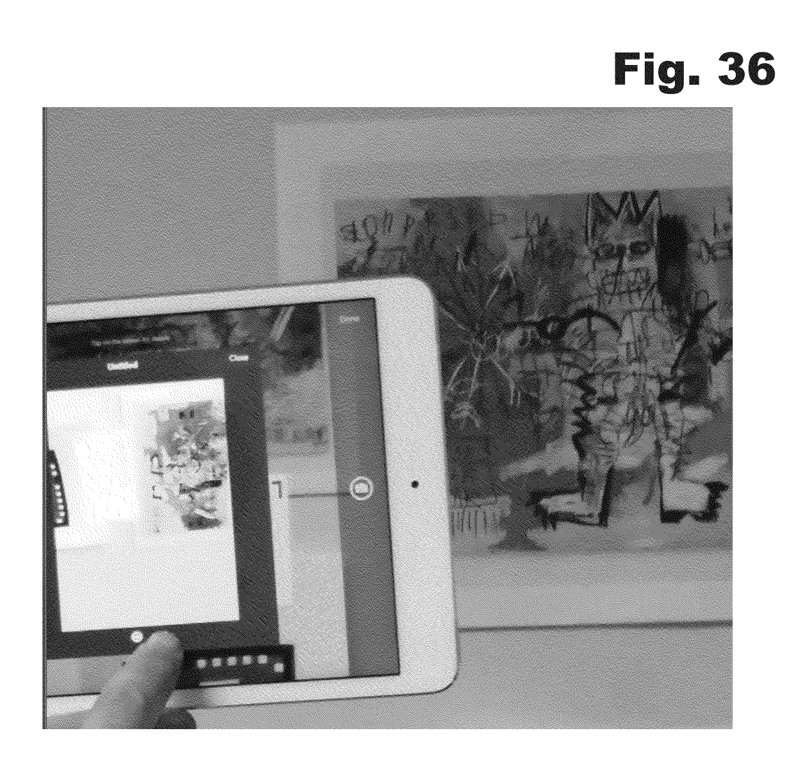

FIG. 36 is an illustration similar to FIG. 35, wherein the user's finger is shown clicking on an email icon, thereby facilitating the sending of an email copy of the captured image to a recipient, such as the sending of an email by an Agent to a client Collector;

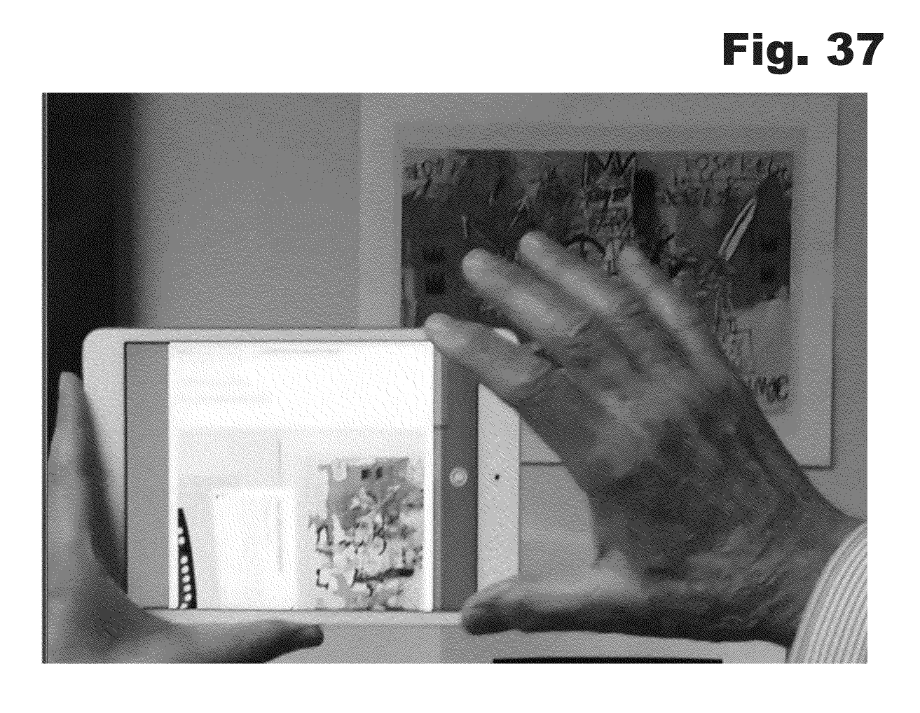

FIG. 37 is an alternative view similar to FIG. 36, but showing the remote device in the hands of a user, with the art image on the screen;

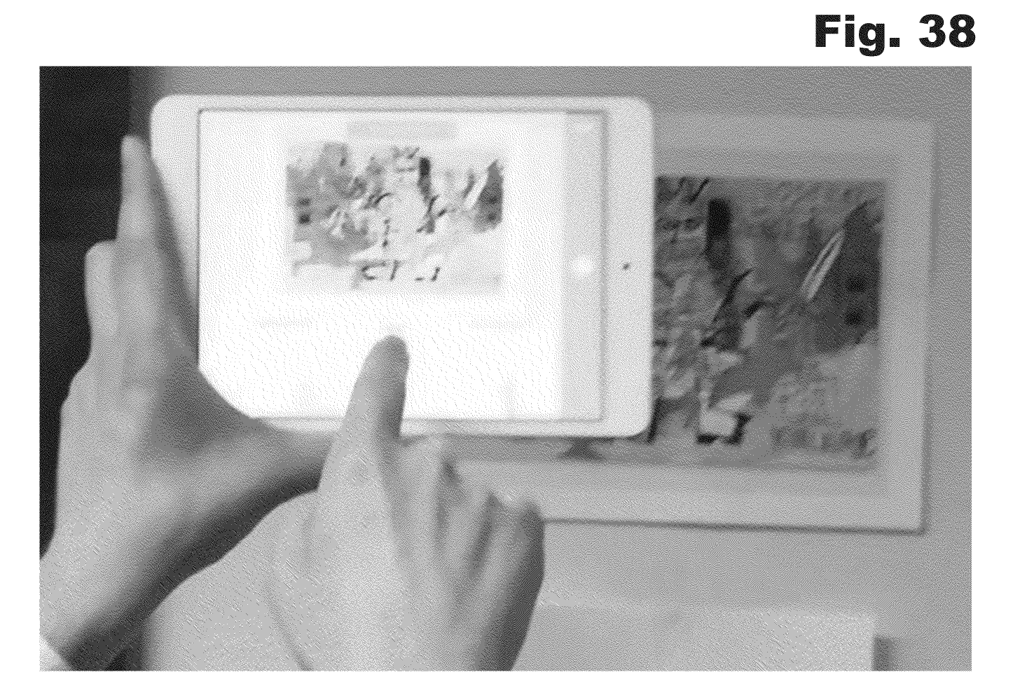

FIG. 38 is an alternative view similar to FIG. 37;

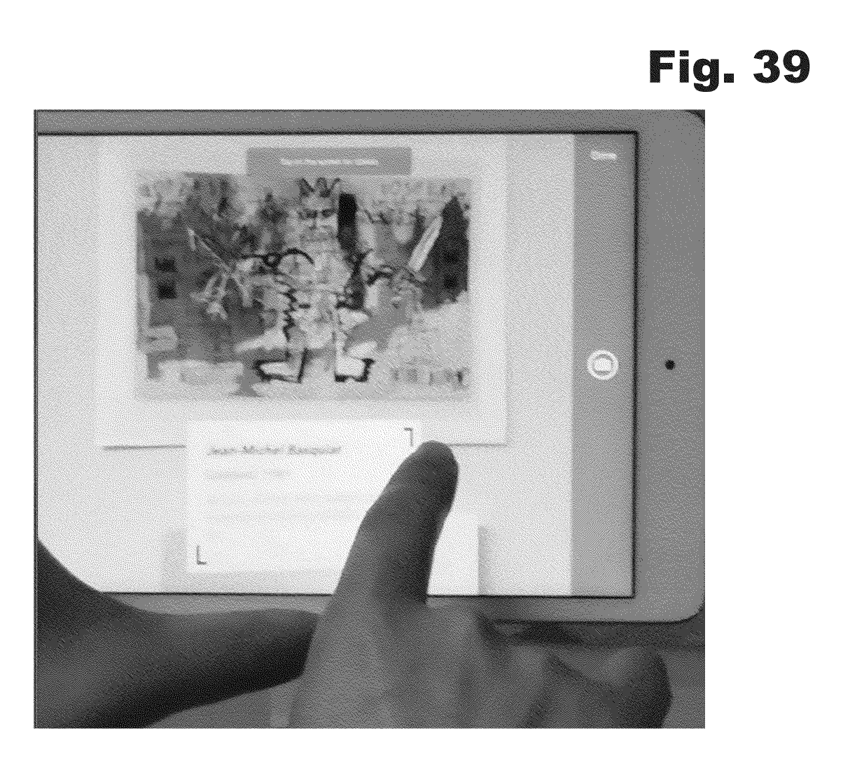

FIG. 39 is meant to illustrate the ability of the user to click on a “Favorites” virtual button, to thereby add the link to the device;

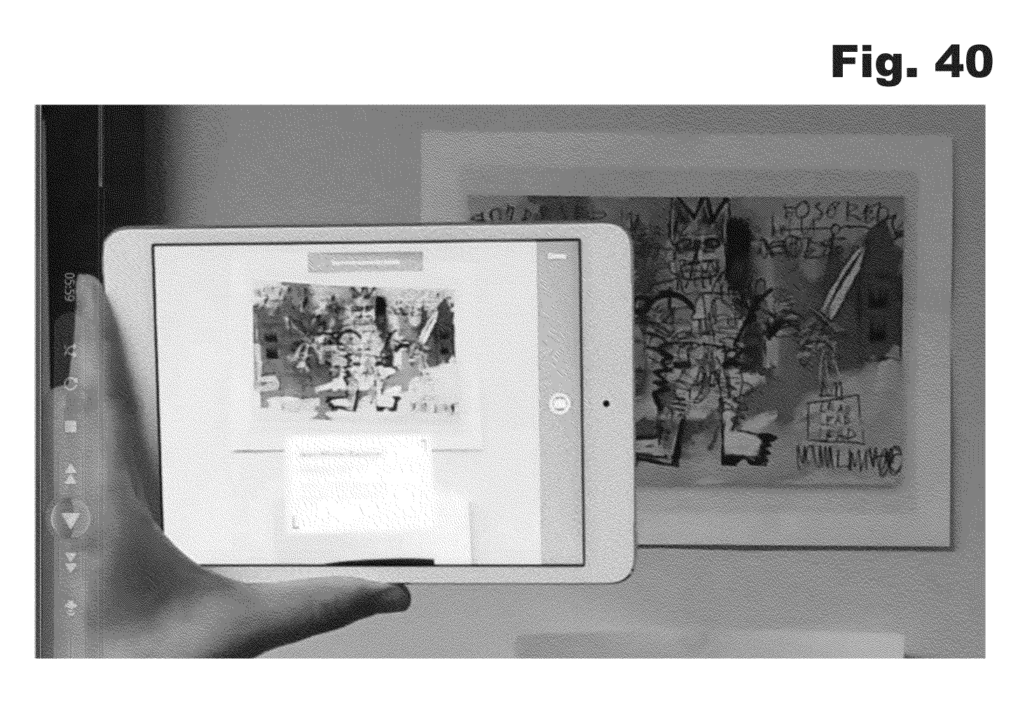

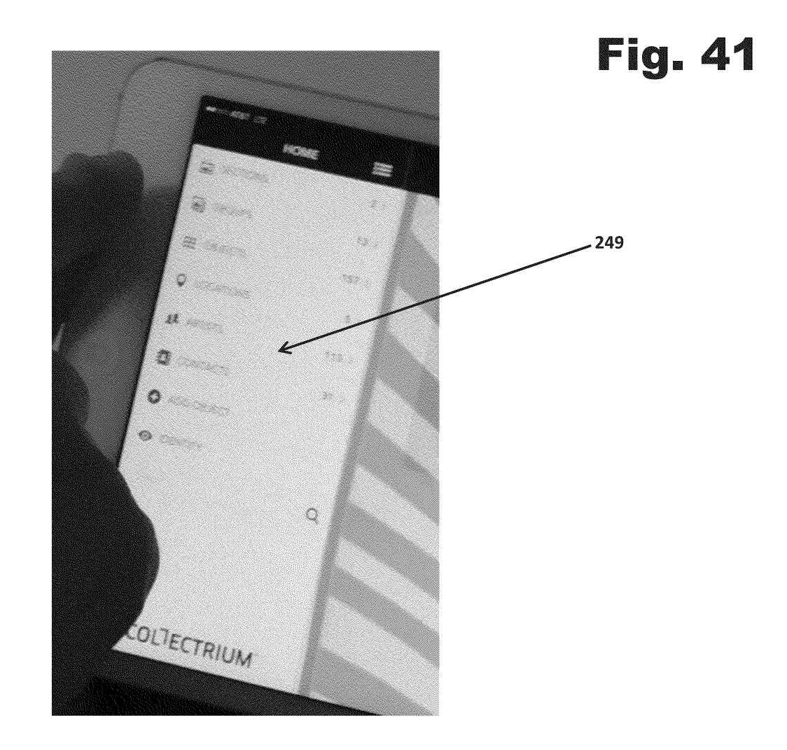

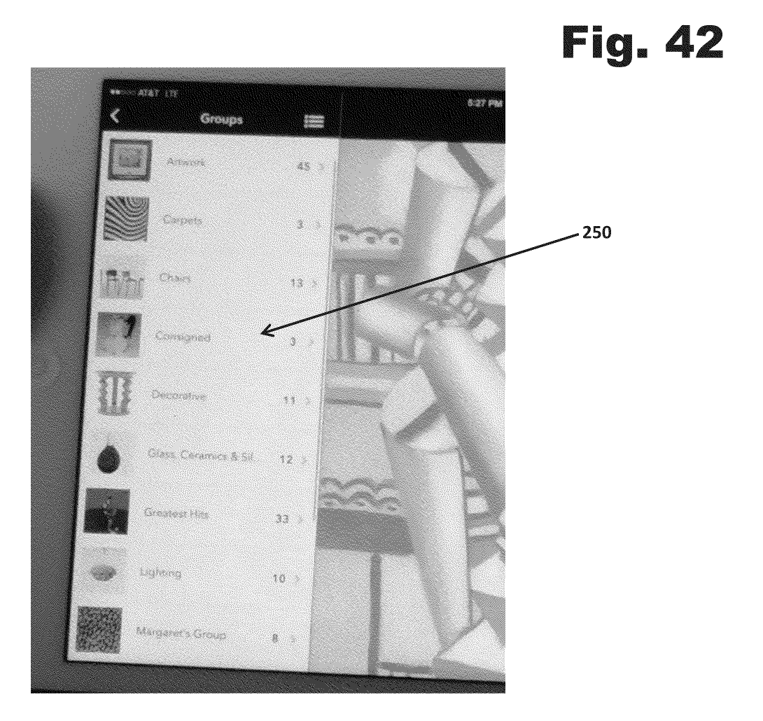

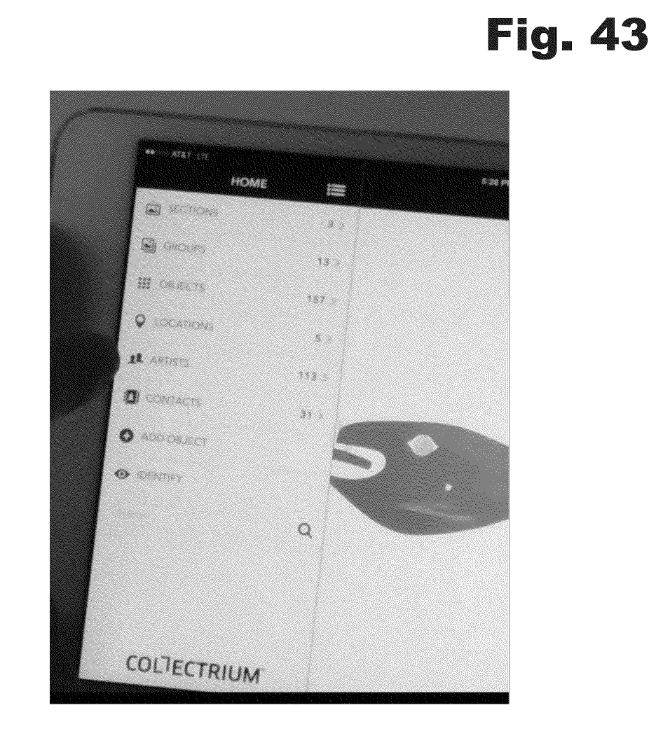

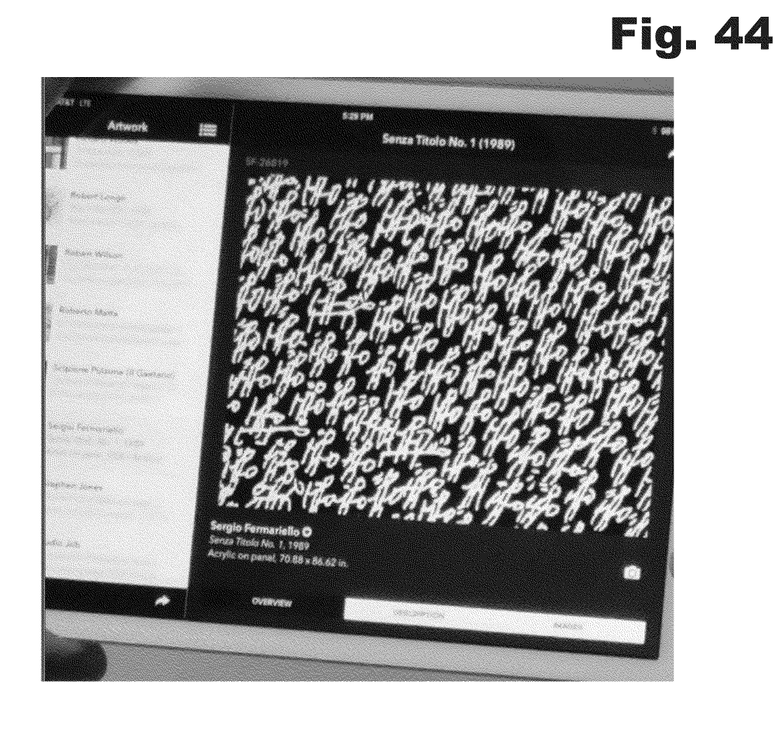

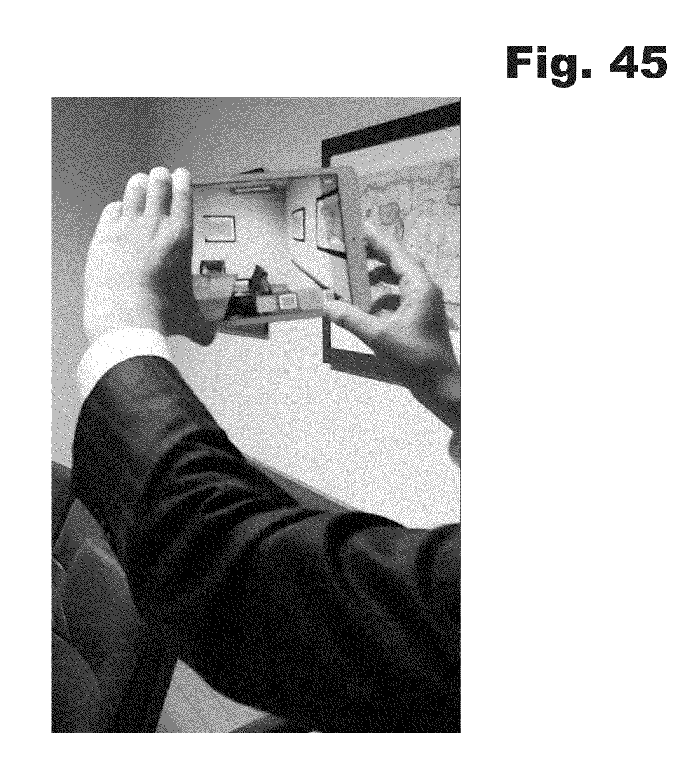

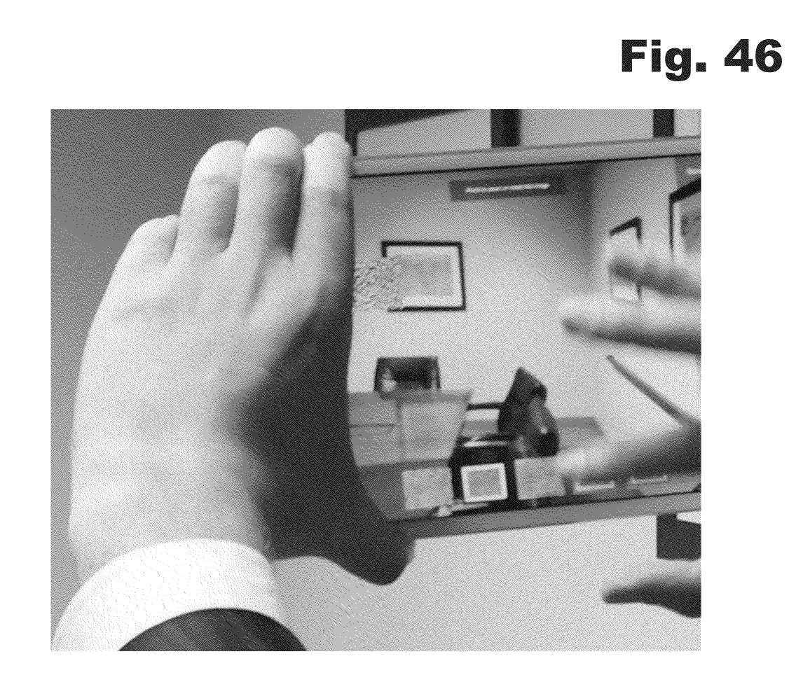

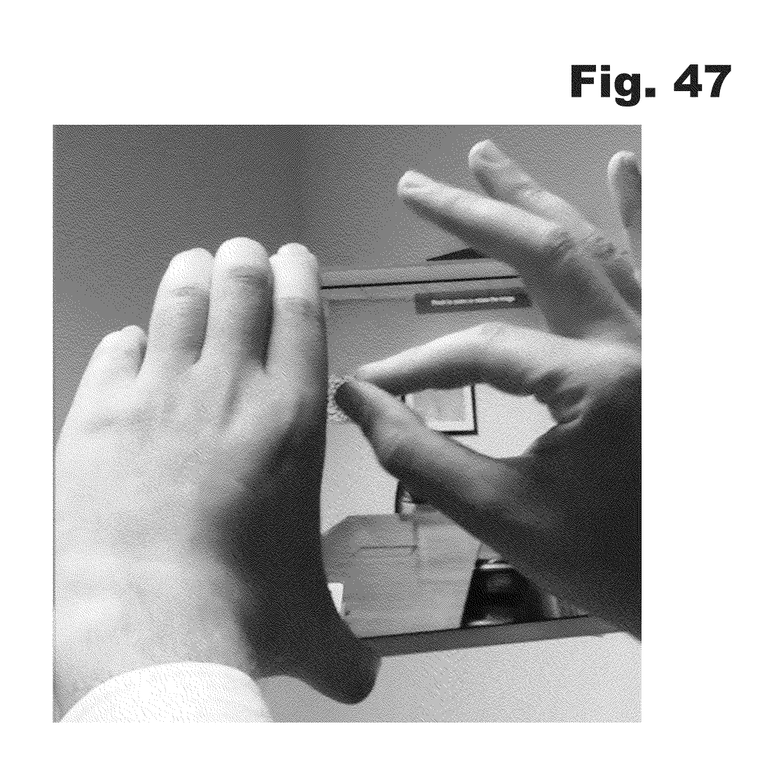

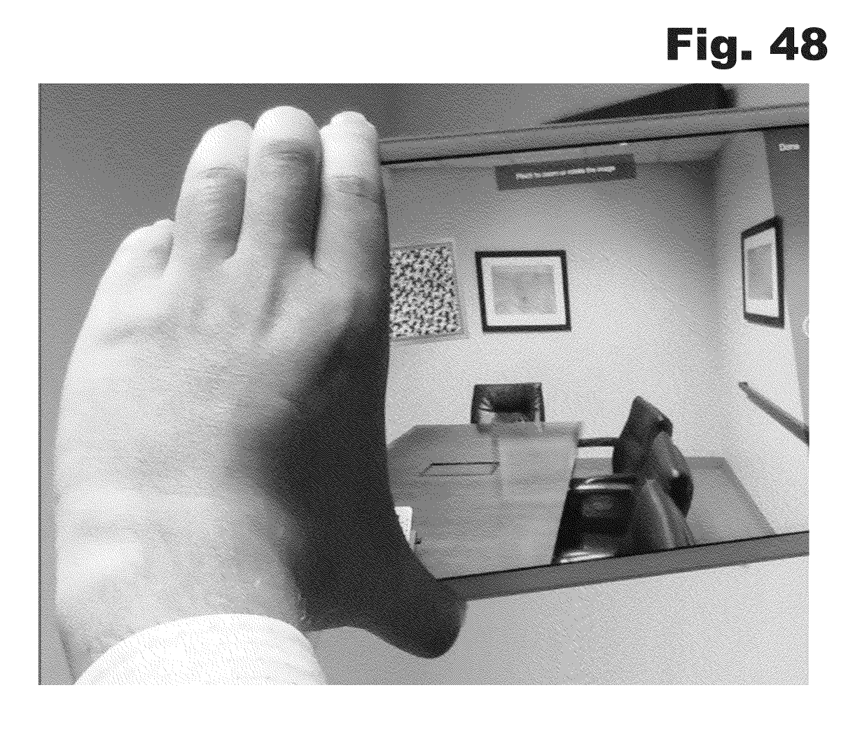

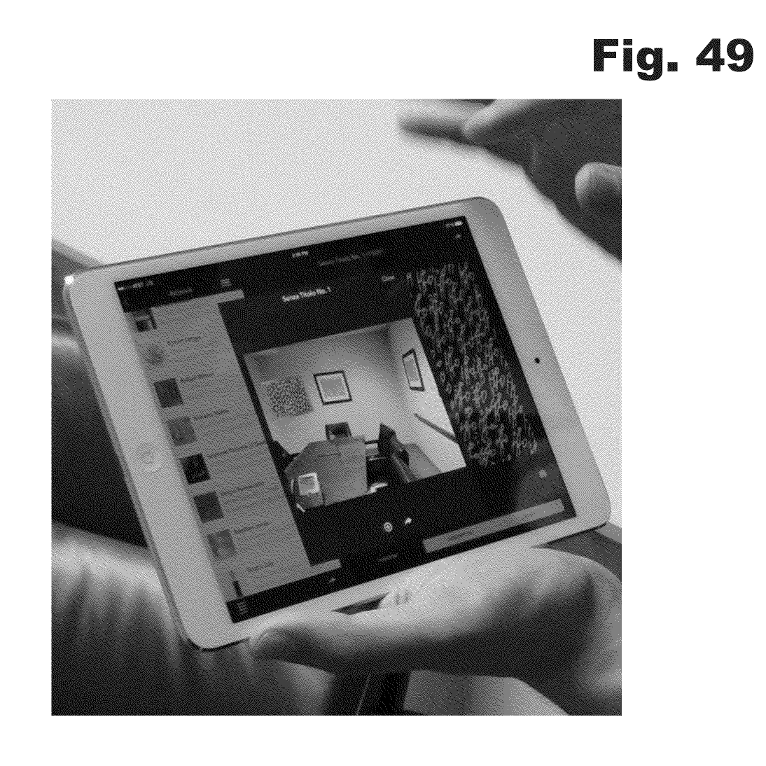

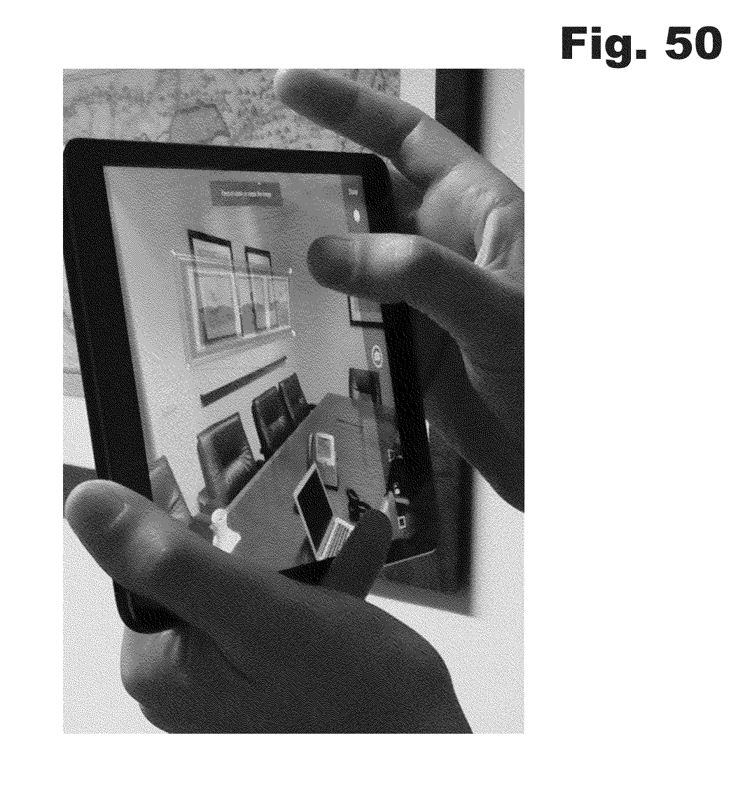

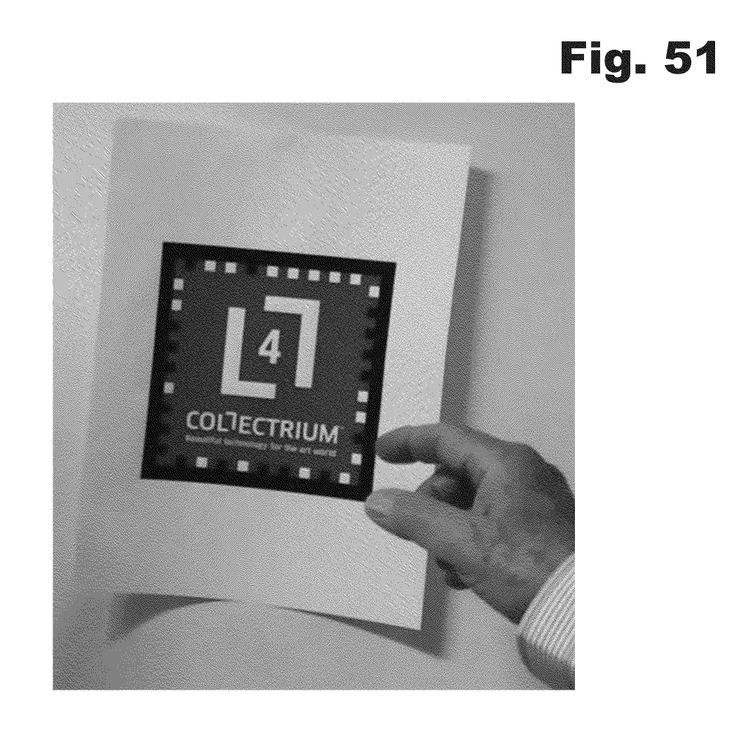

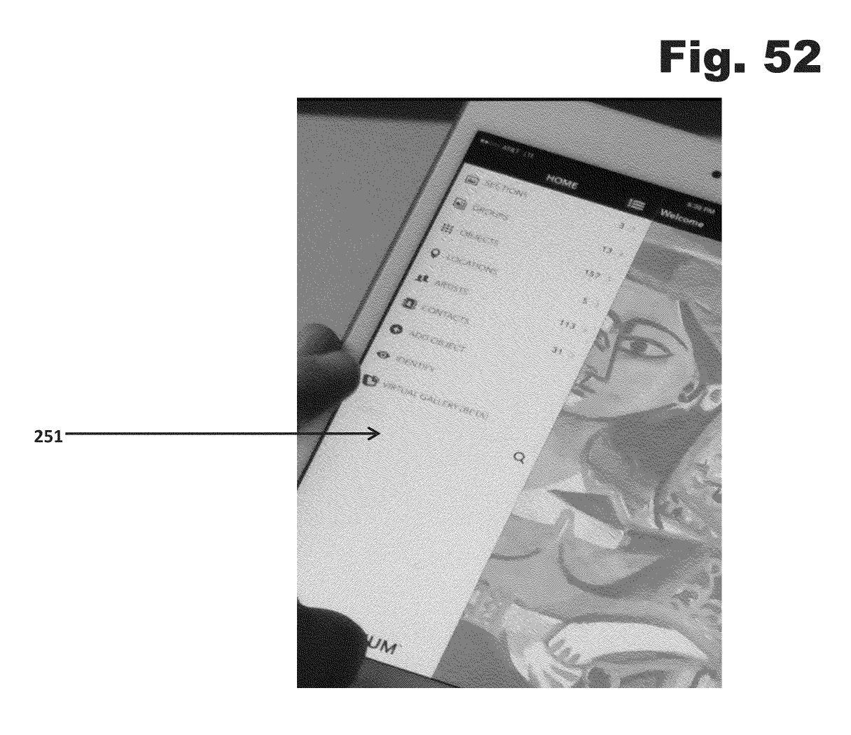

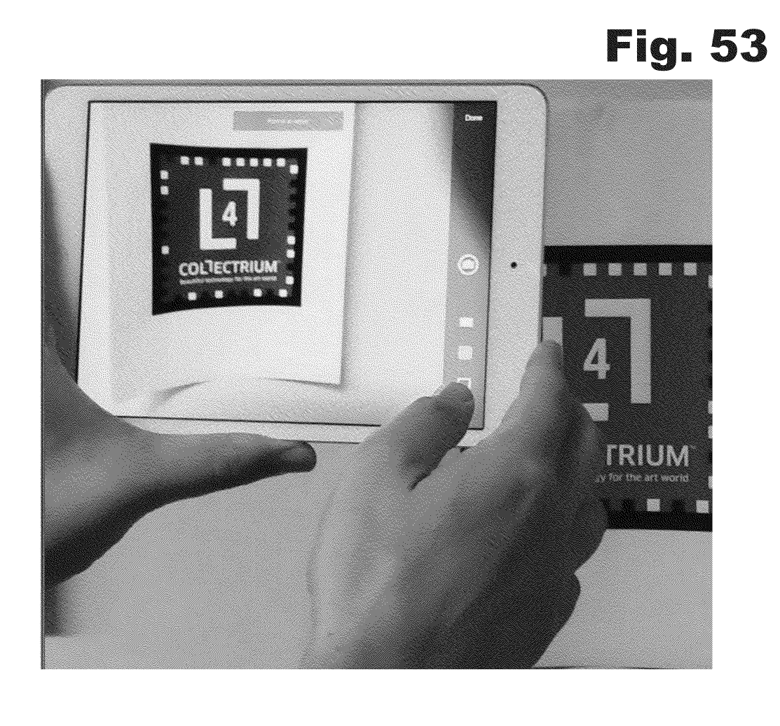

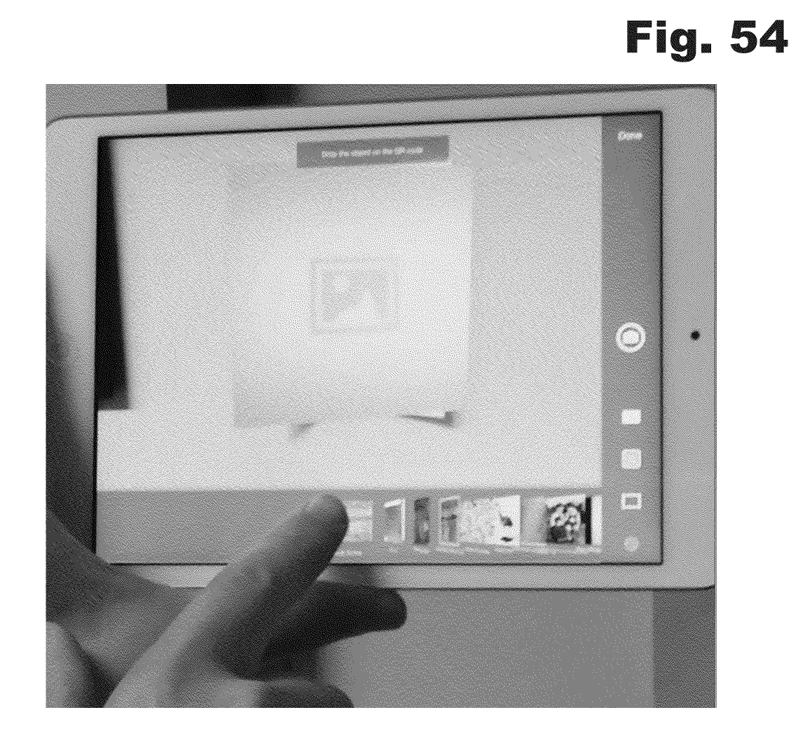

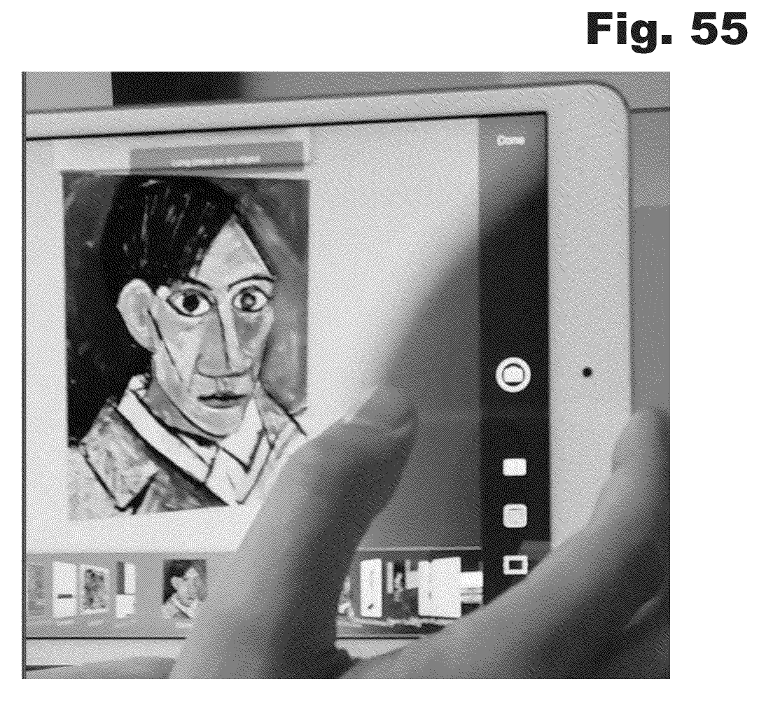

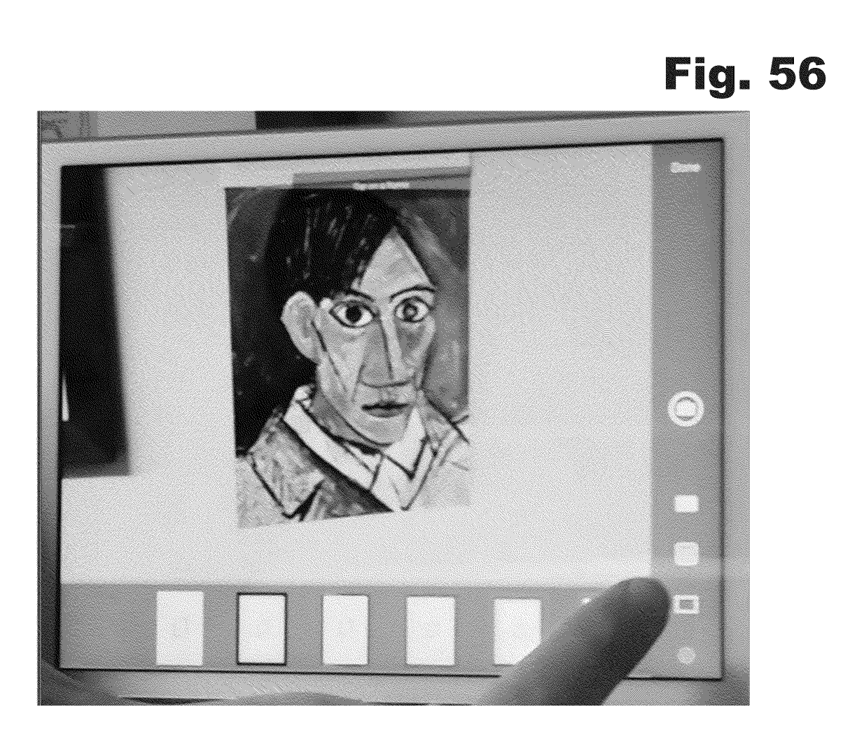

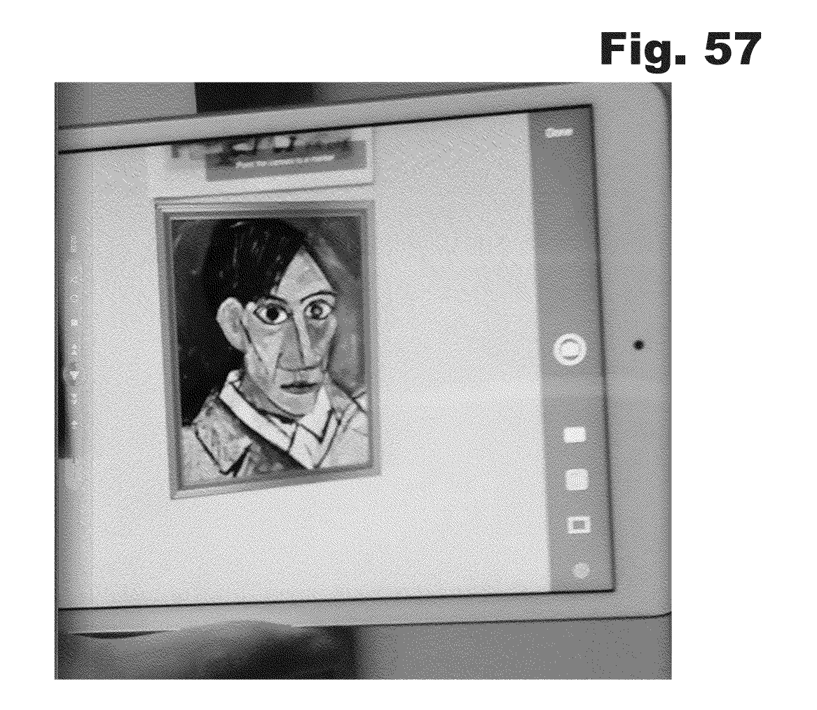

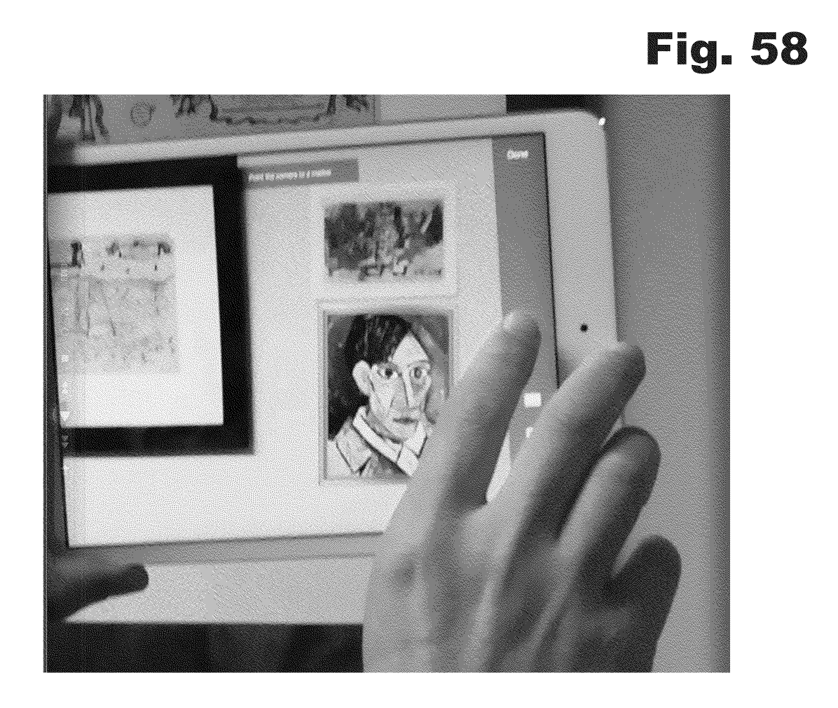

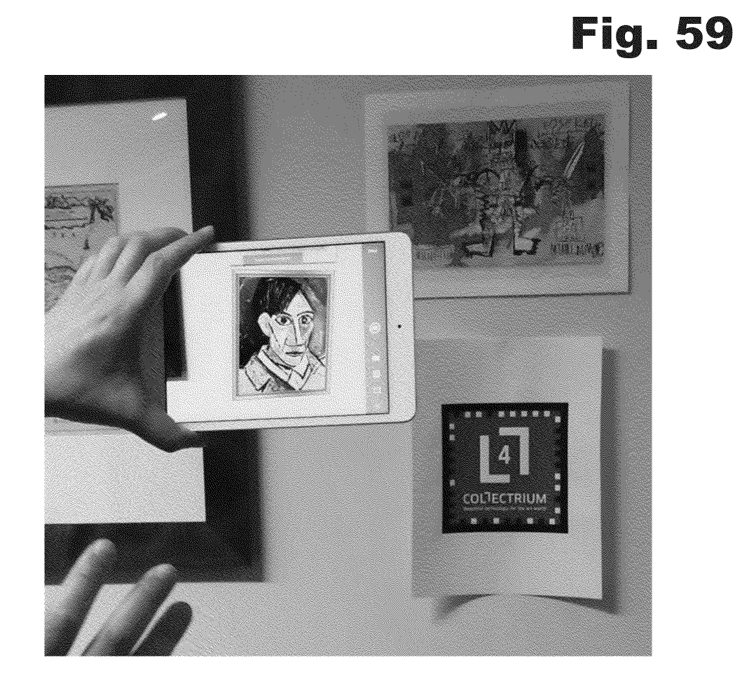

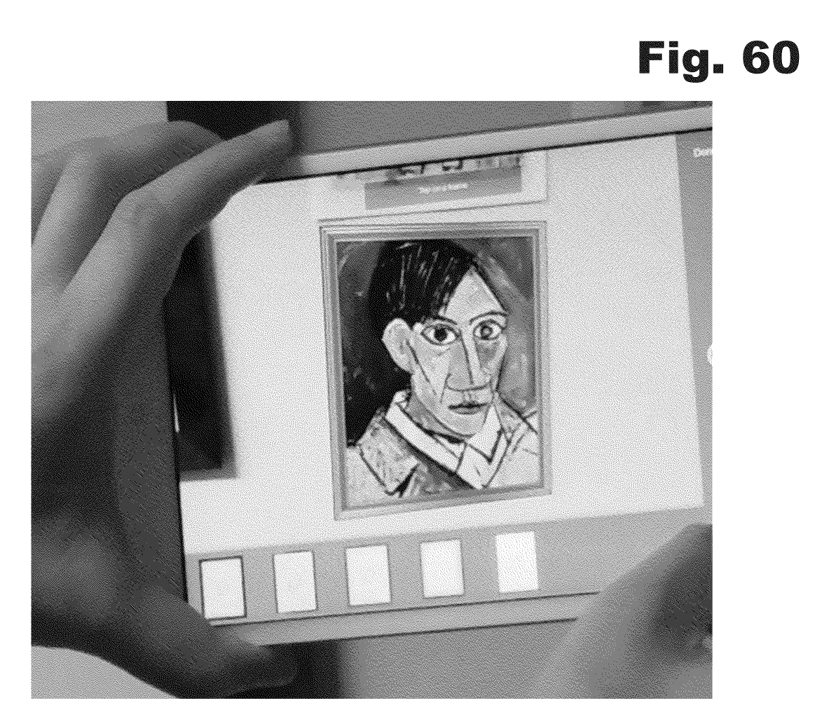

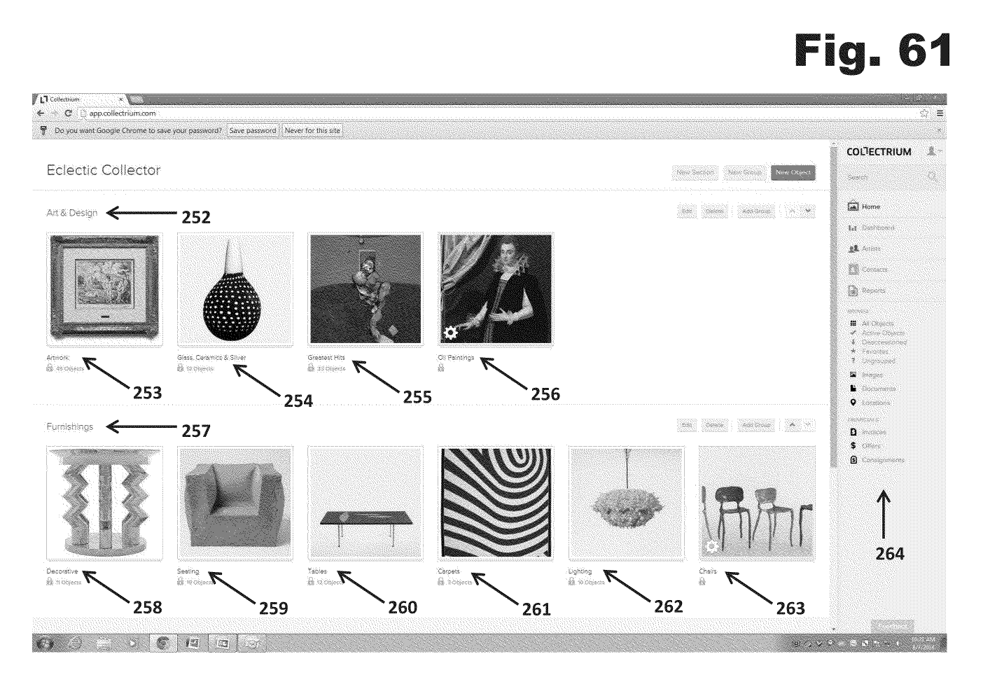

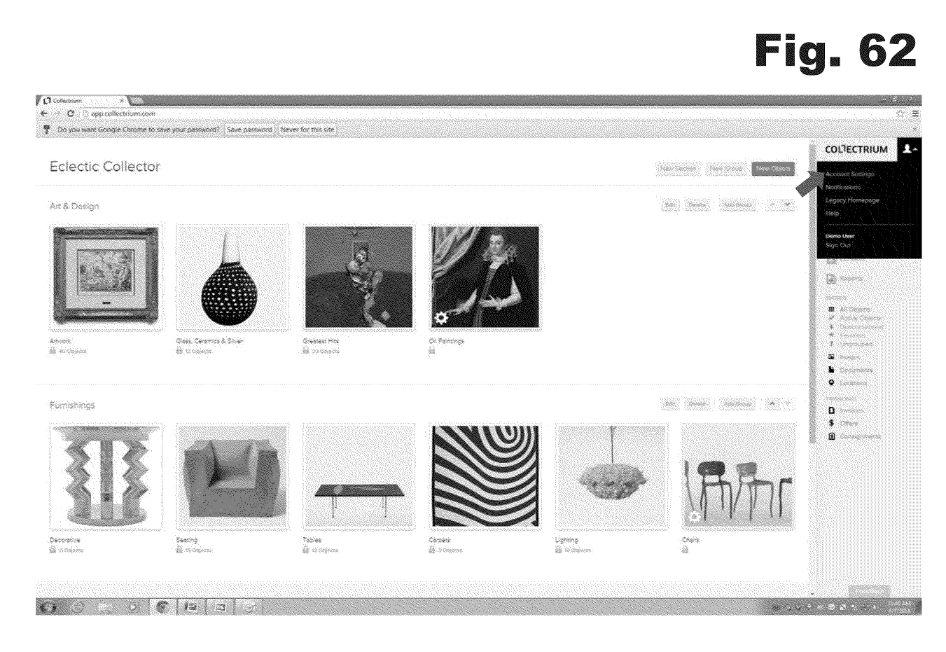

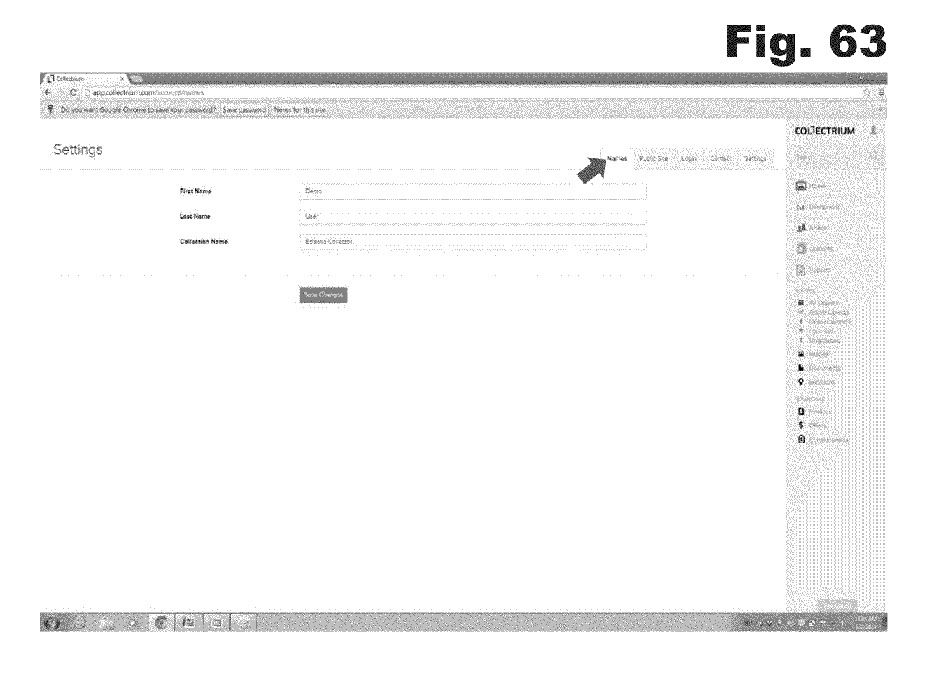

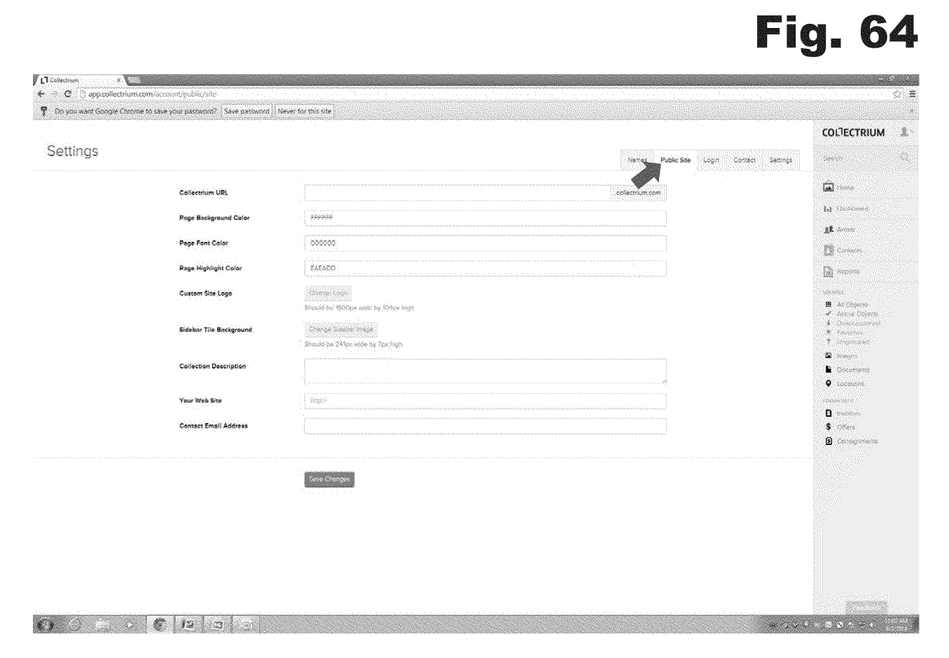

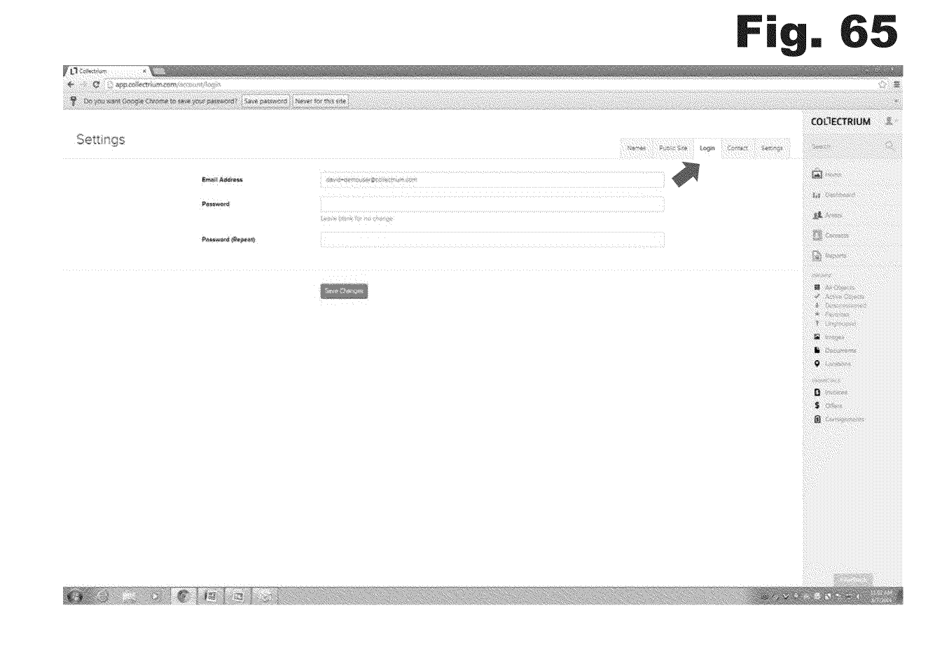

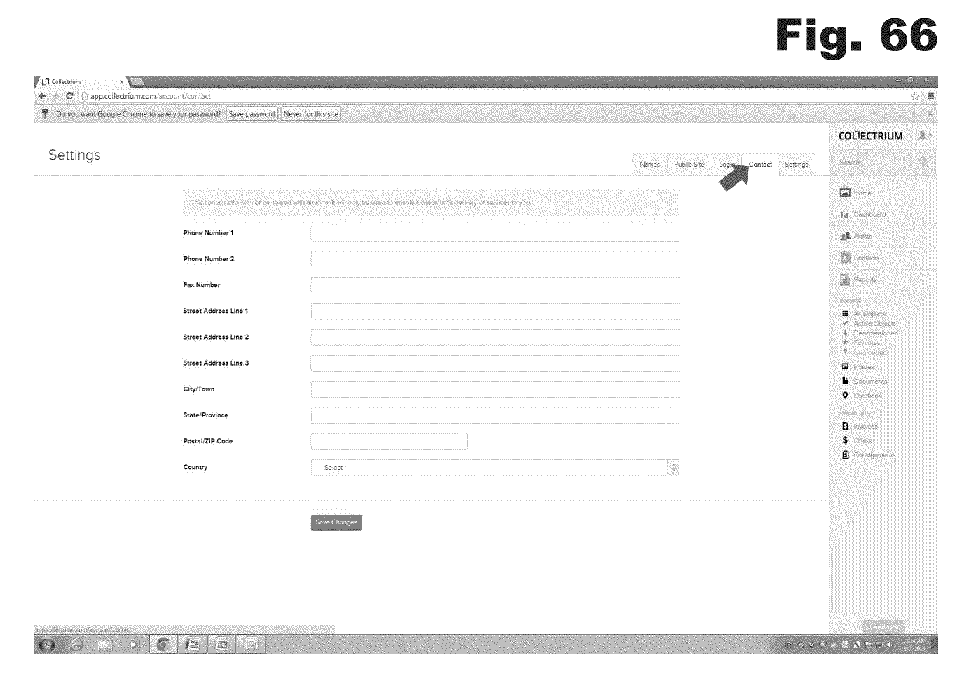

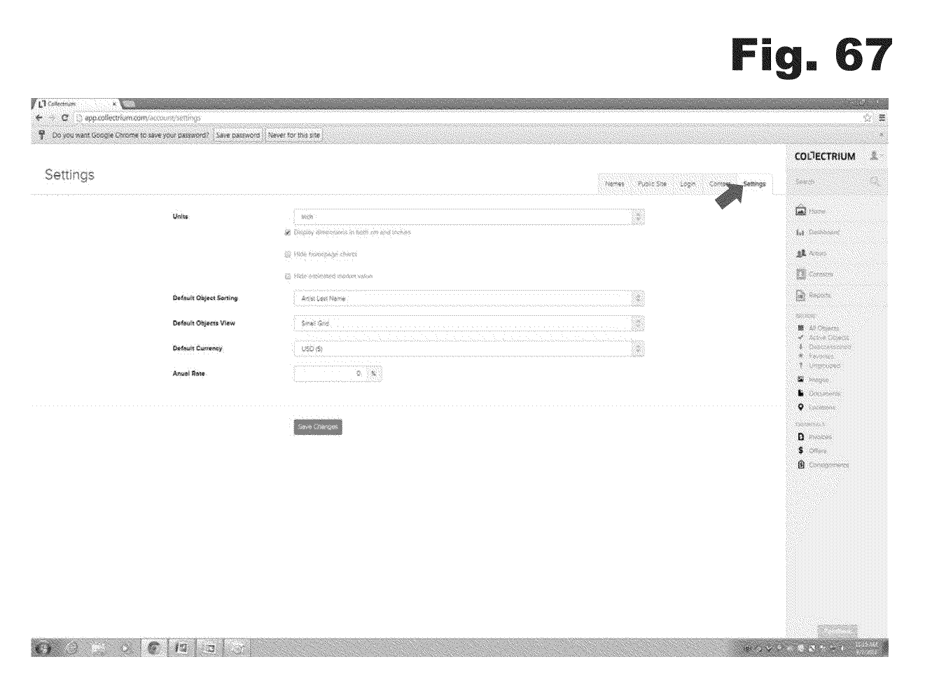

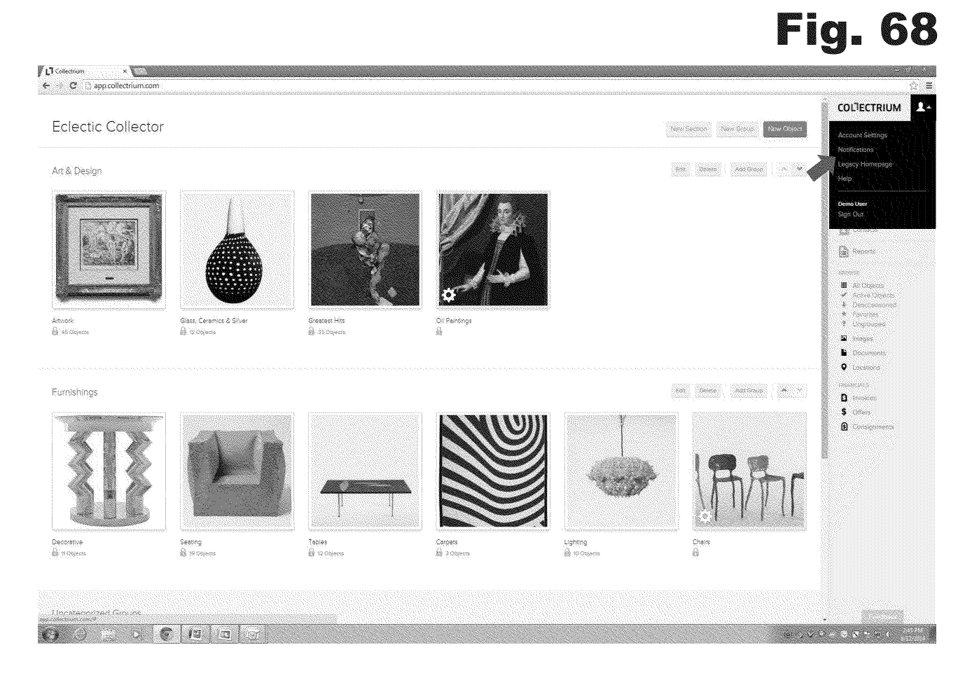

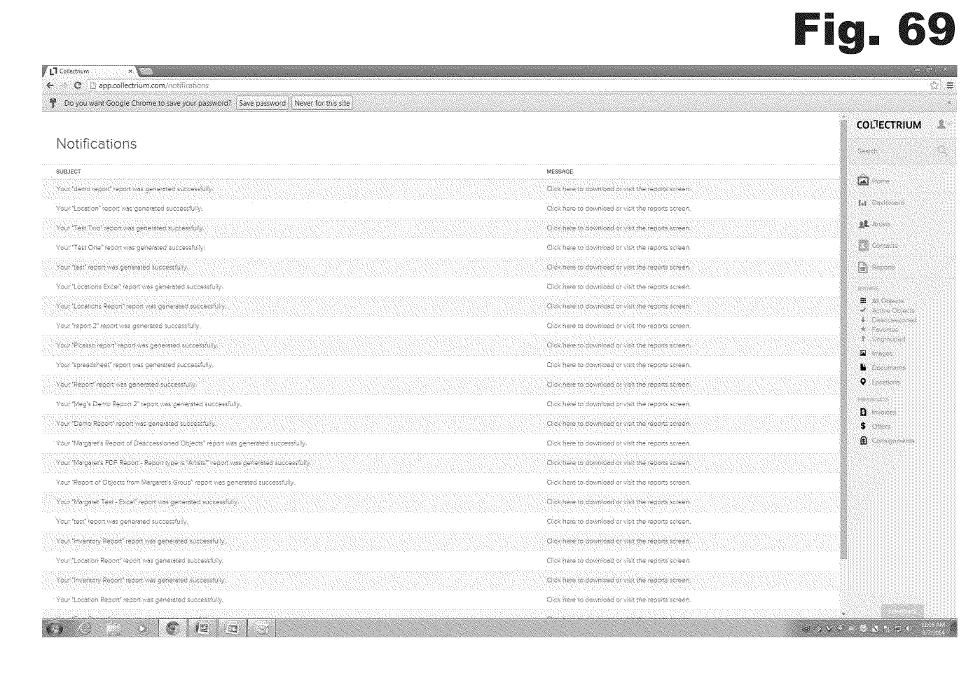

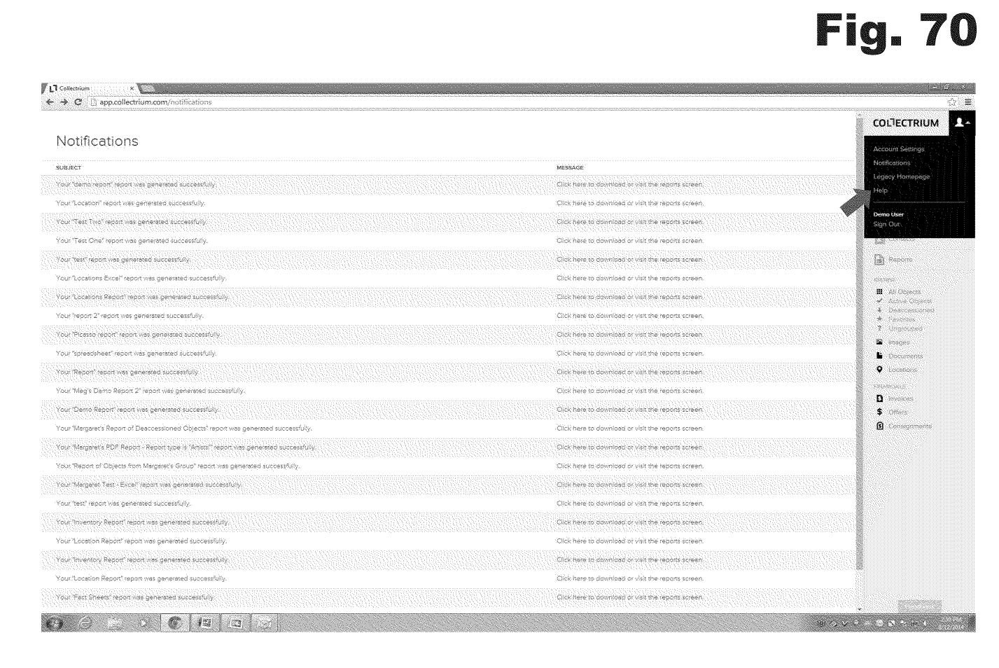

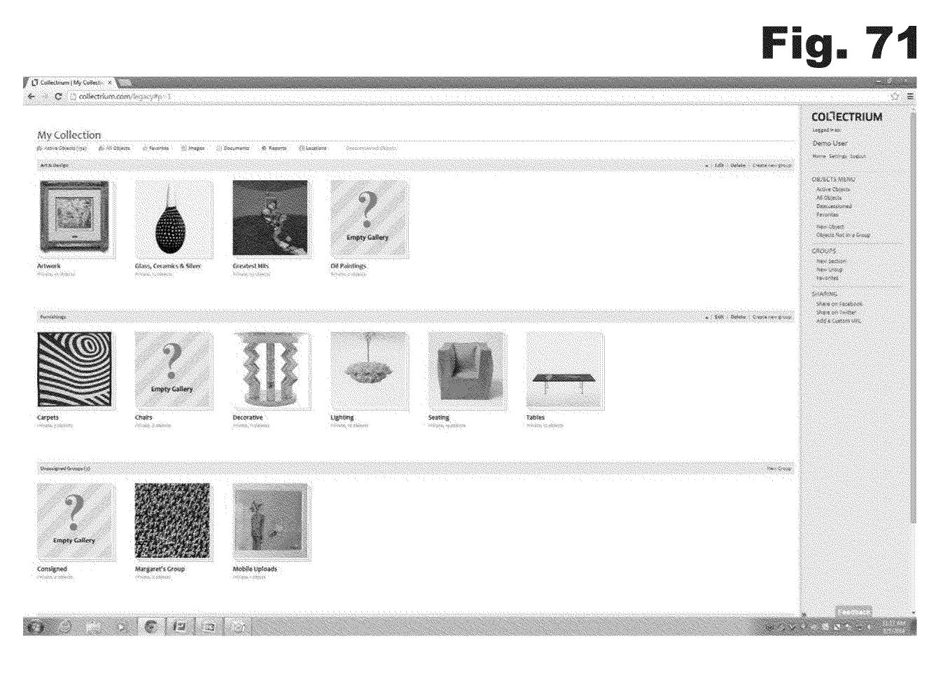

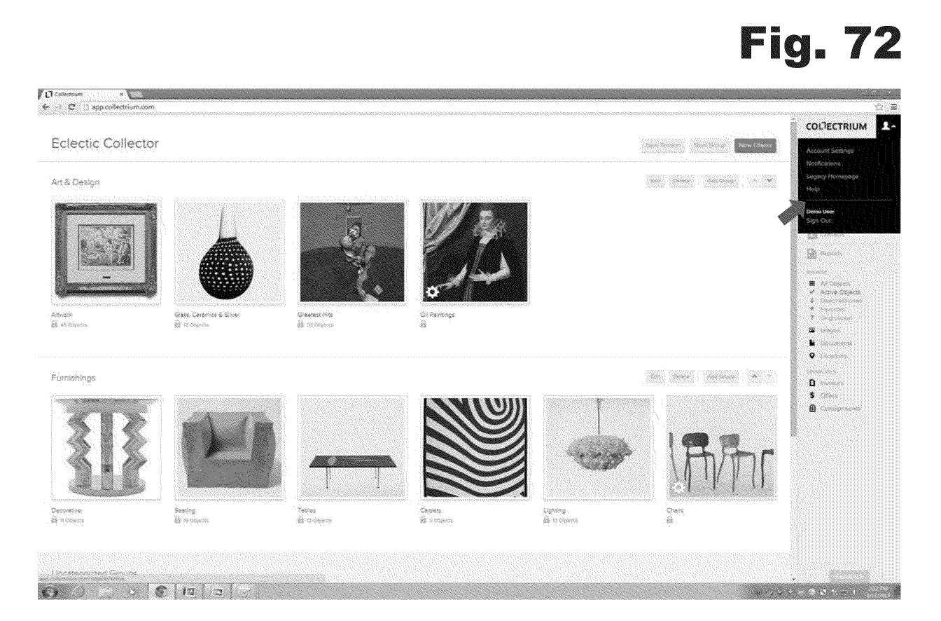

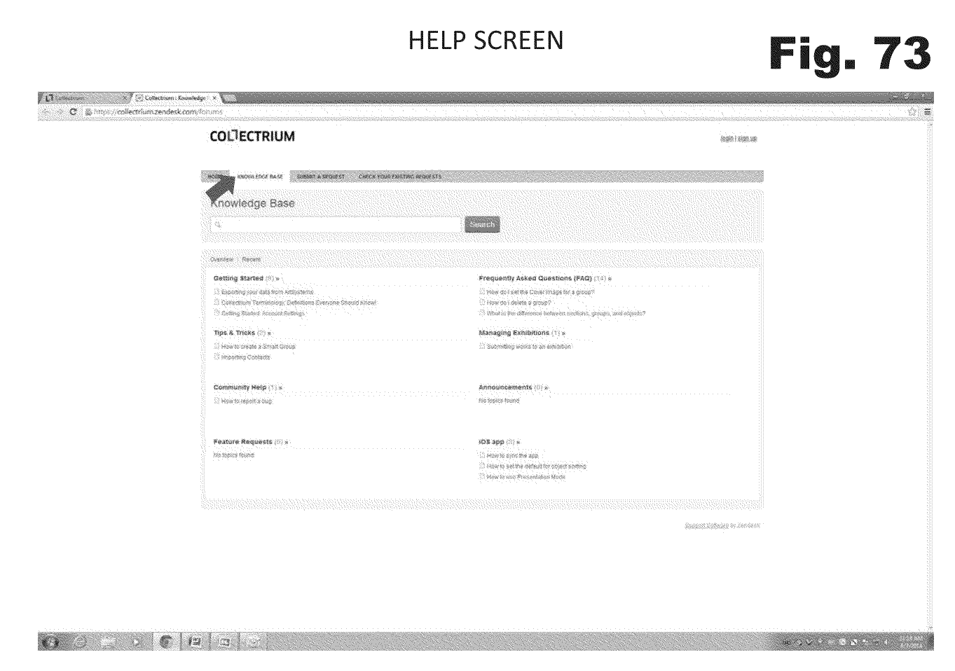

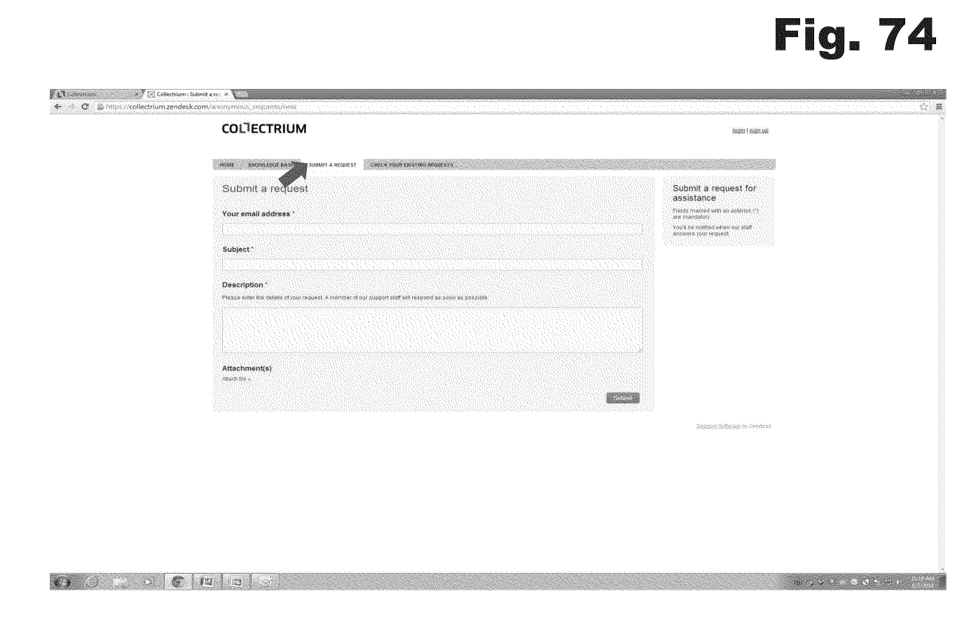

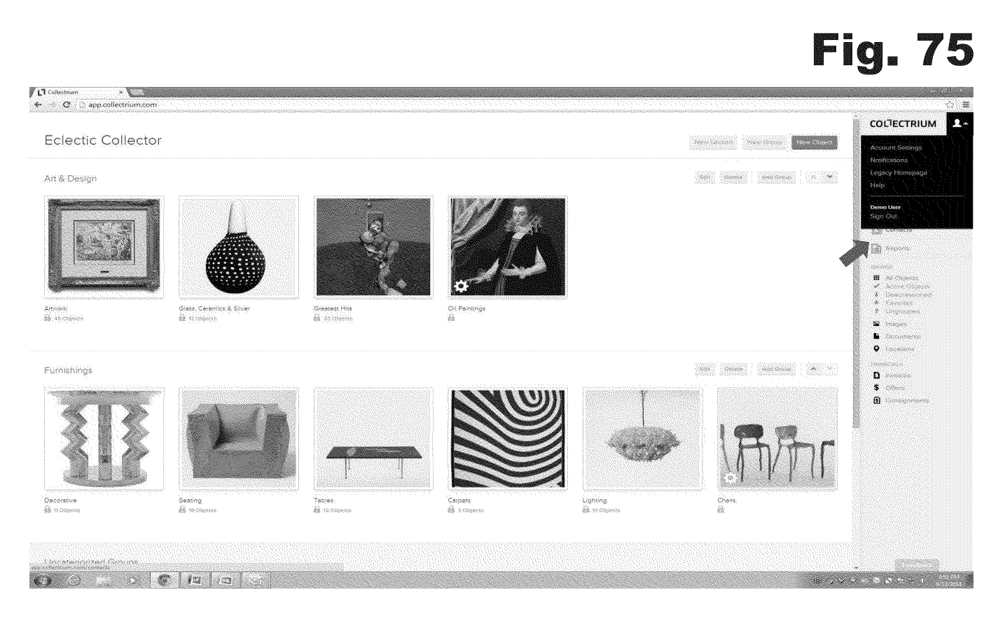

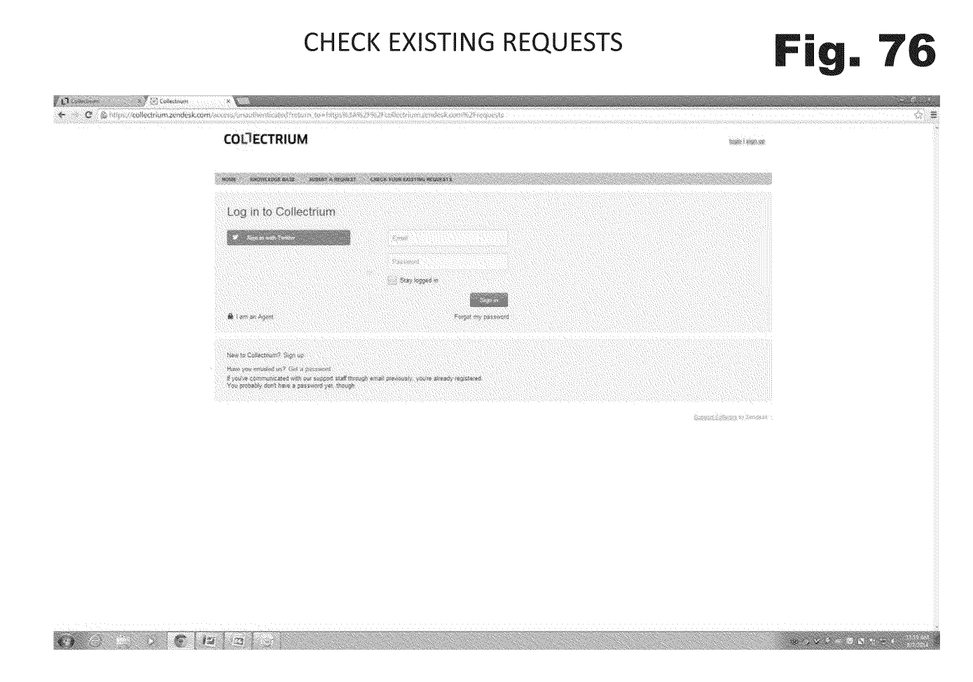

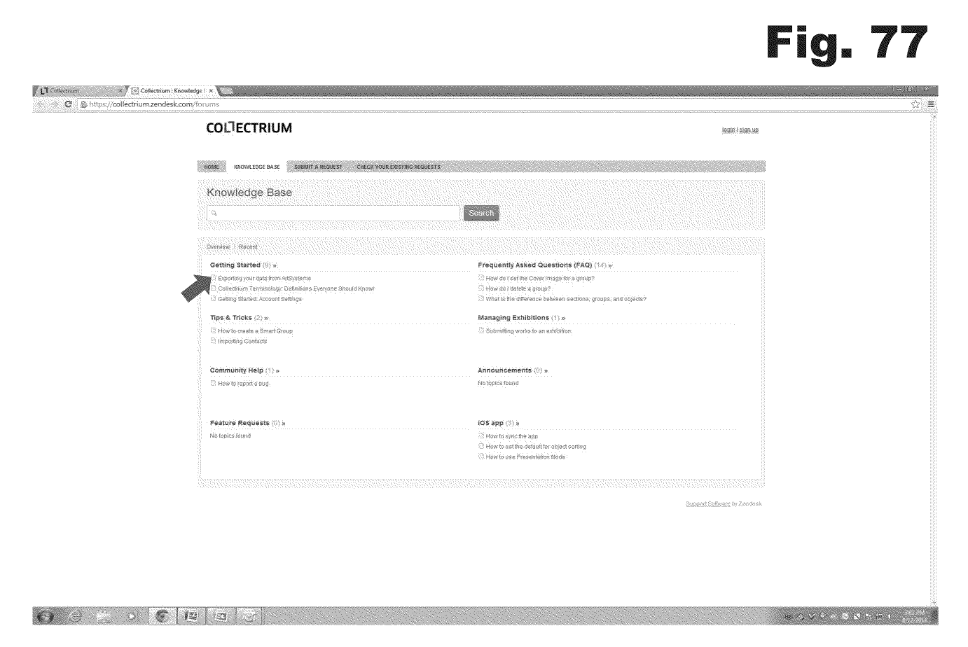

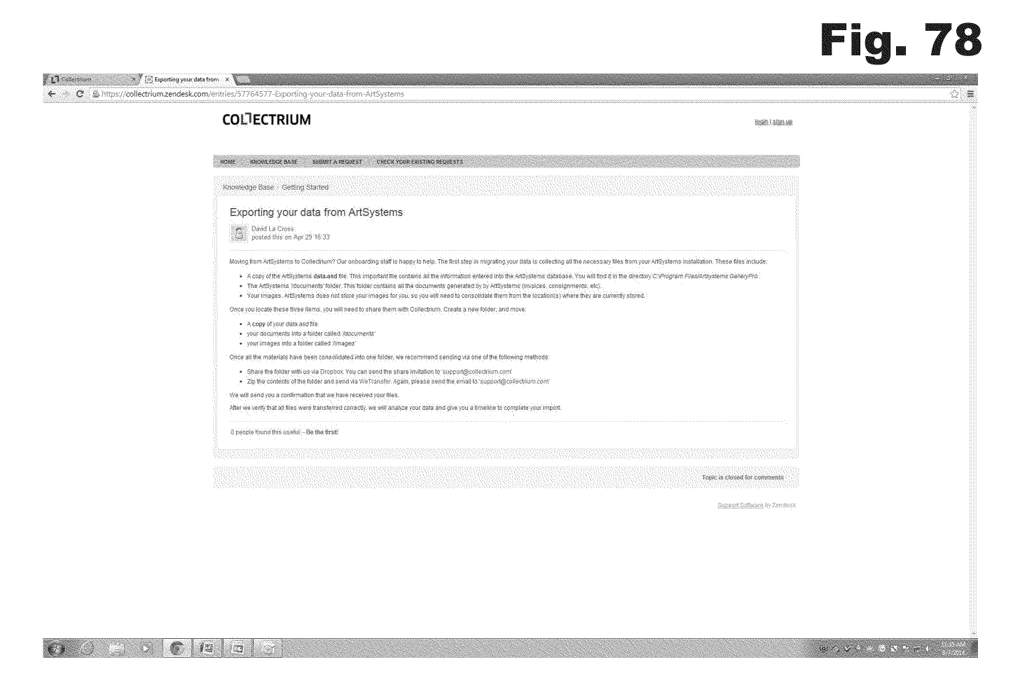

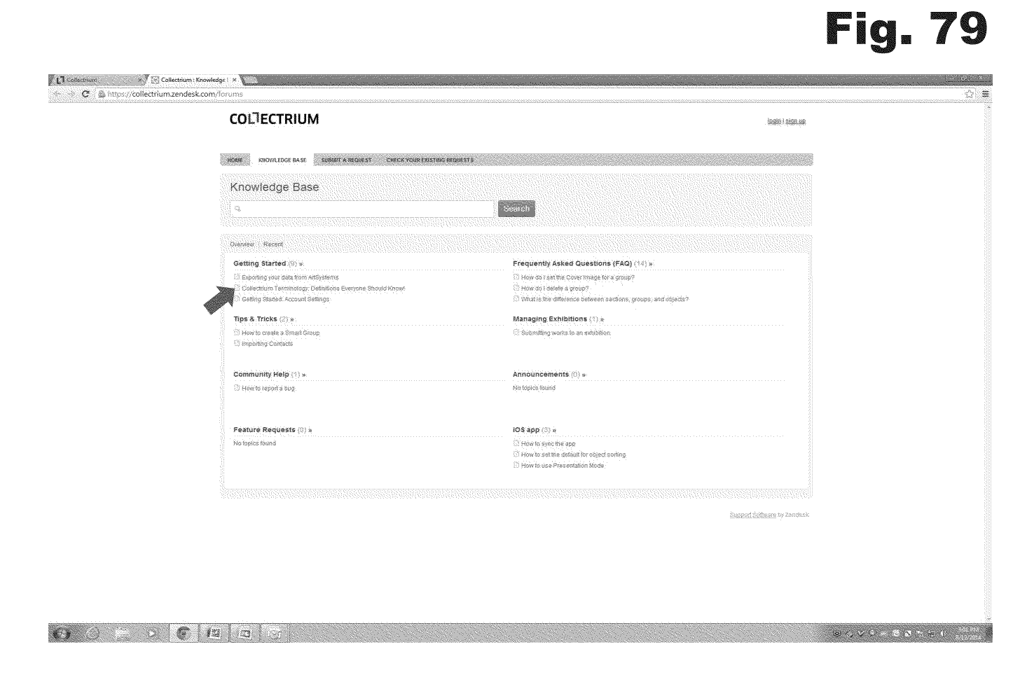

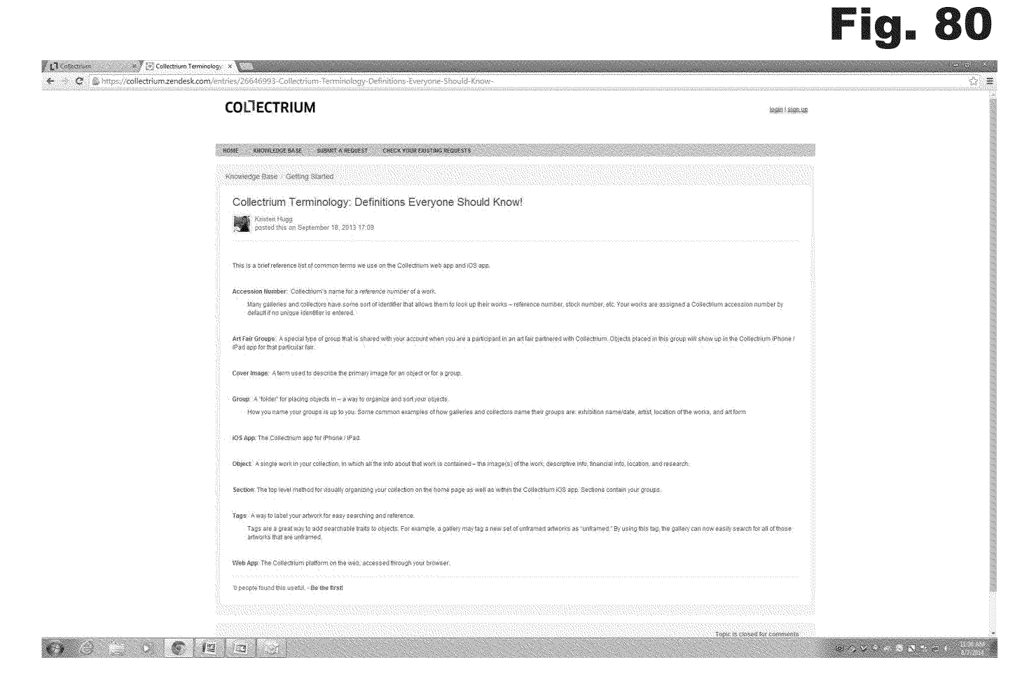

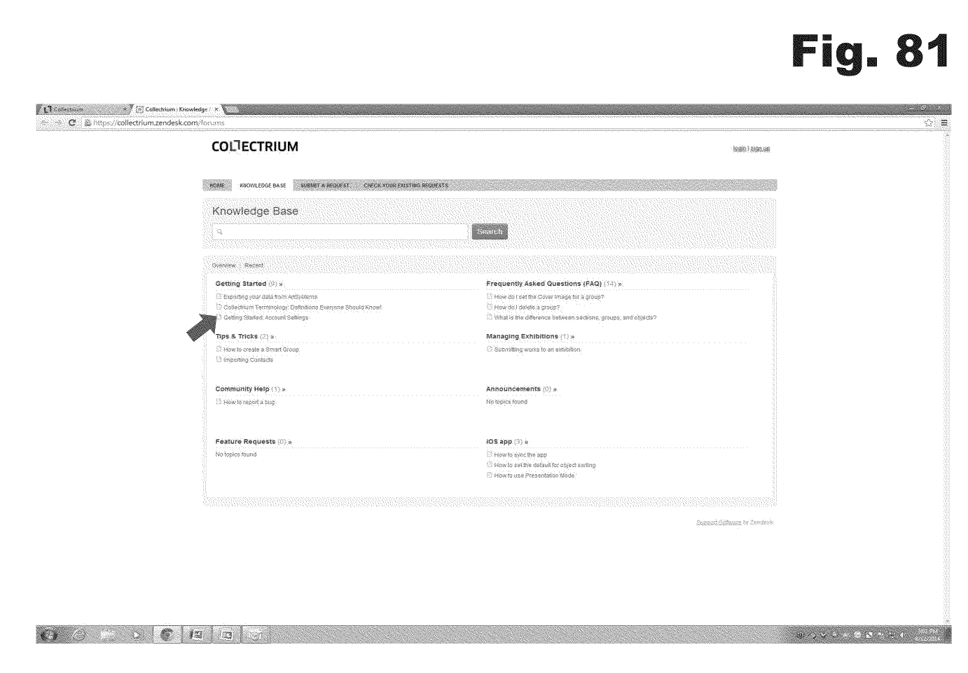

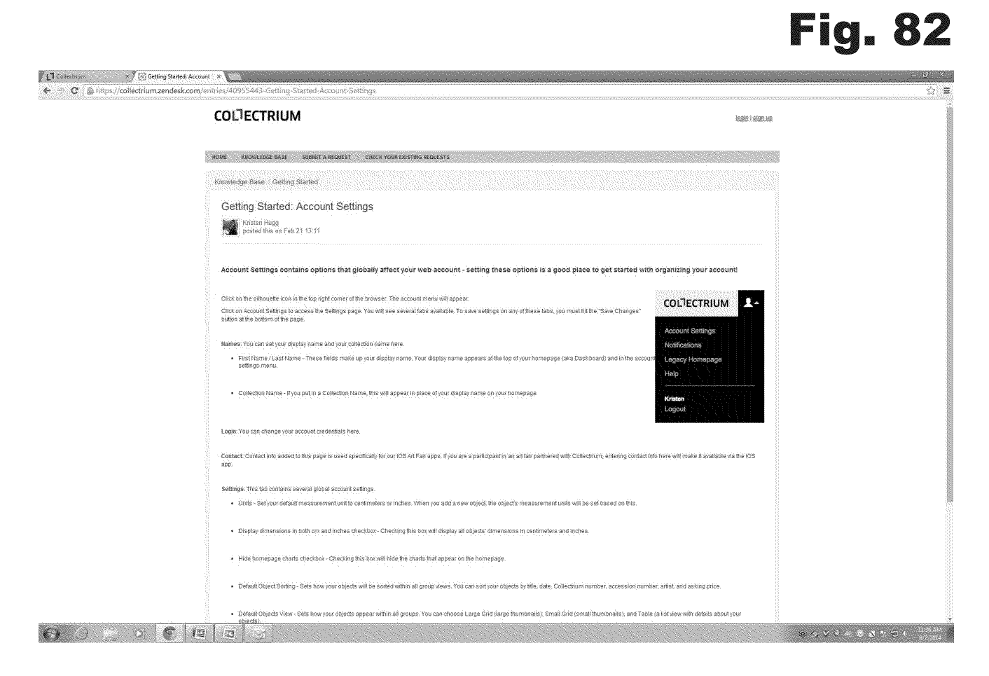

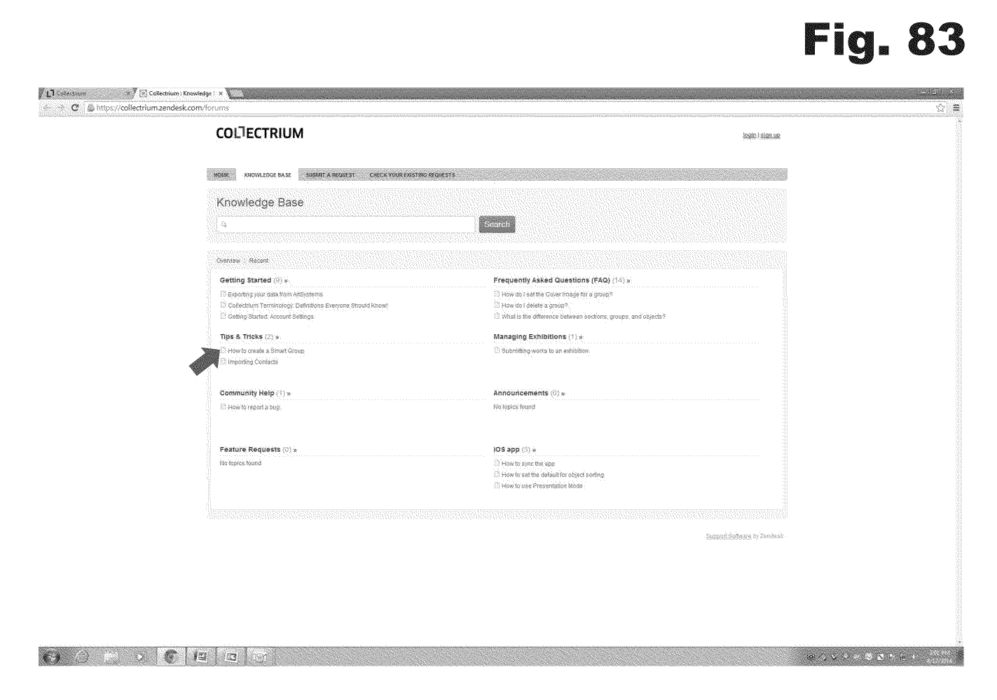

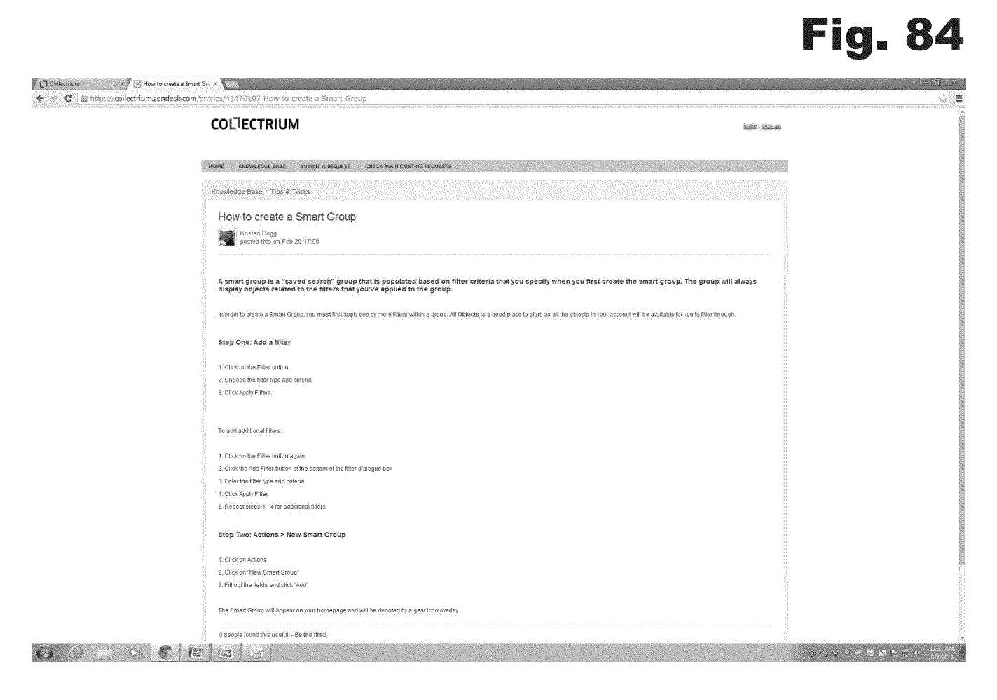

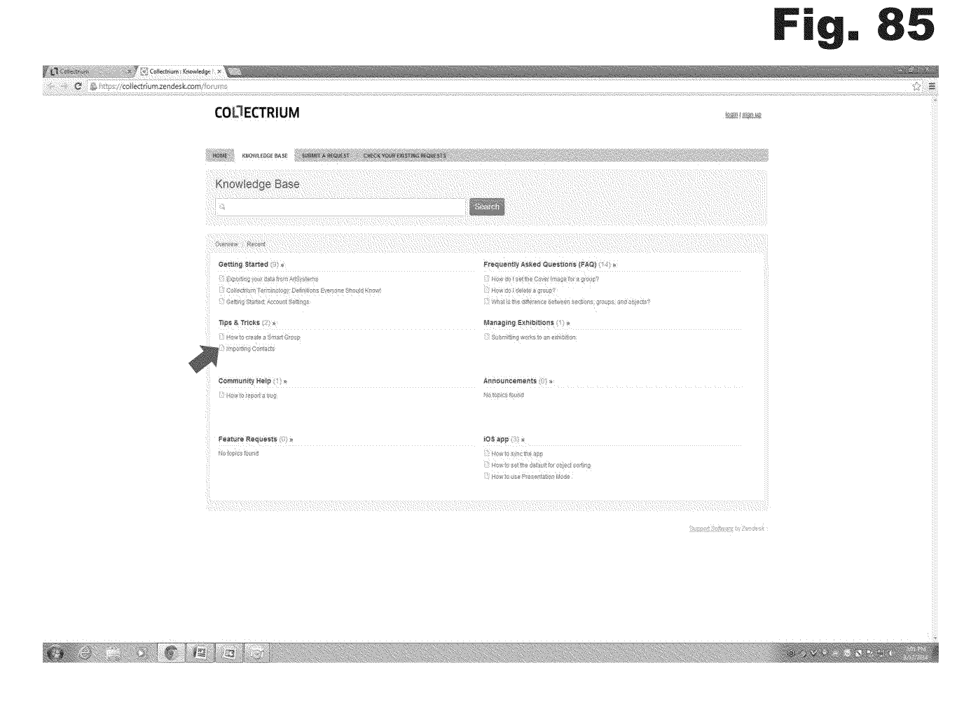

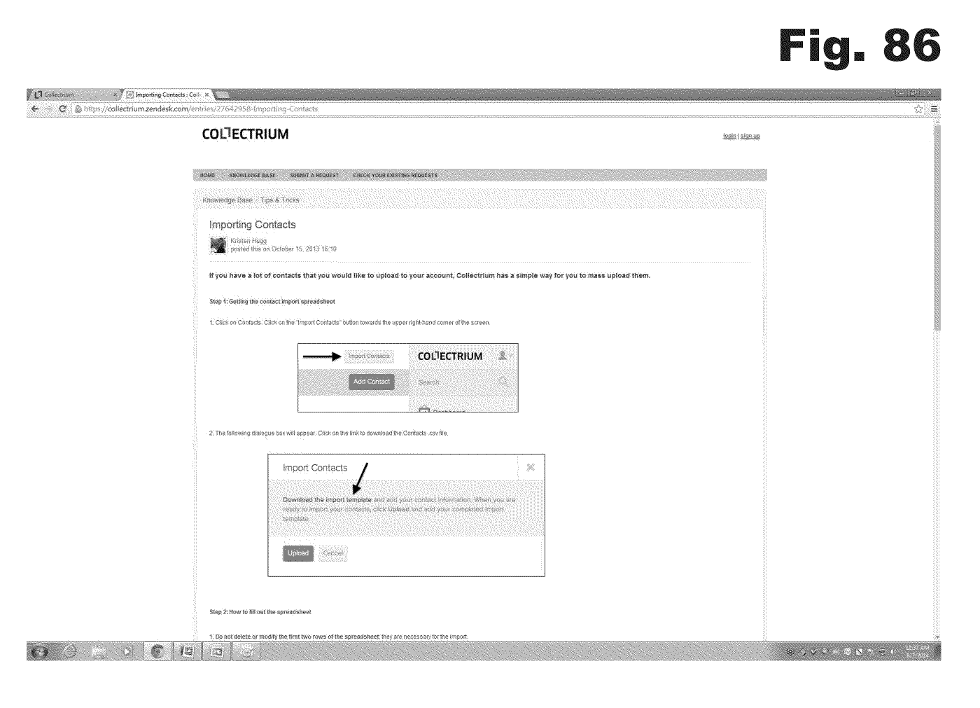

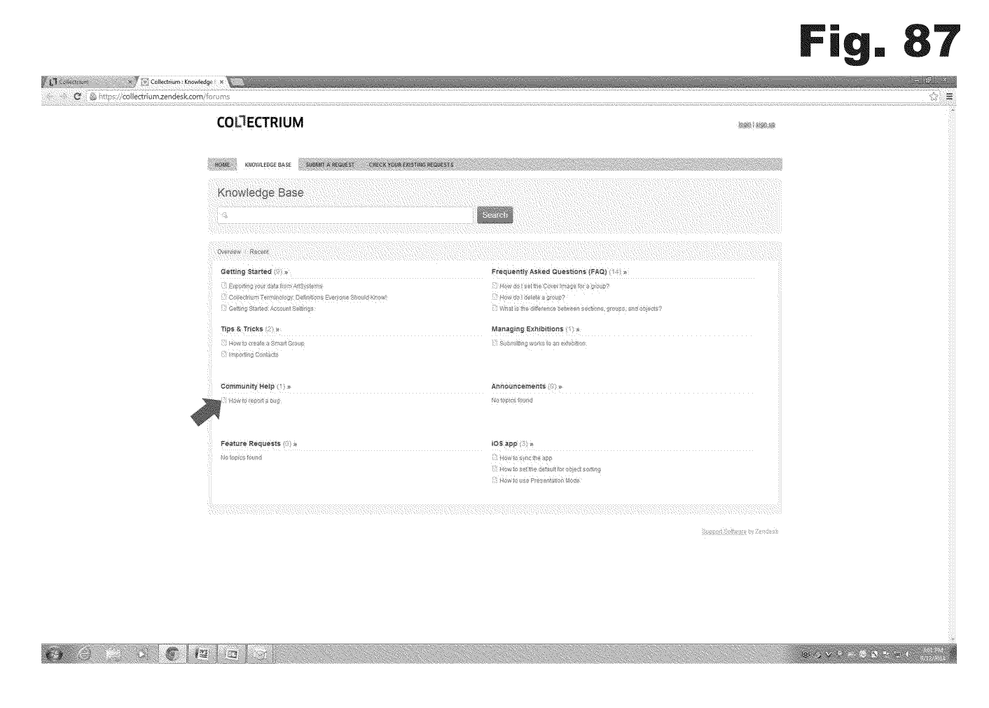

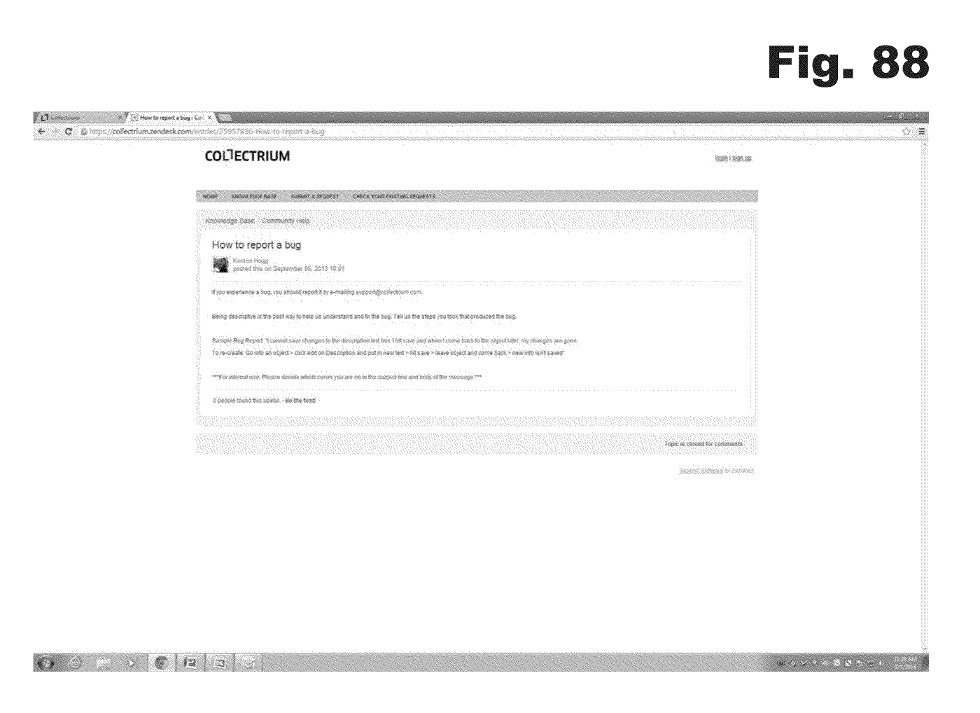

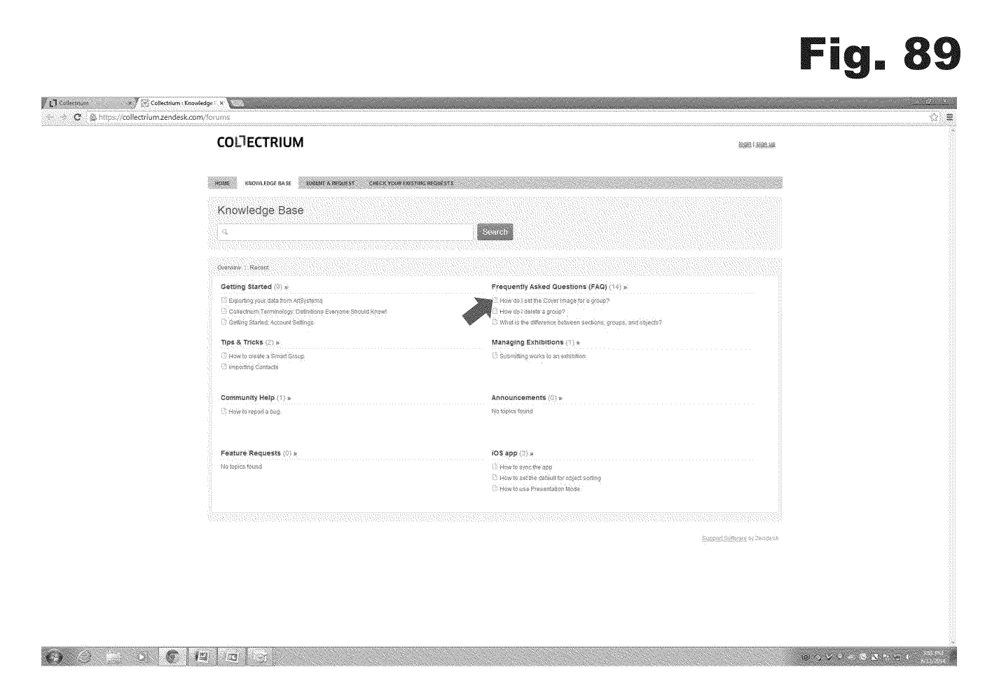

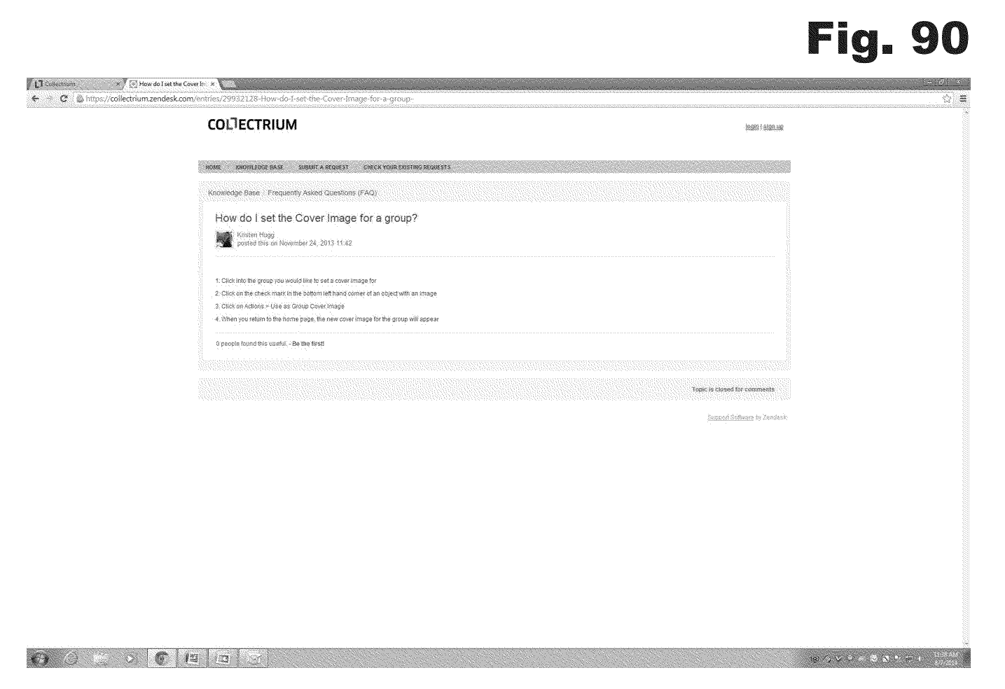

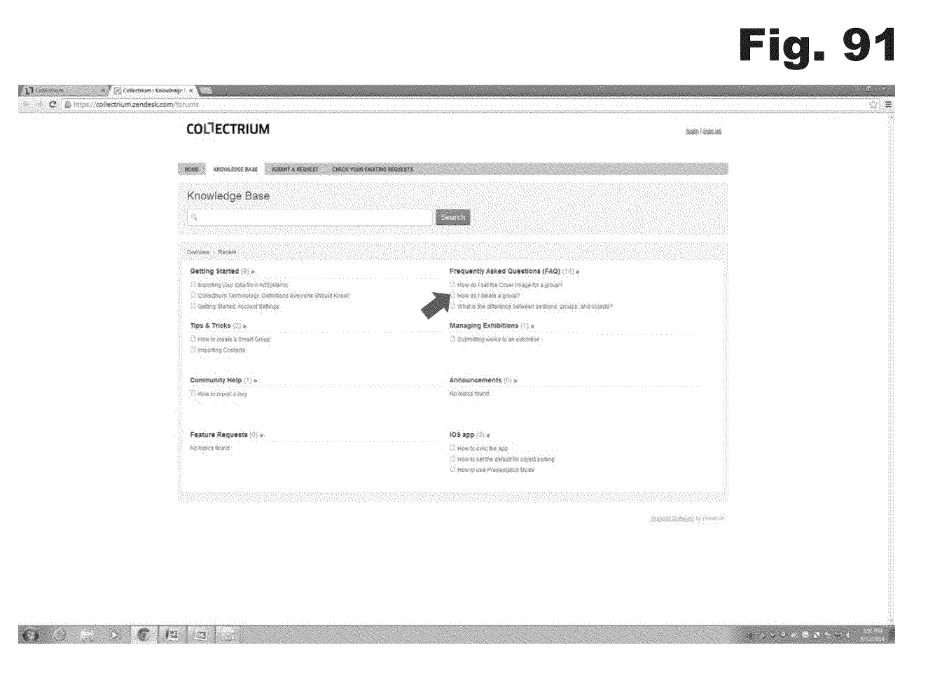

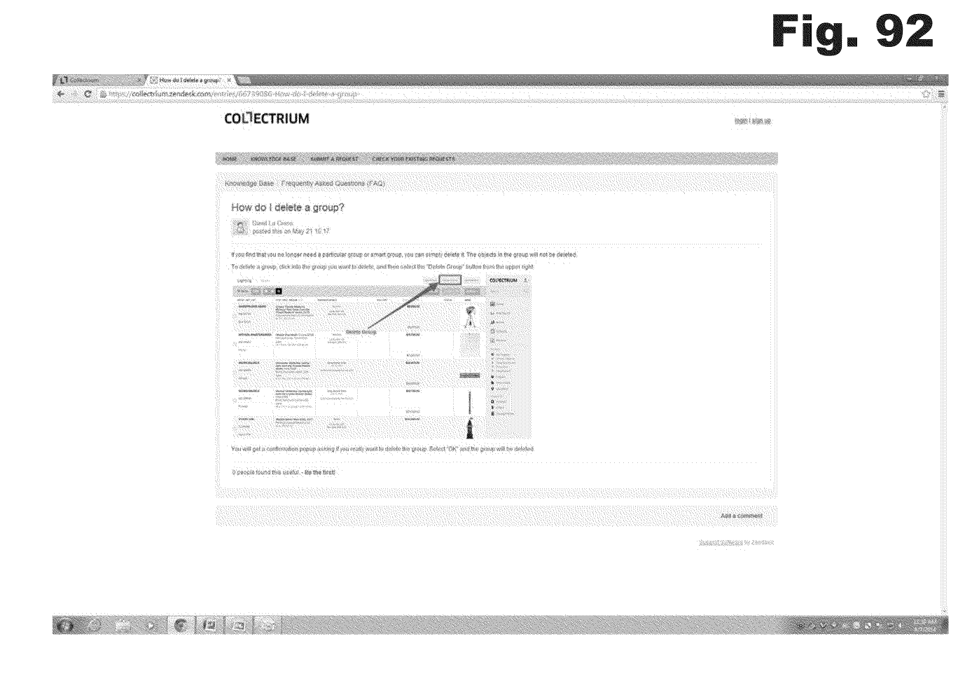

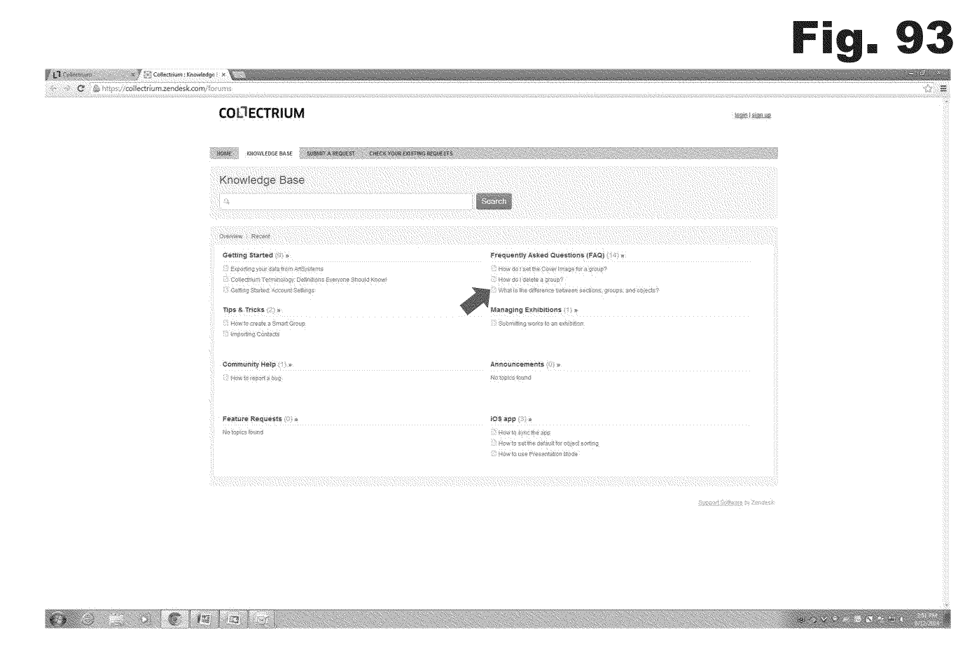

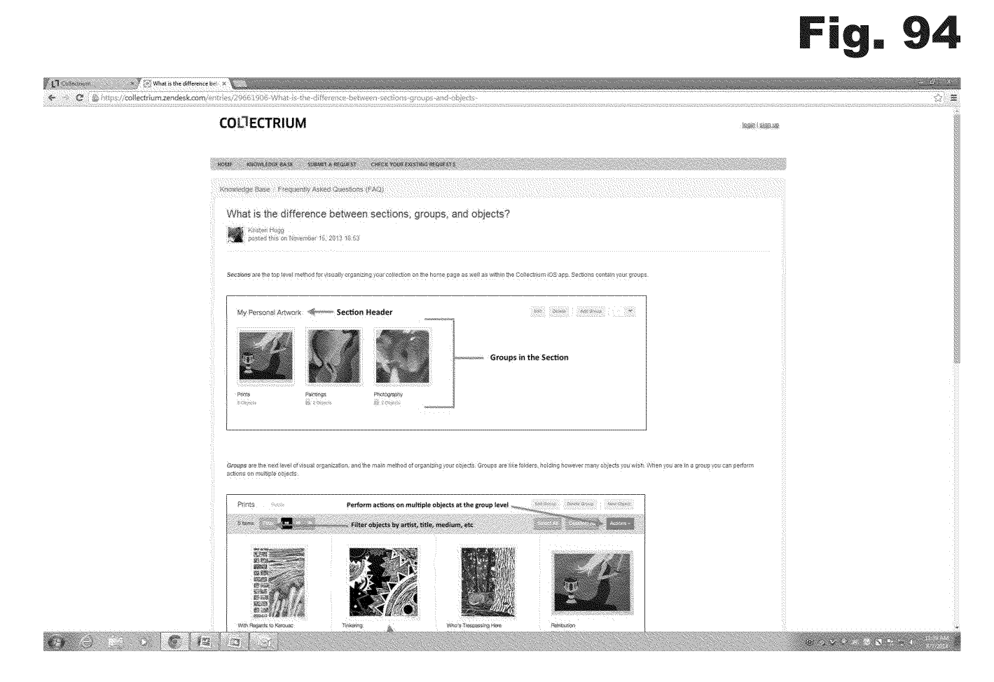

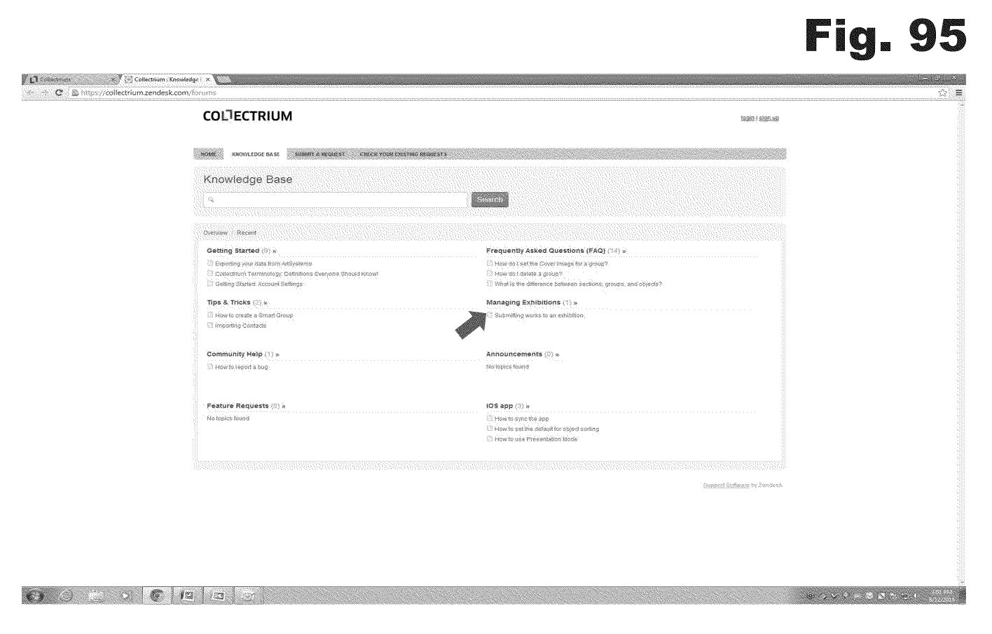

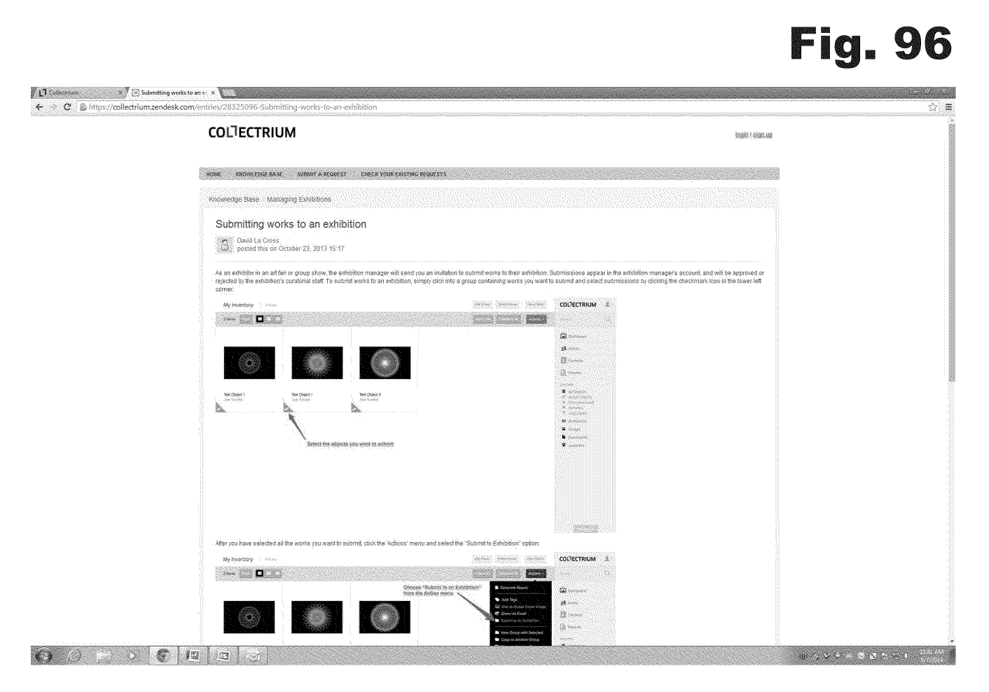

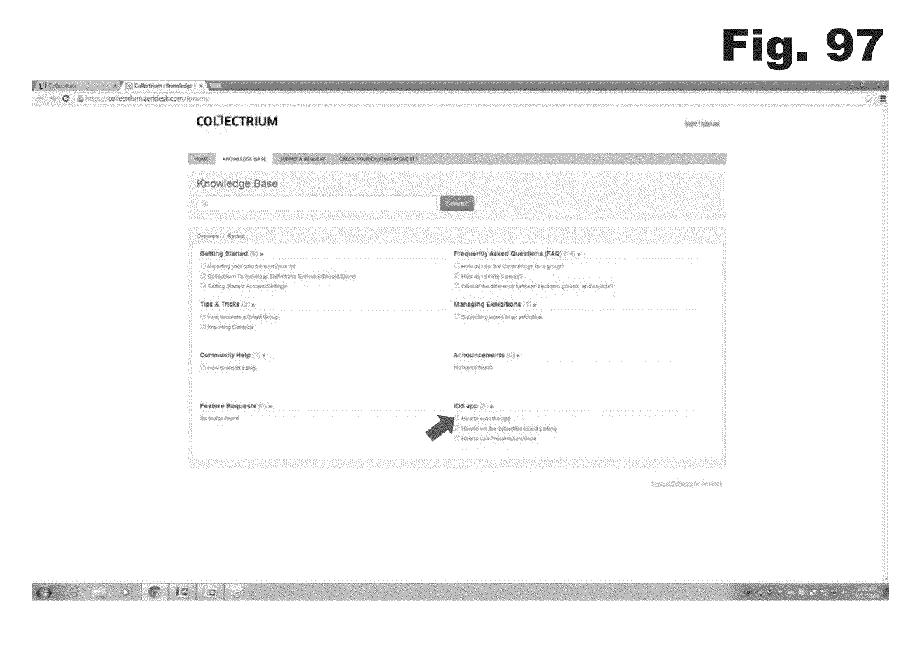

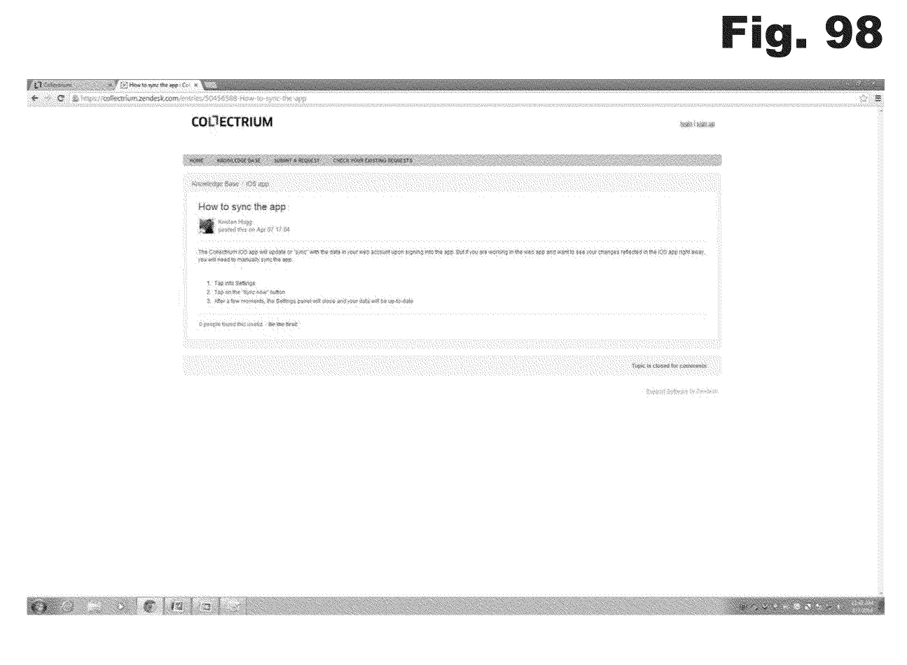

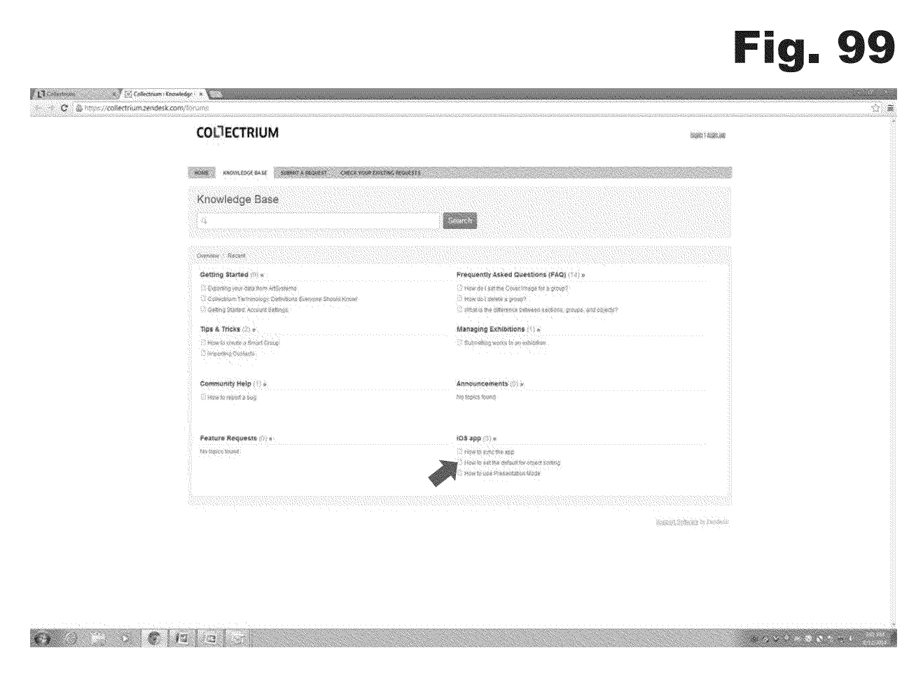

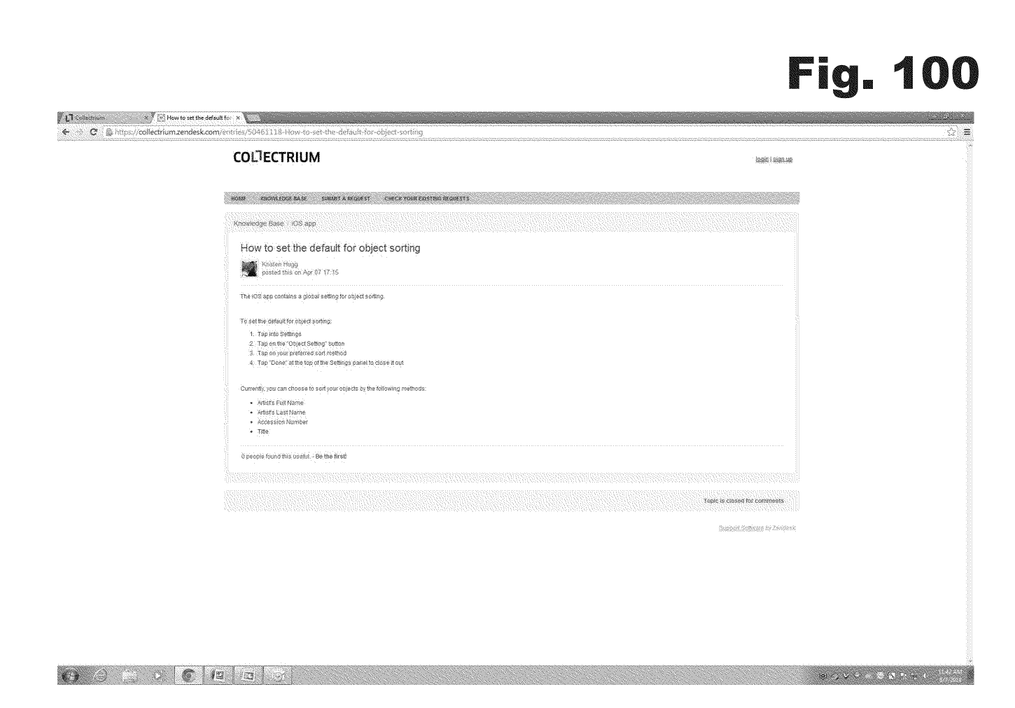

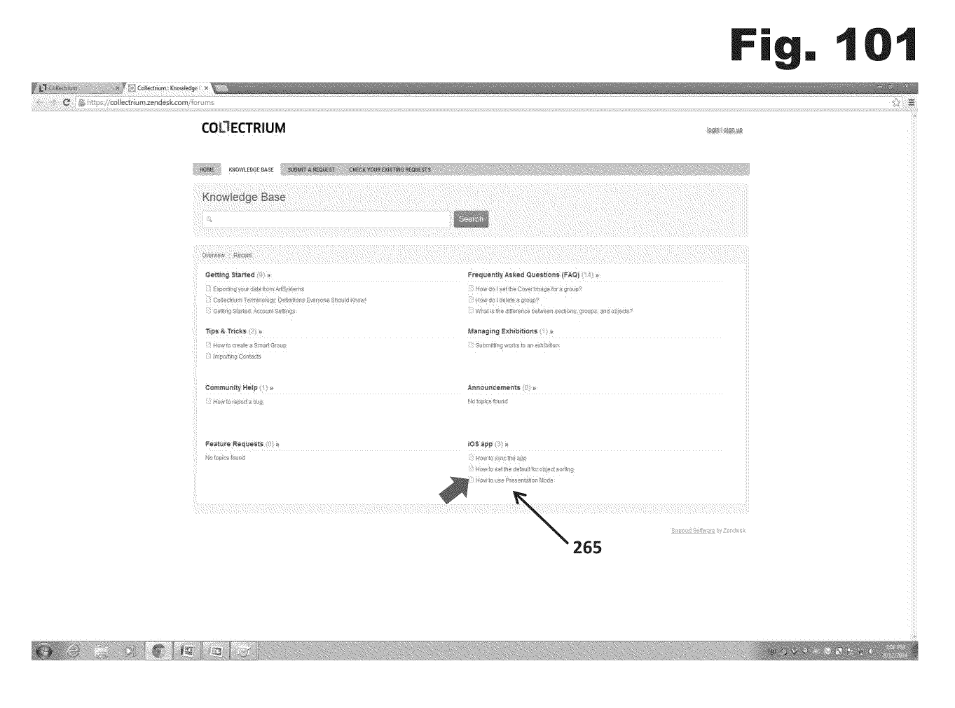

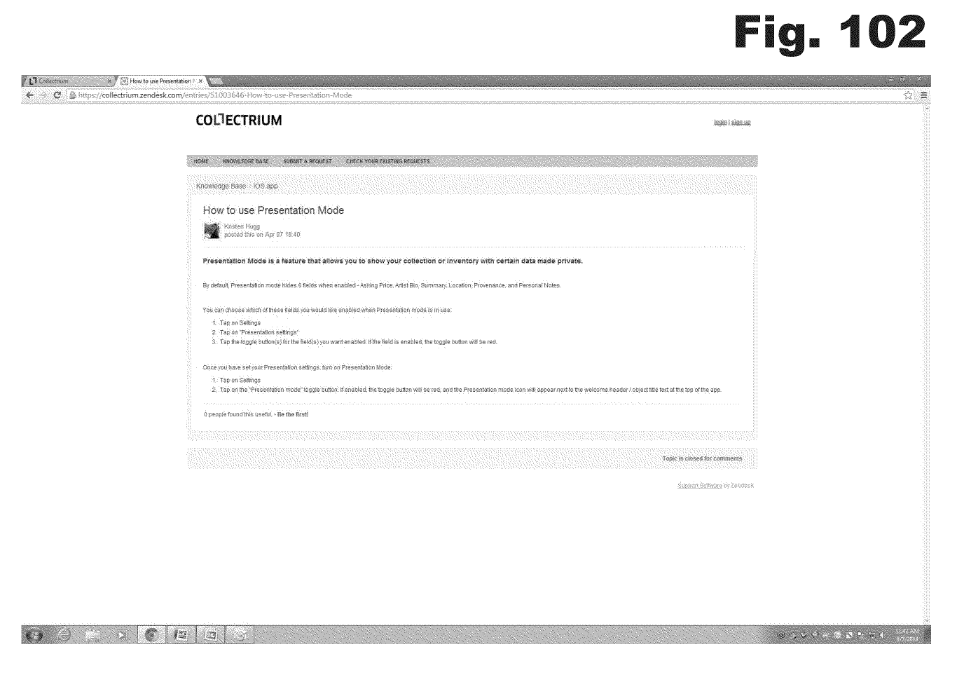

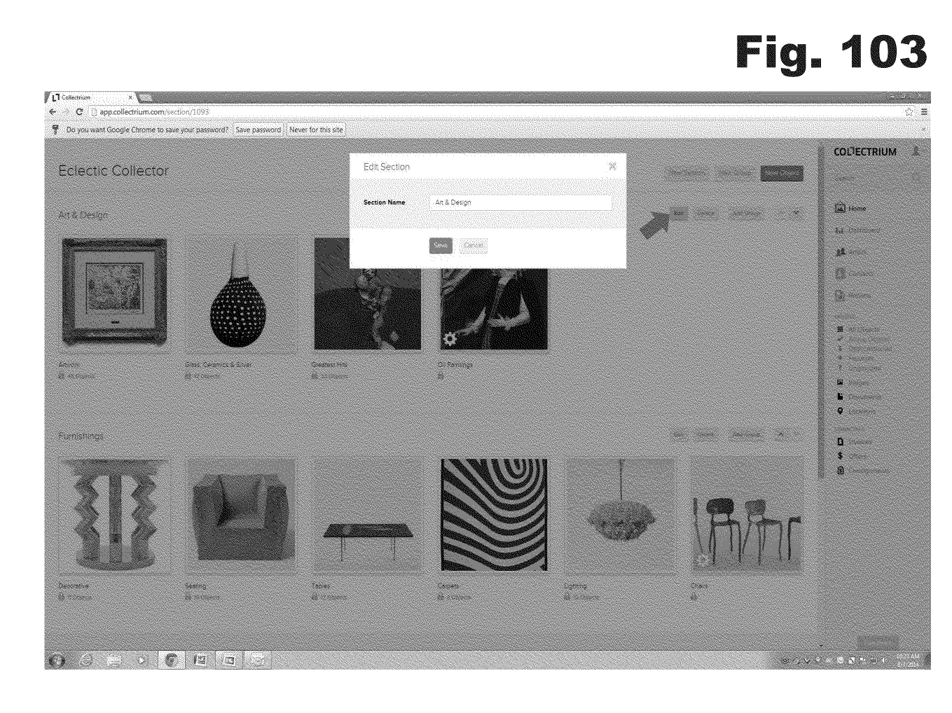

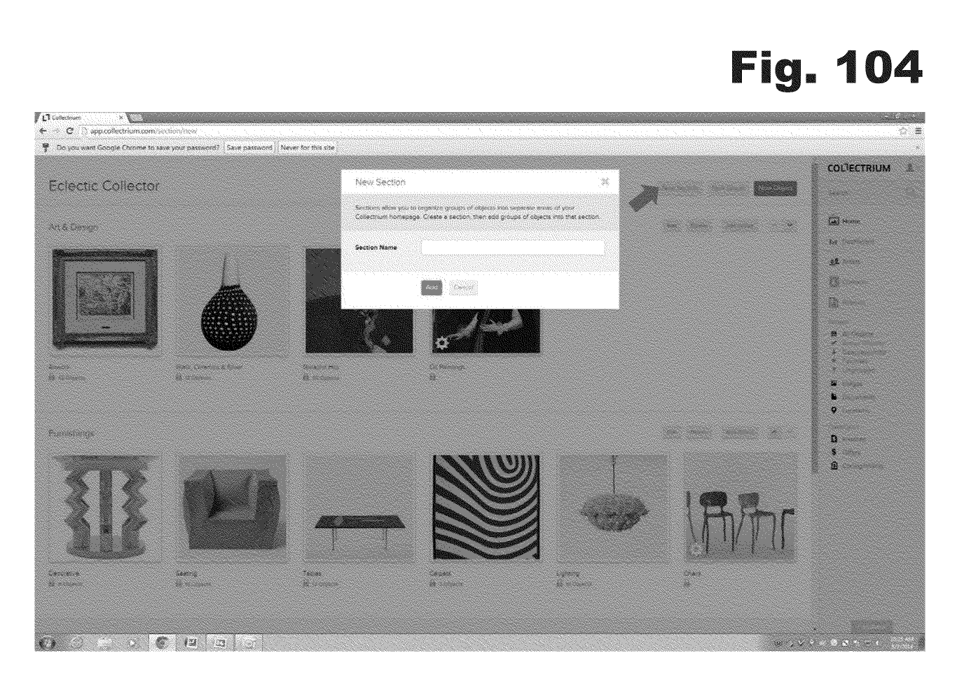

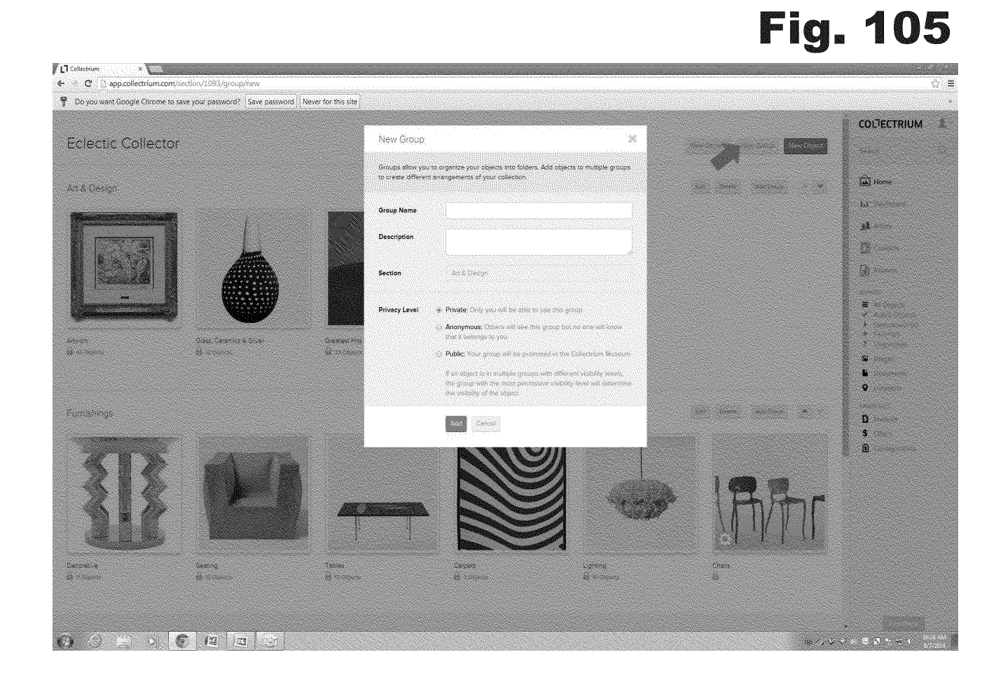

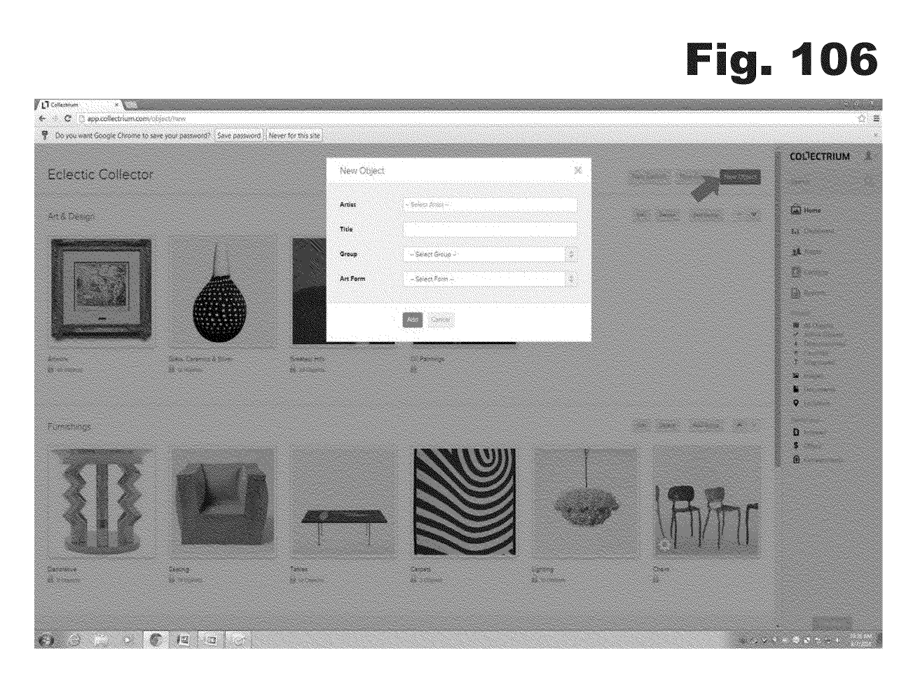

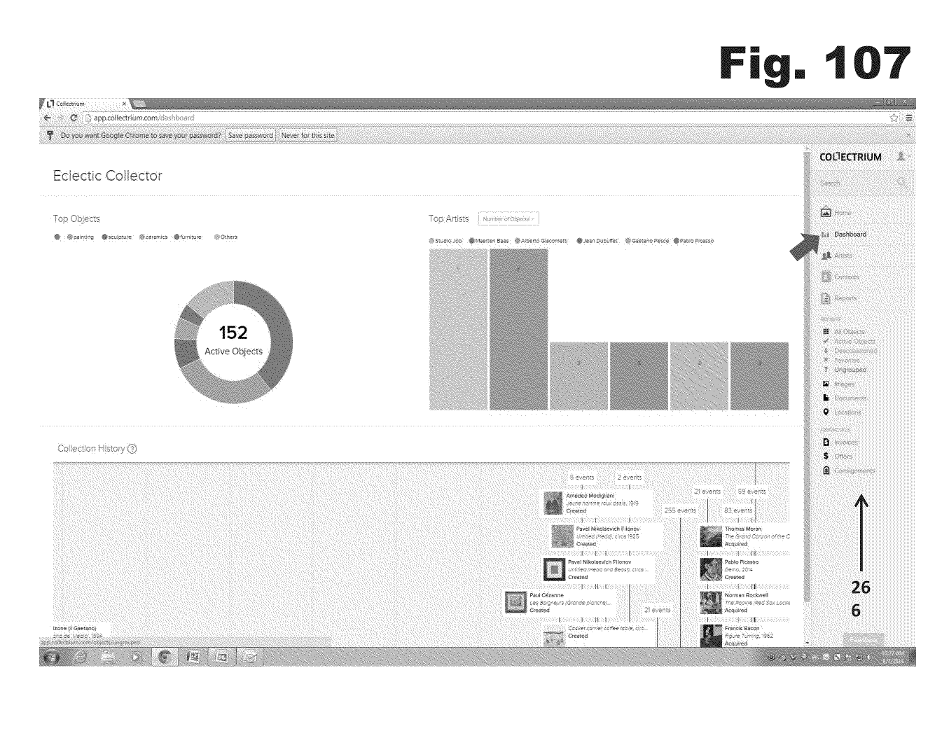

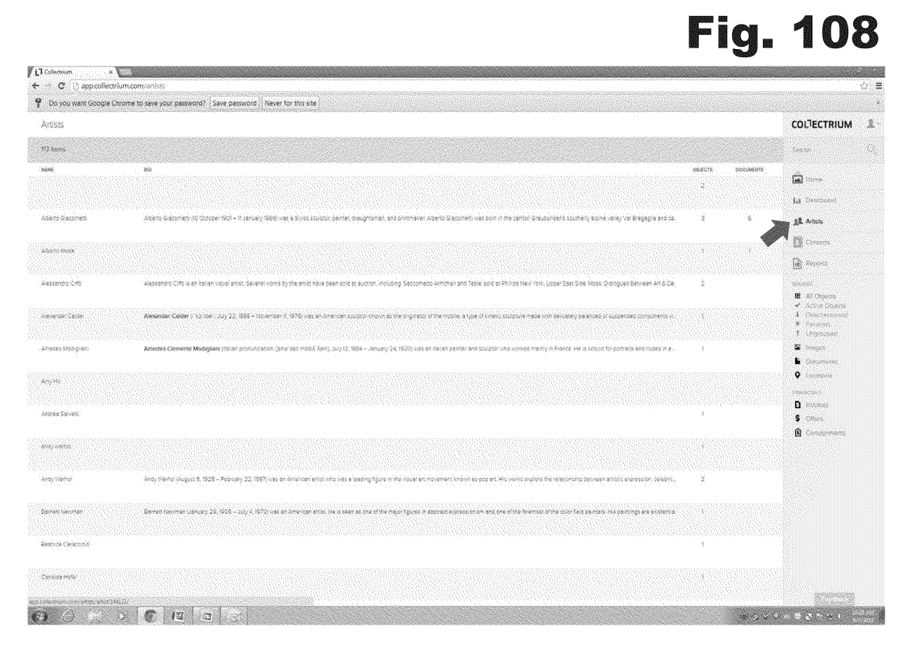

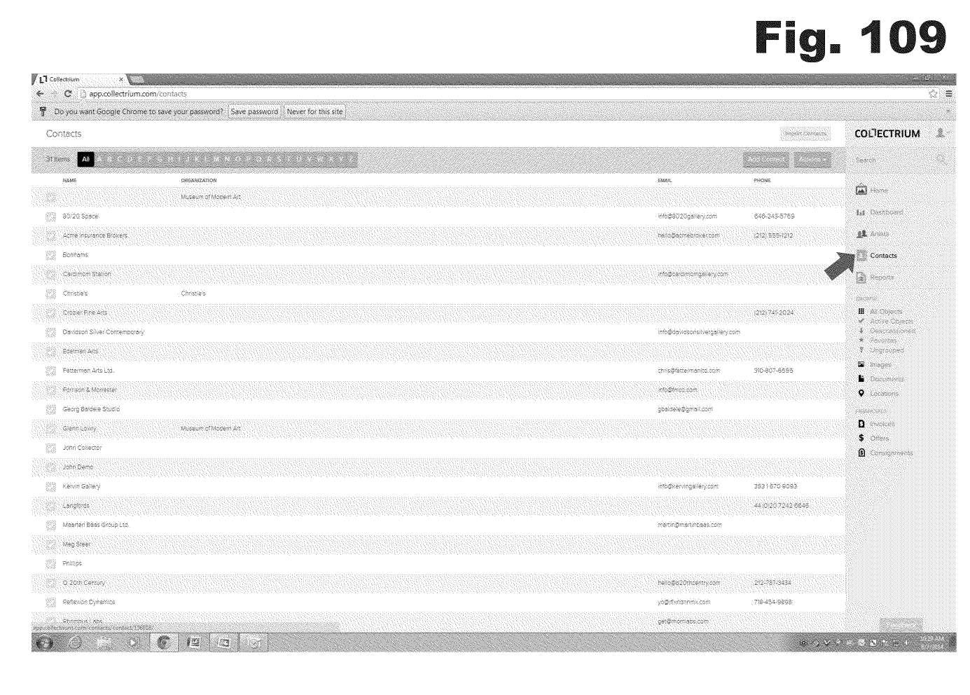

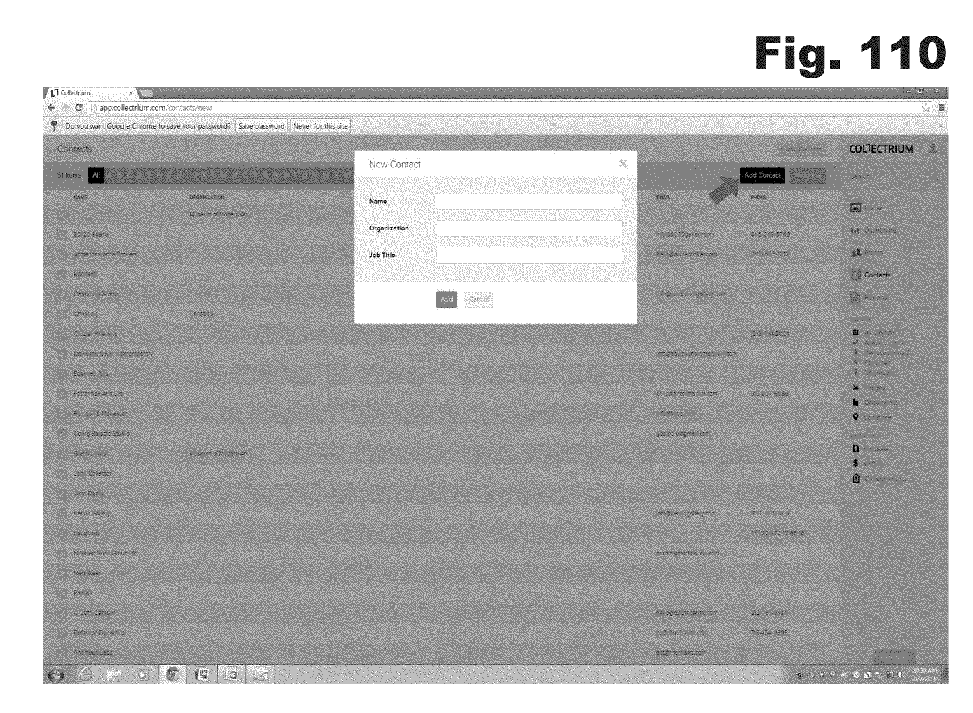

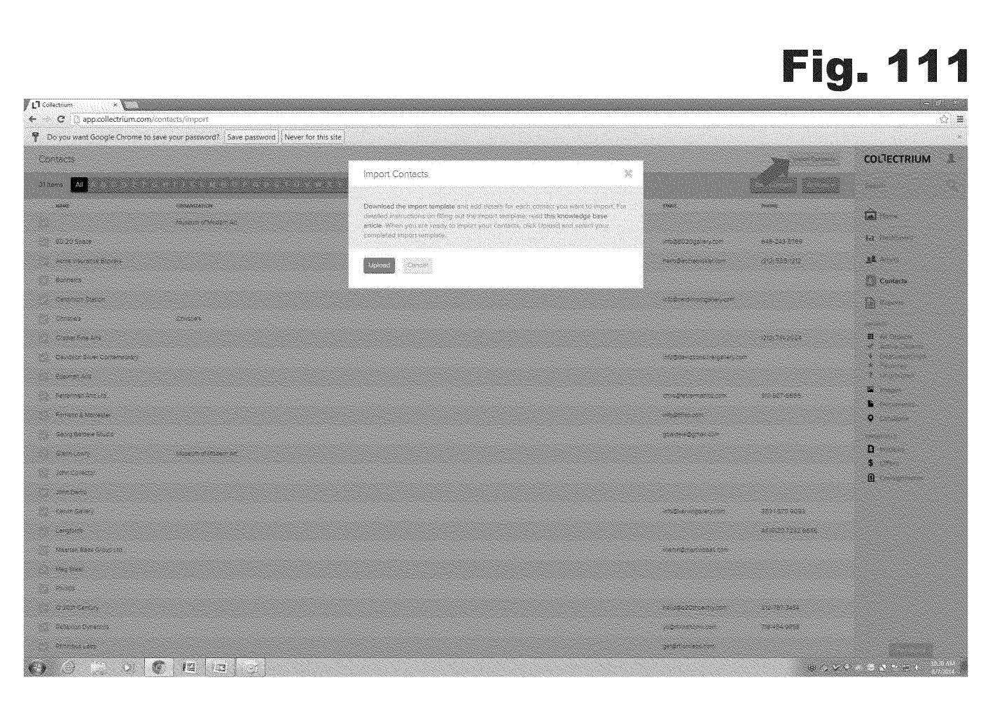

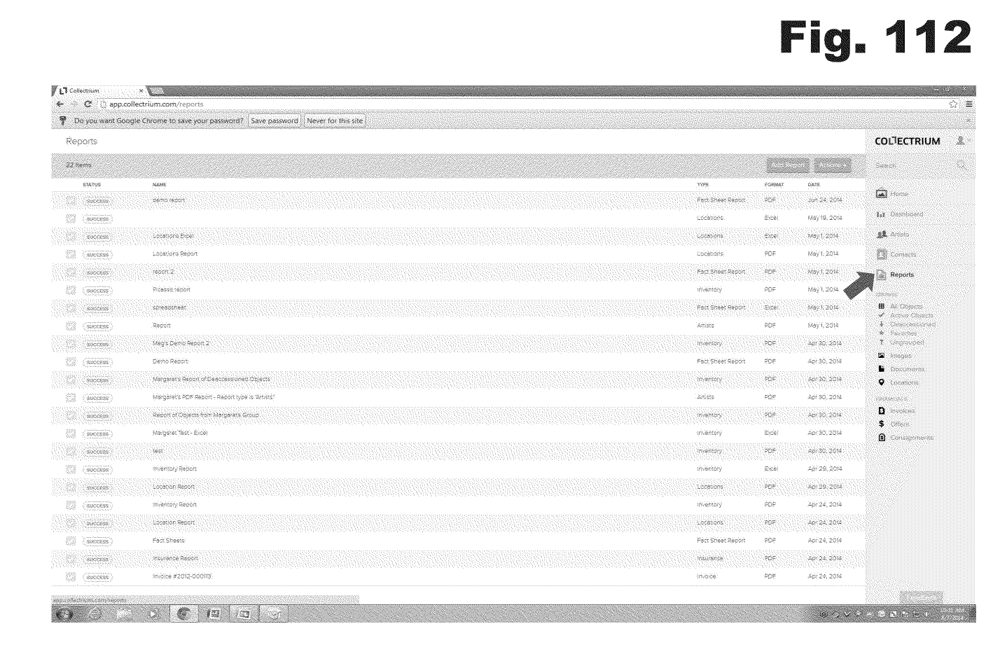

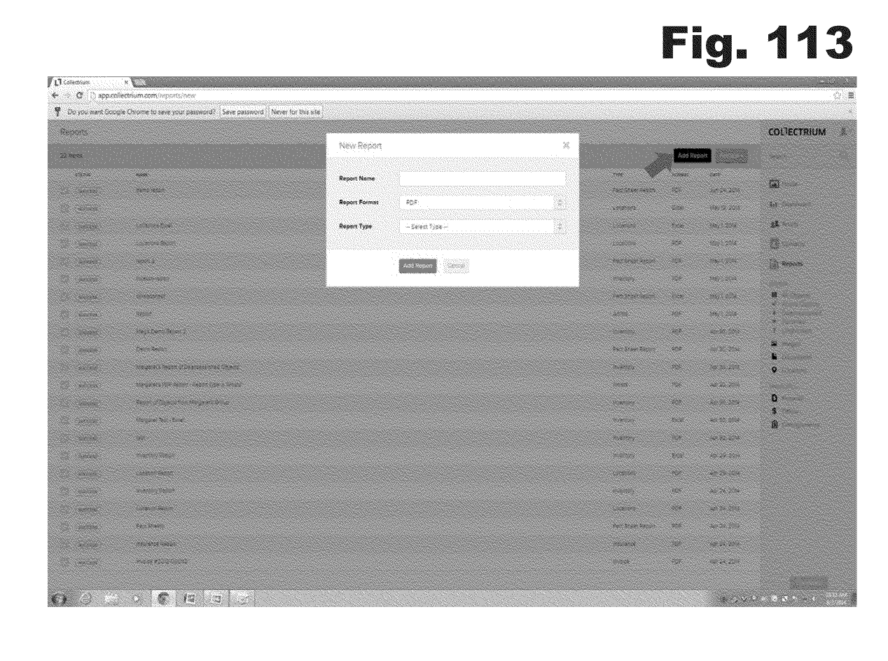

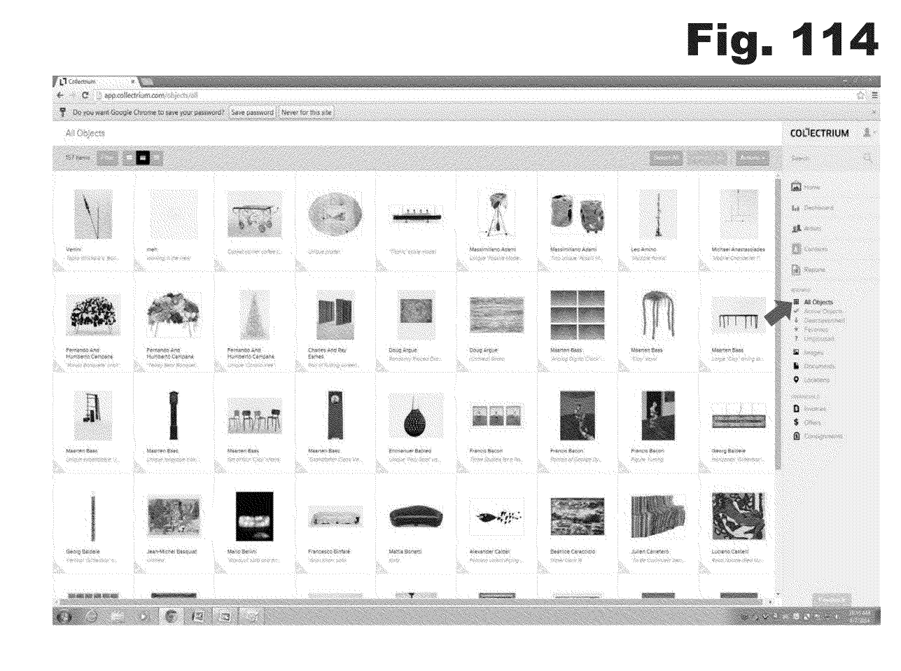

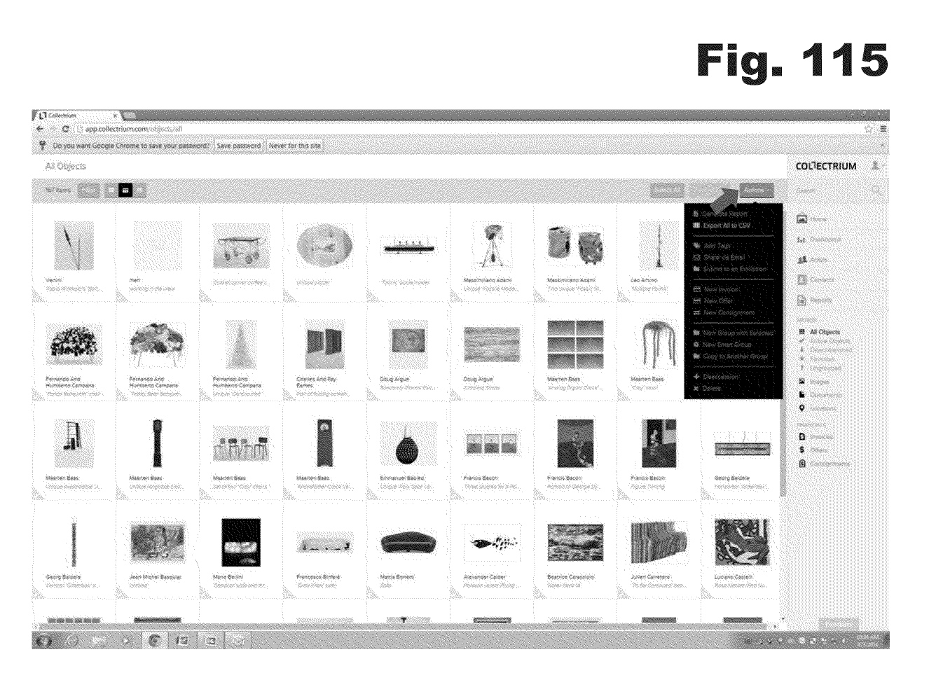

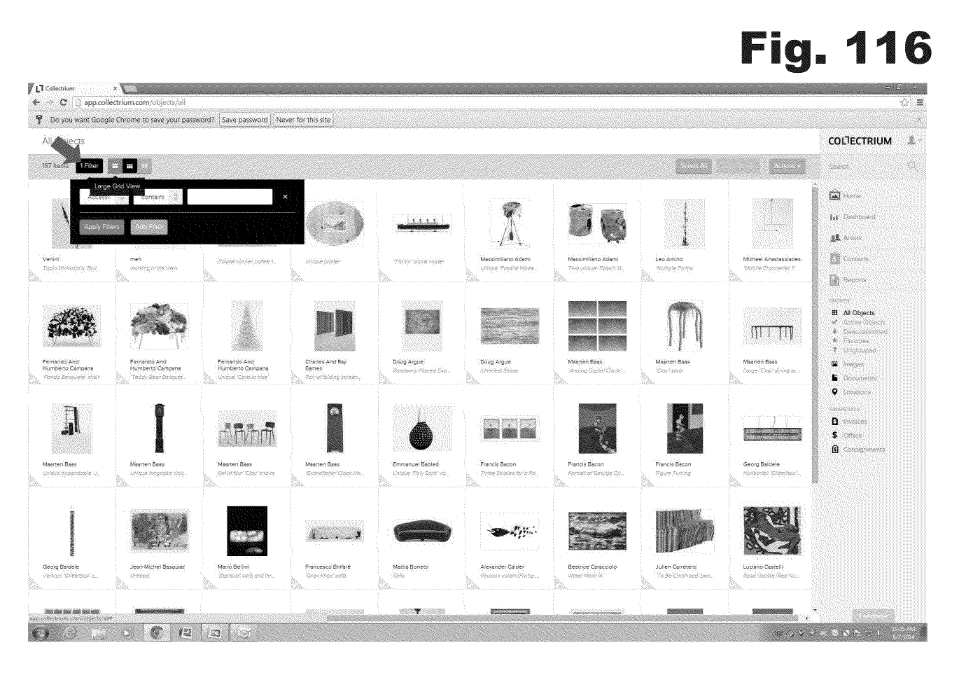

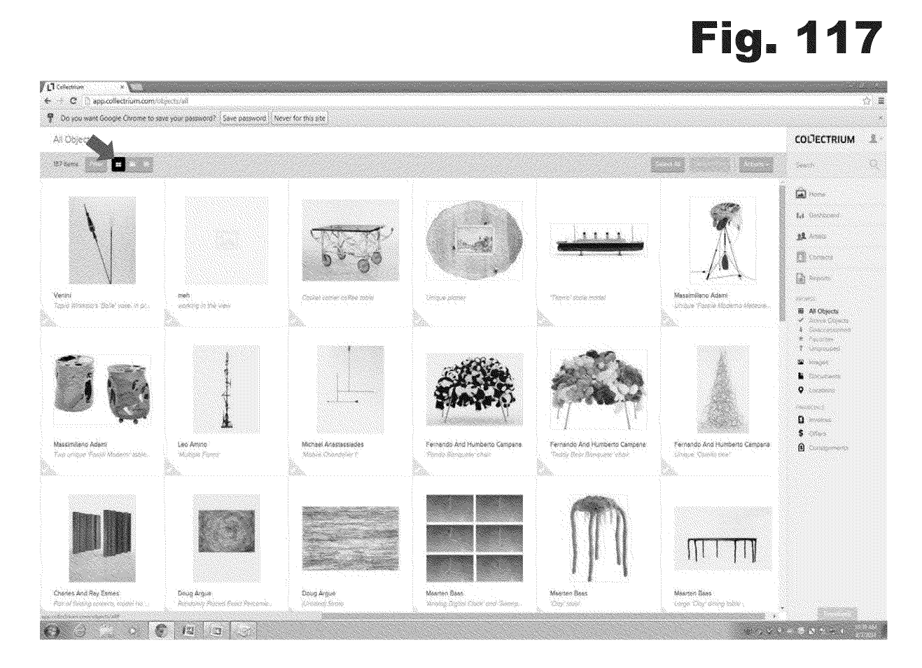

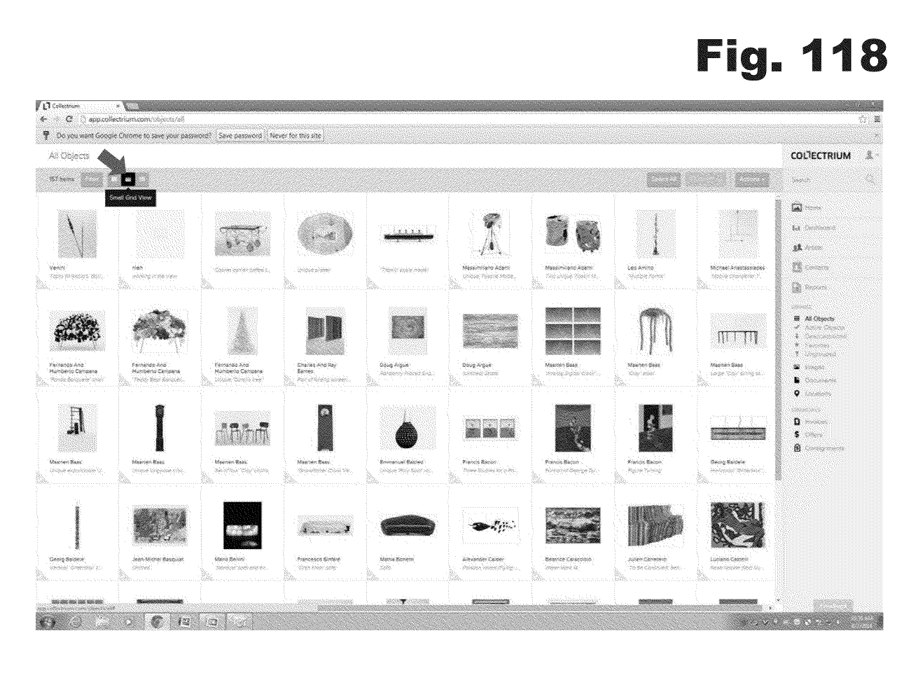

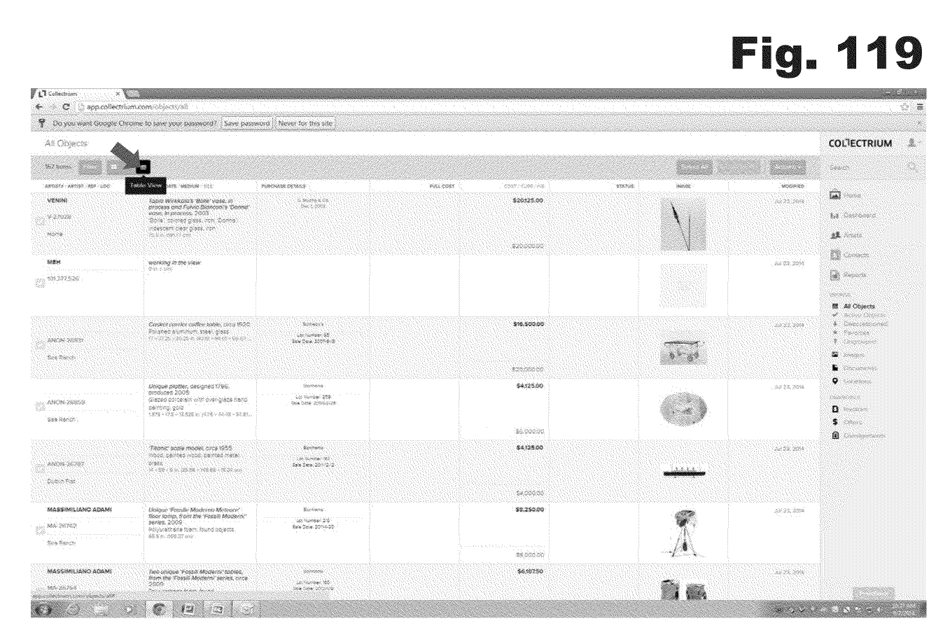

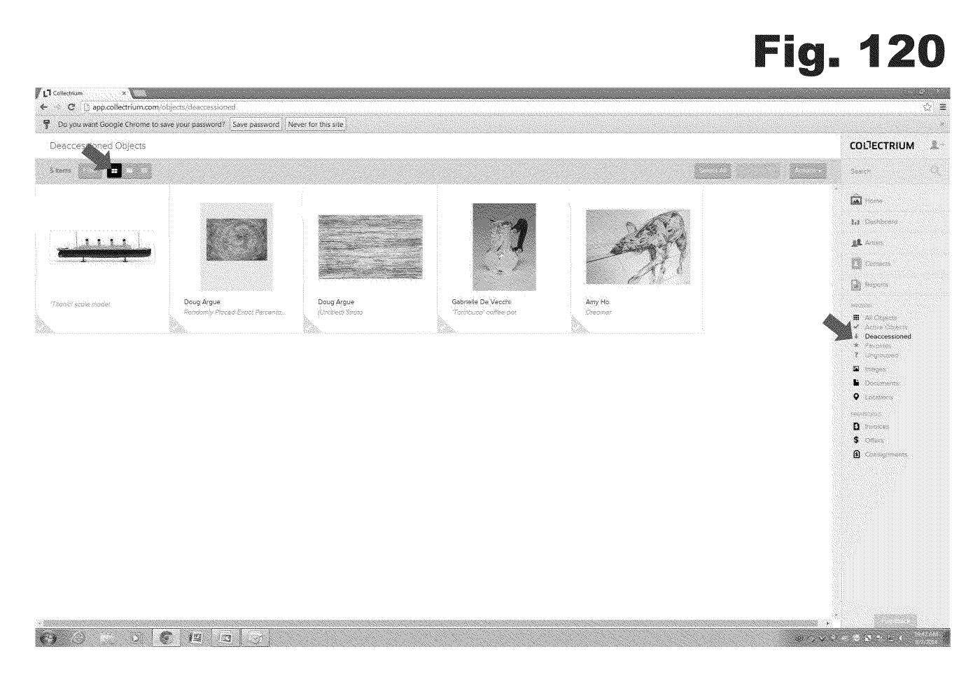

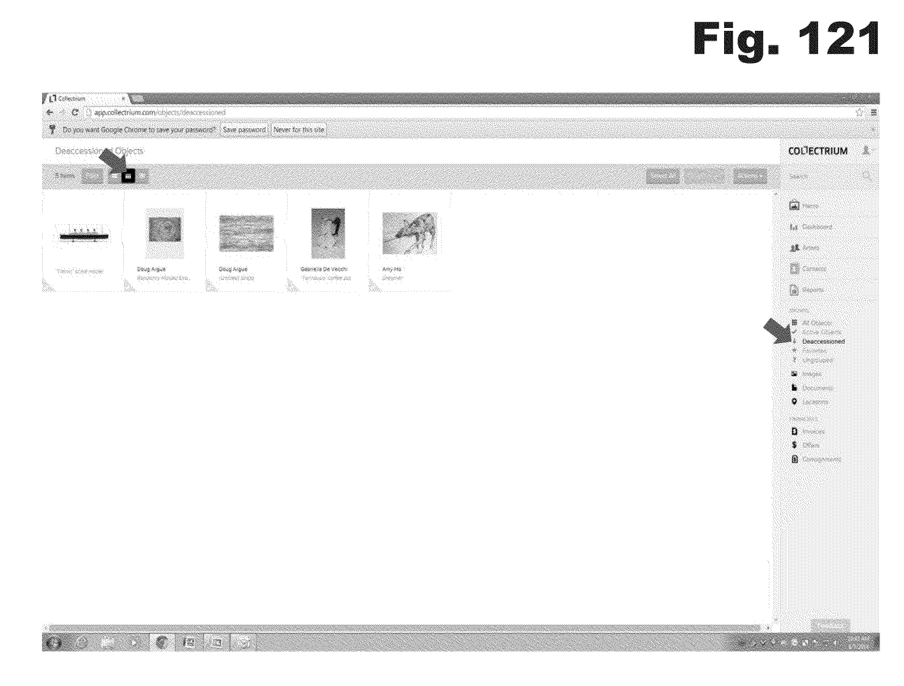

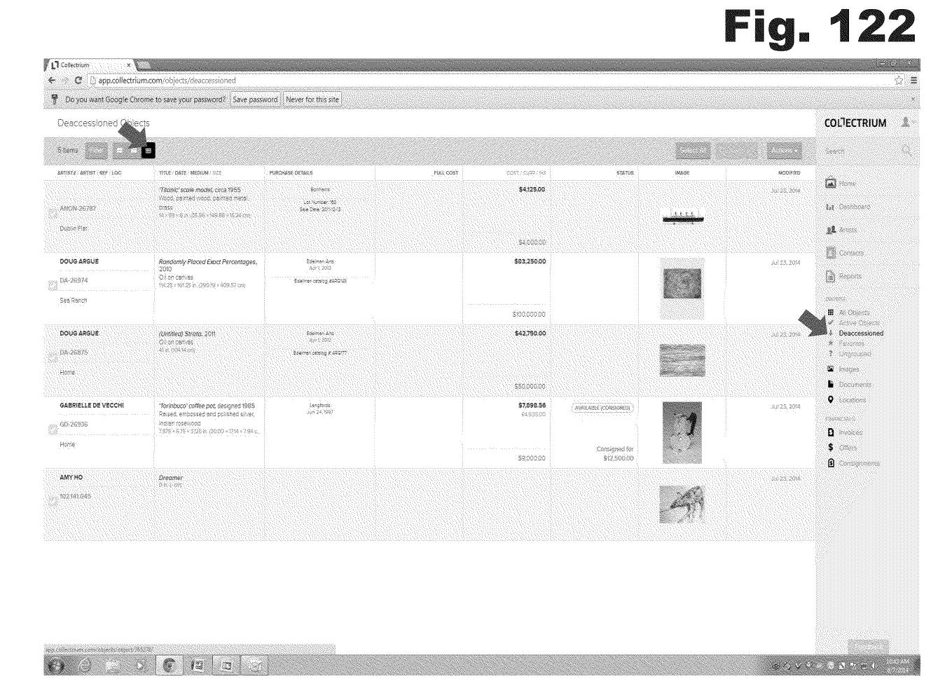

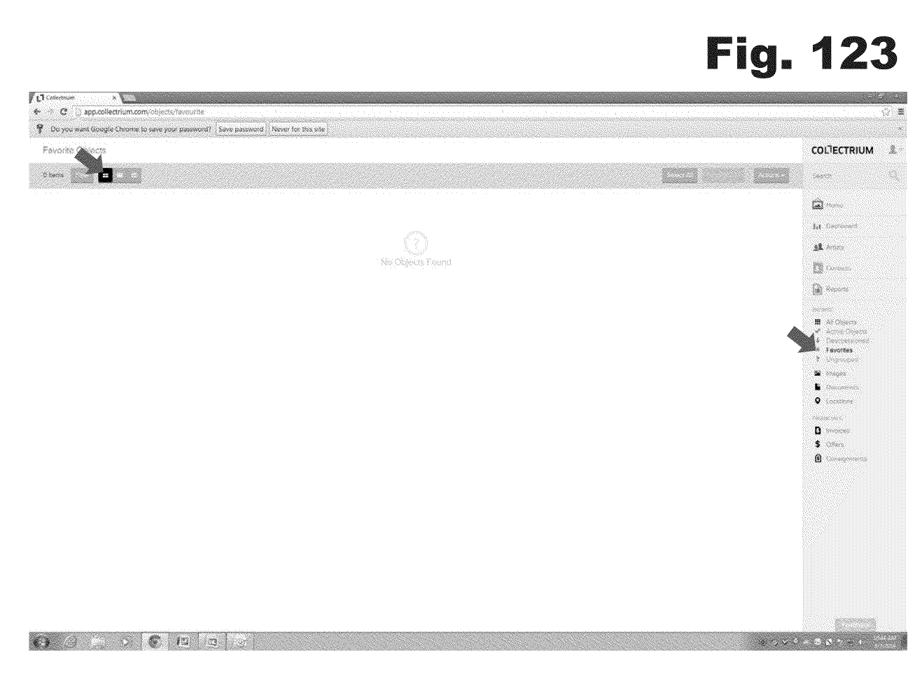

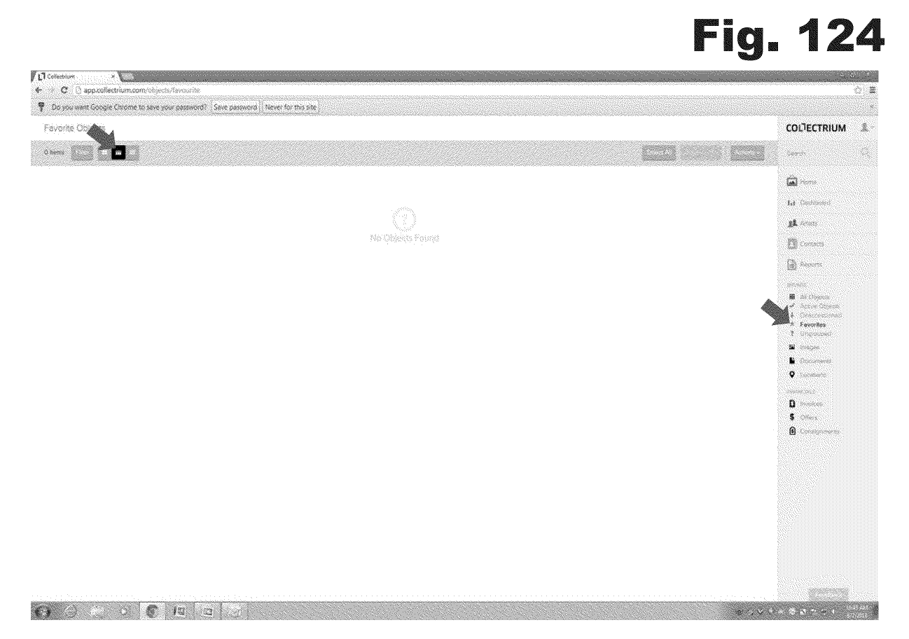

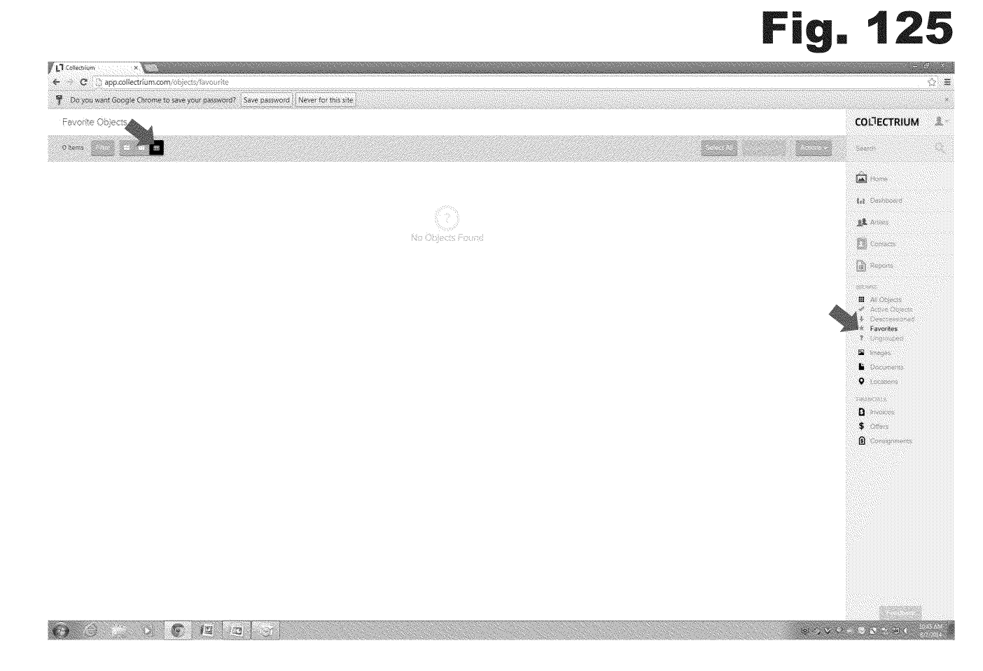

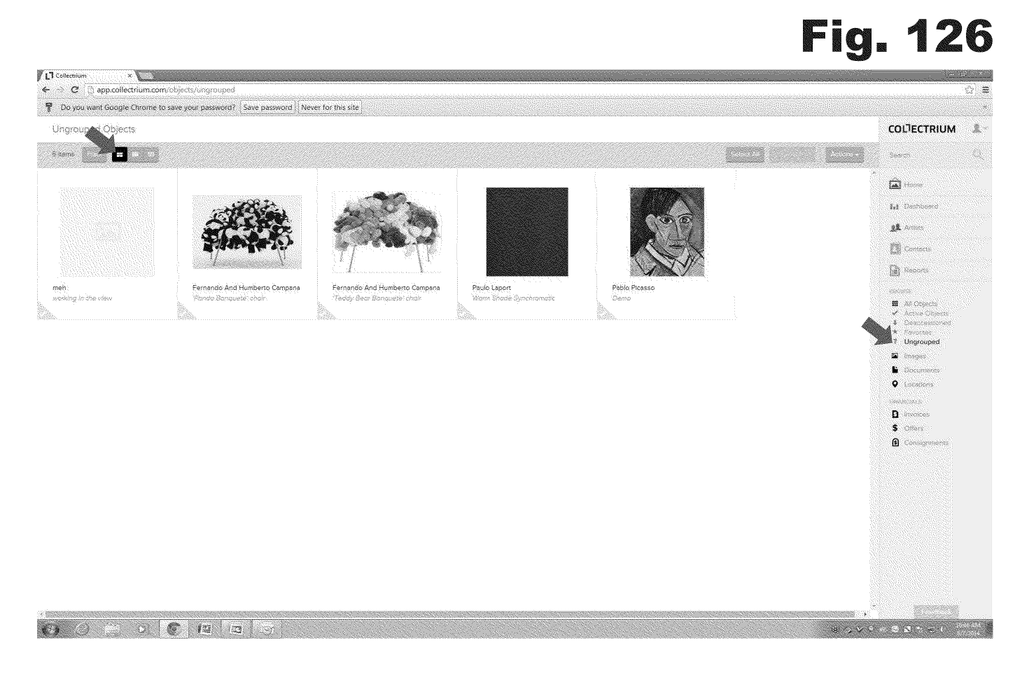

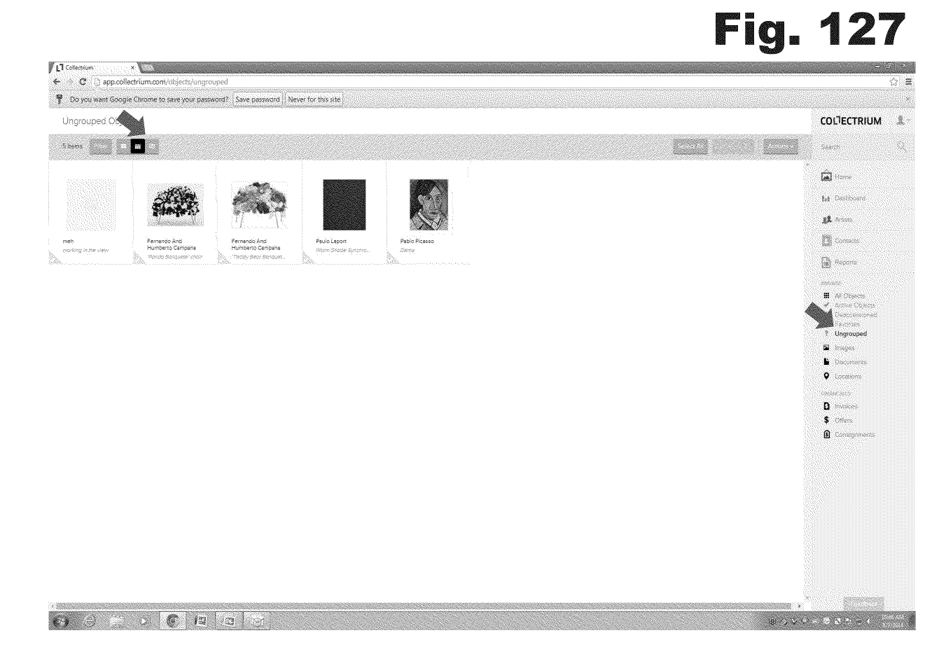

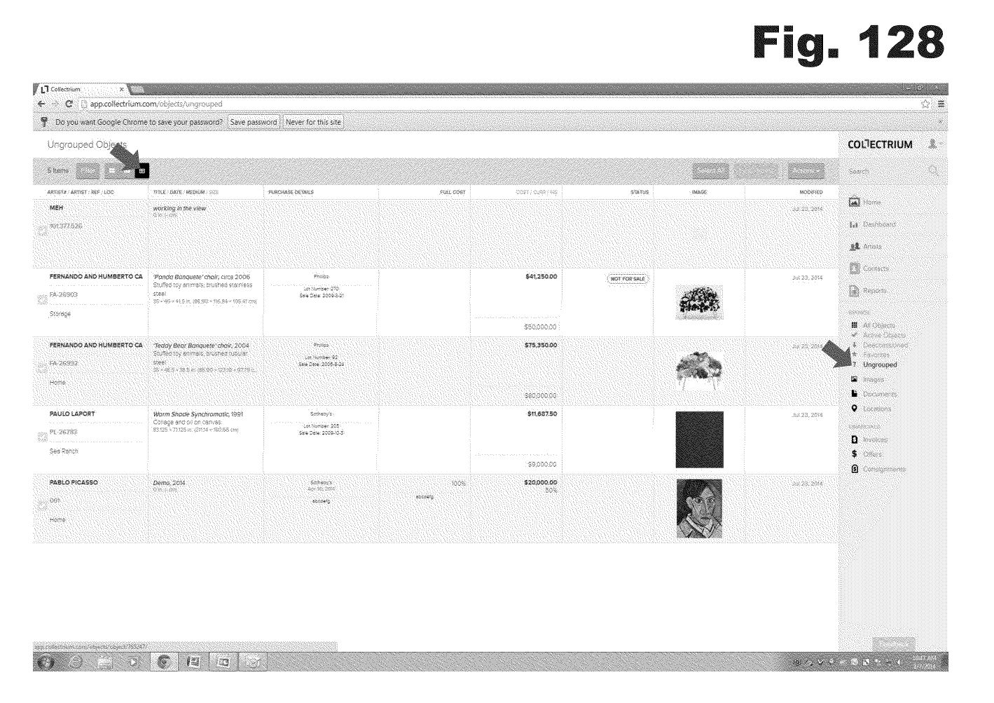

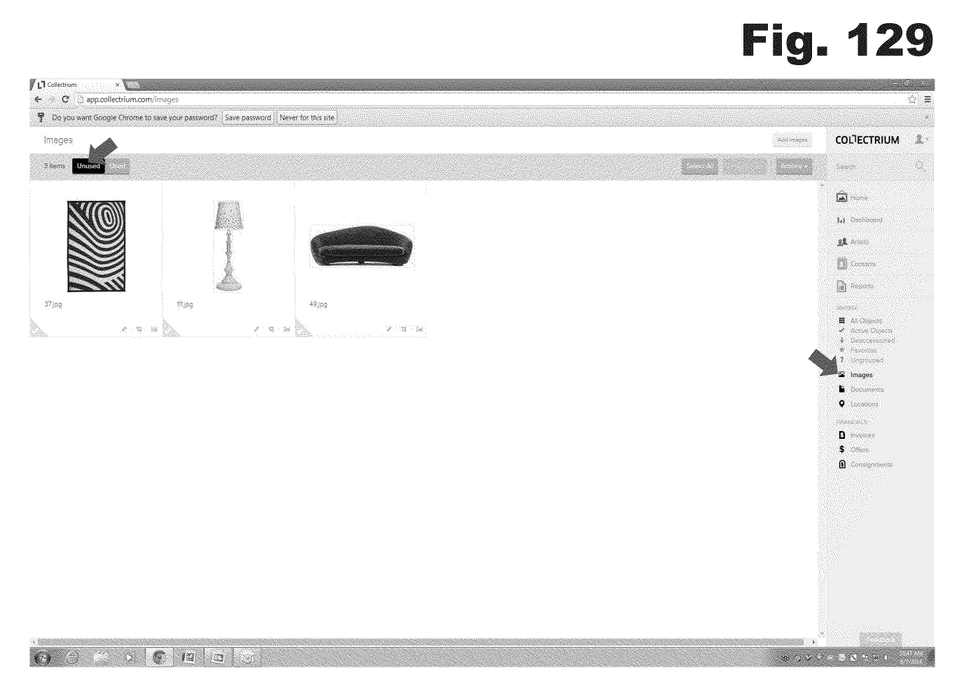

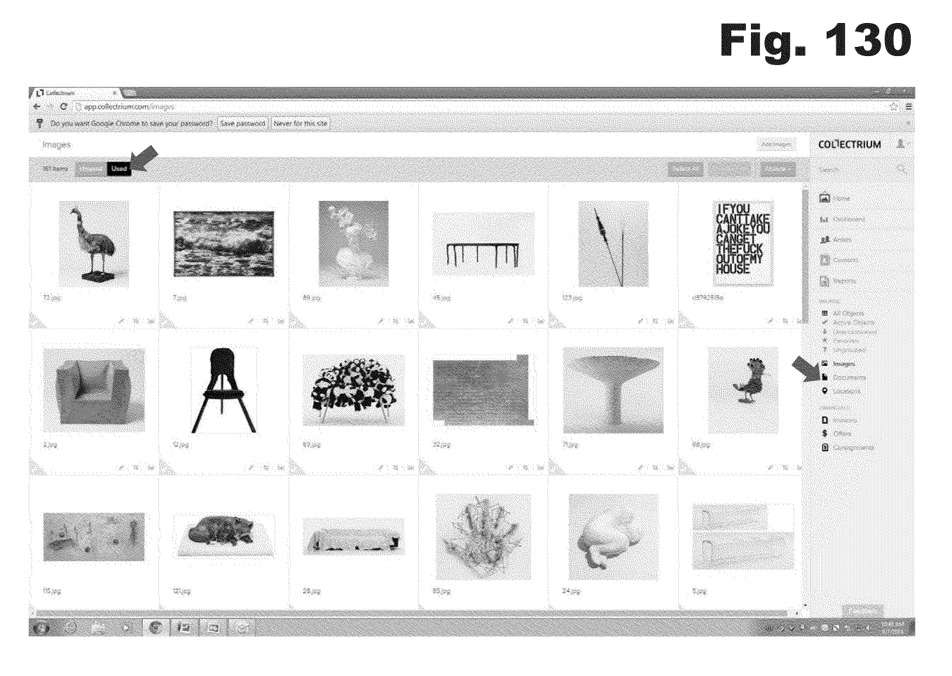

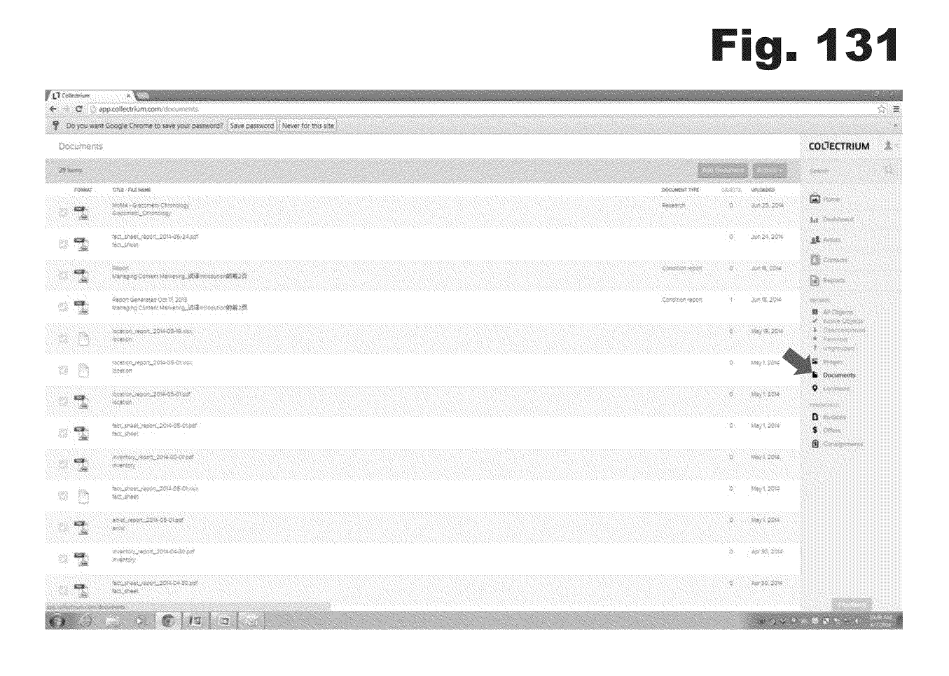

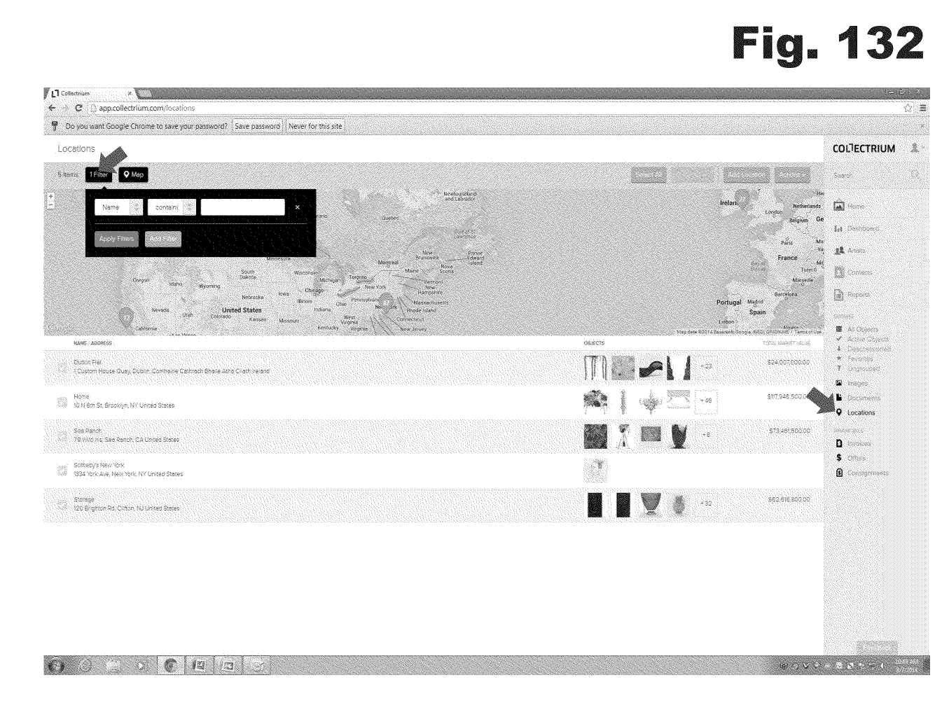

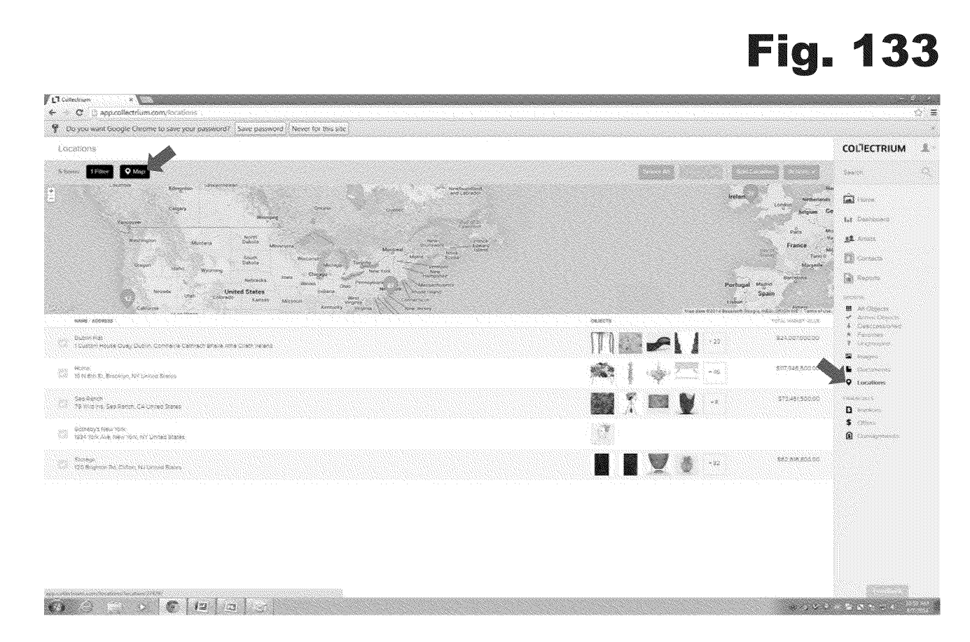

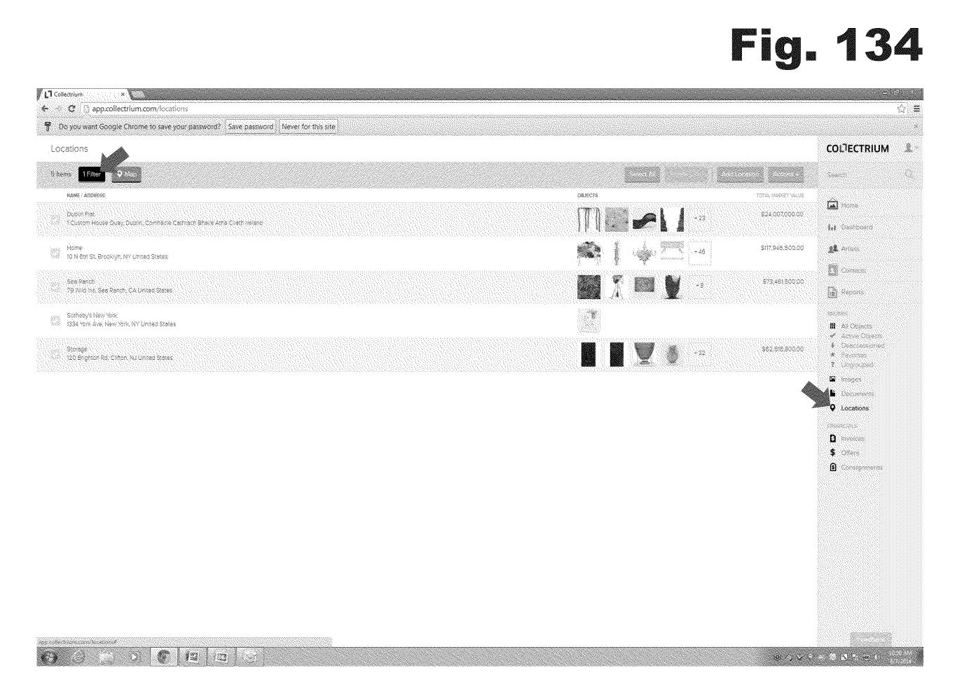

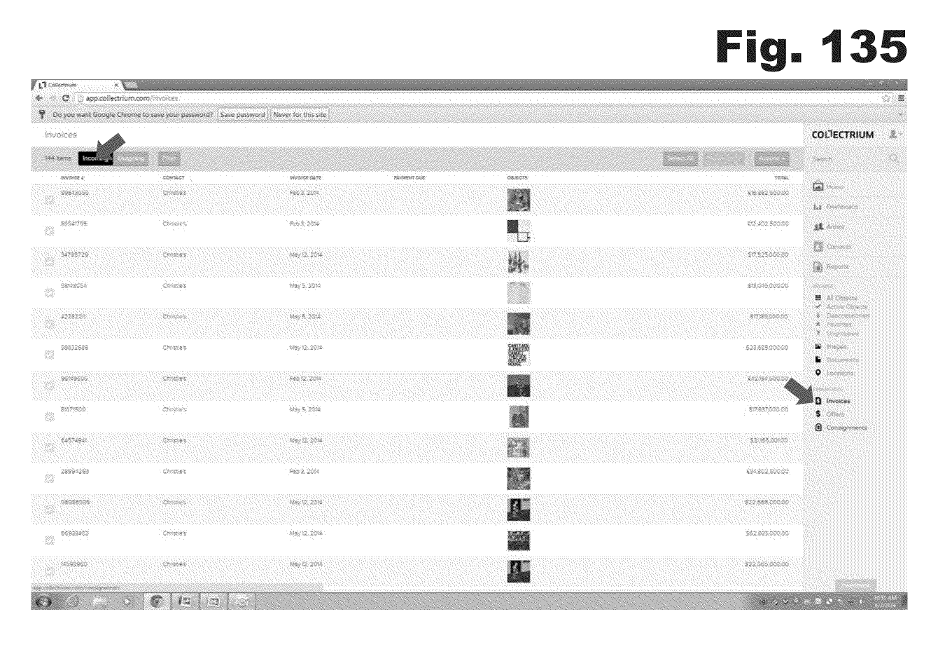

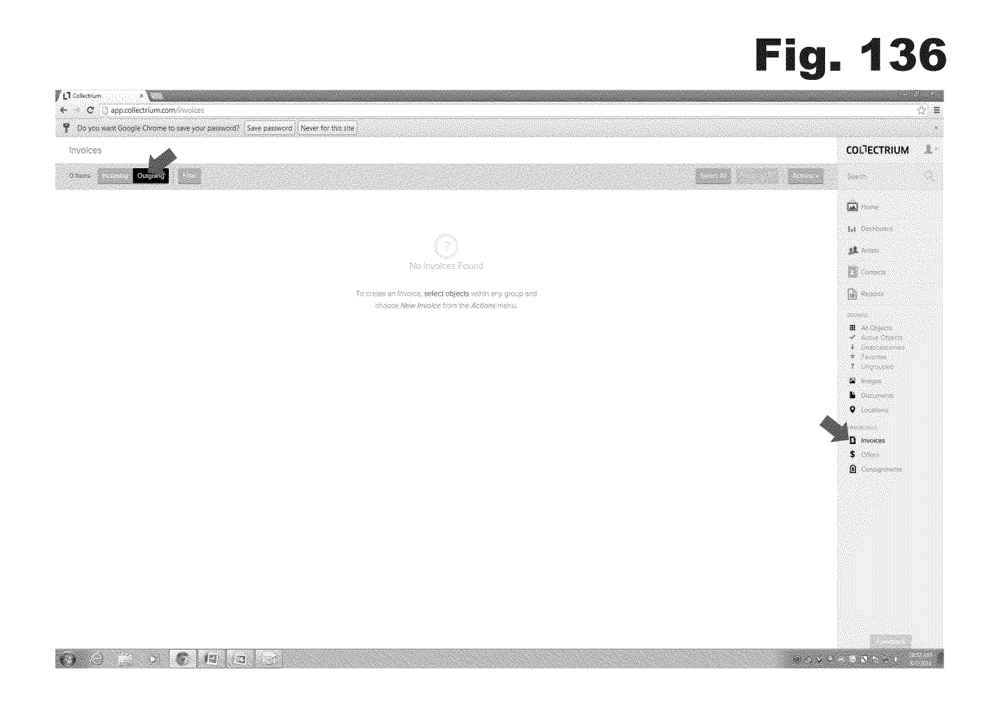

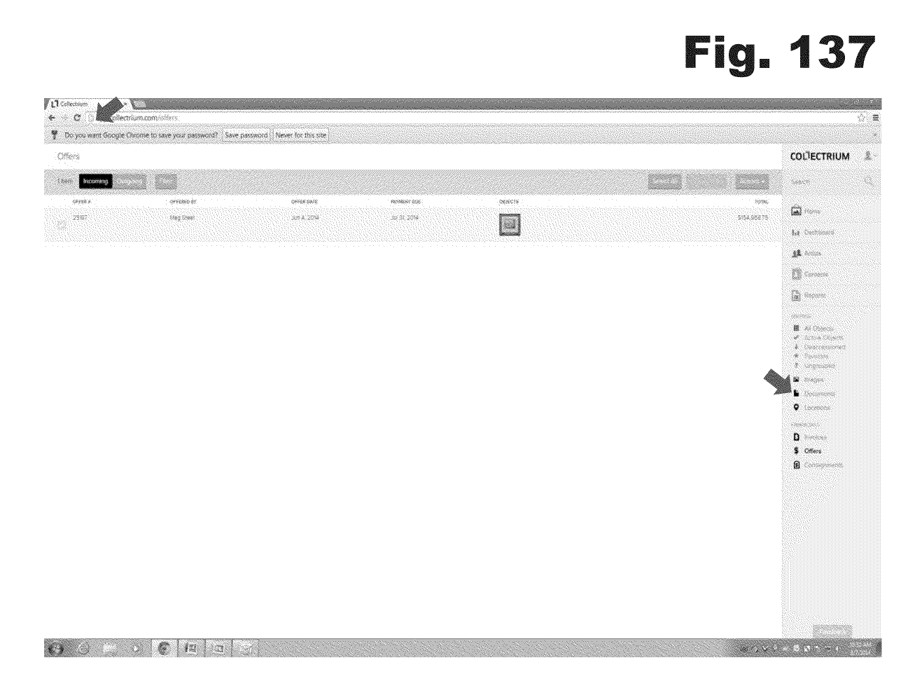

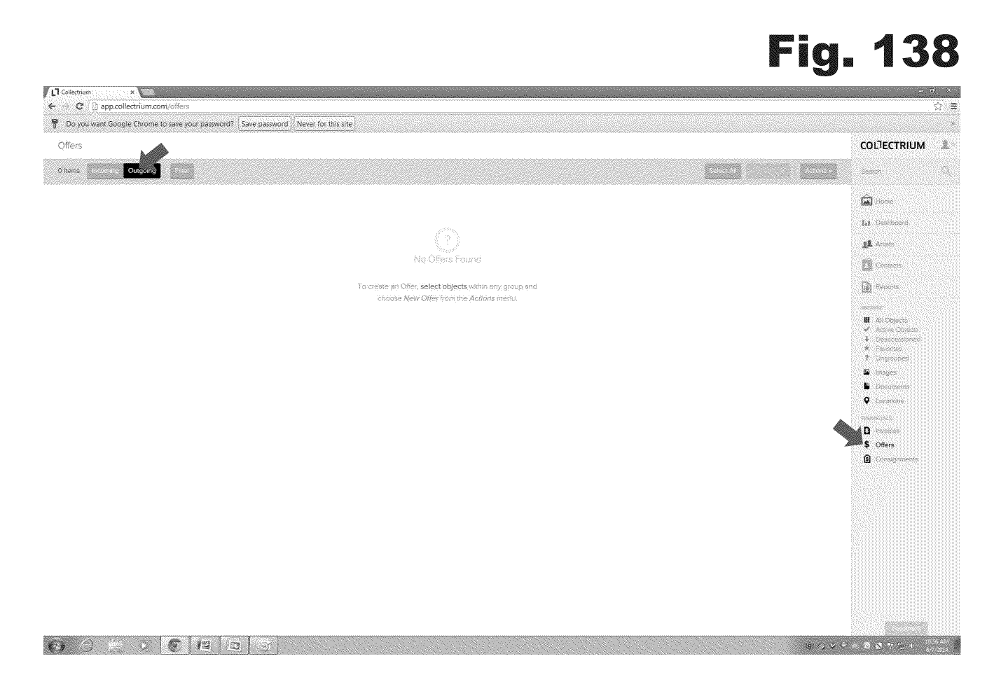

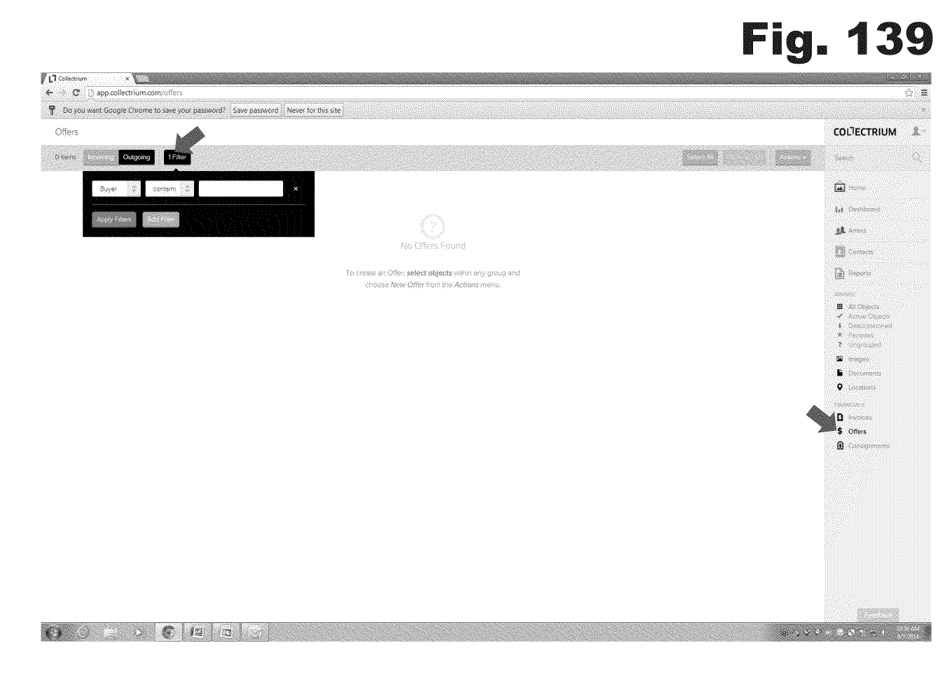

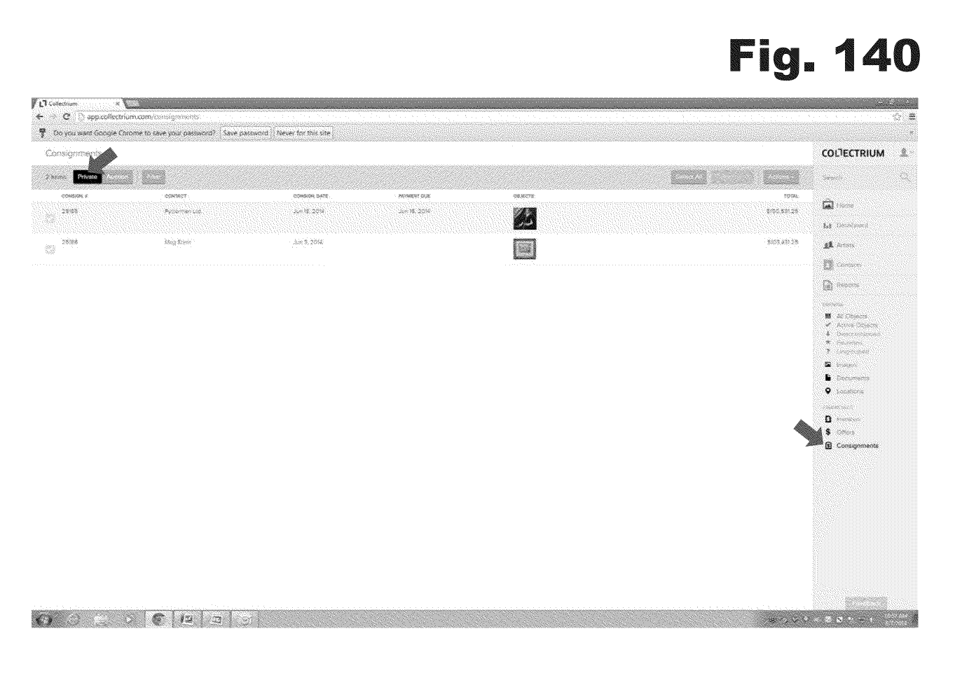

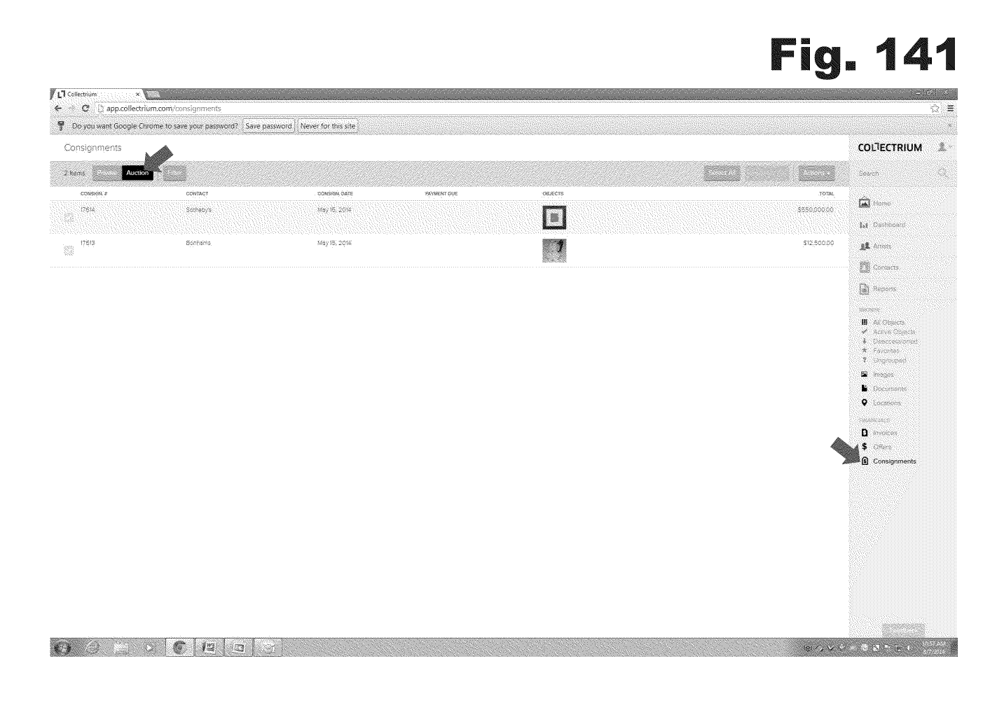

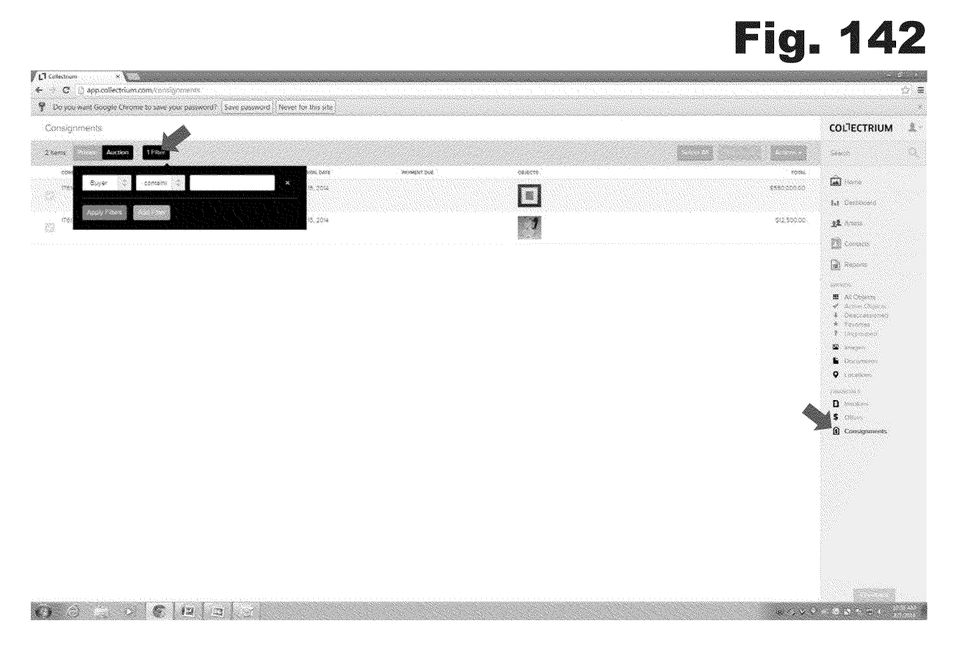

FIG. 40 is simply another view of the device, showing the art work and label on the screen;

FIG. 41 is an illustration of the system software's home page, organized by common attributes;

FIG. 42 is a view similar to that of FIG. 41, wherein the “Groups” menu choice has been clicked and the art work groupings are shown along the left side of the screen;

FIG. 43 is a view similar to that of FIG. 41, wherein the menu items are more clearly discernable;

FIG. 44 is an illustration wherein a particular work of art Senza Titolo No. 1 (1989) has been selected by the user, but where this selected work of art is merely representative of any work that the user may select;

FIG. 45 illustrates the user virtually placing the selected work of art on a real wall of a room within which the user is located, thereby trying out how to the eye of the user the work would look on that wall;

FIG. 46 illustrates the system's user selecting a virtual frame for the work of art from a frame collection in the database;

FIG. 47 illustrates the system's user manually changing the size of the virtual framed work on the wall image, via spreading/contracting the thumb and forefinger, it being emphasized that in addition to this technique of manually sizing, the system of this invention contemplates relatively “automatic” sizing by way of the use of a tag (or marker, illustrated and described in more detail below) and/or by use of camera trigonometric ratios and triangulation (knowing the distance to the wall, the height, and the tilting of the camera);

FIG. 48 illustrates the finally framed and sized virtual image of the work on the room wall, with an ability of the user to capture that image for transmittal via email or other social media to persons of interest, such as a client Collector;

FIG. 49 is another view of the finally framed and sized virtual image of the work virtually “installed” on the wall;

FIG. 50 is a photograph of a tag (or marker) of known size, referred to with respect to FIG. 47, within the view of the iPad Mini's camera;

FIG. 51 is an illustration of a system user virtually placing an art work image onto a “camera roll” image of a wall that has been stored in the user's database, thereby virtually “hanging” the semi transparent image of the work (to aid in more accurate placement and its visualization) while simultaneously in real time compensating for the viewing angle of the wall through camera tilting, providing a perspective view of the art image, and allowing ambient conformity or coordination of the virtual work's image with its virtual surroundings;

FIGS. 52 through 60 provide illustrations of the use of tags (markers) in accordance with the virtual gallery features of the system of the present invention.

FIG. 52 is another illustration of the home screen of a beta version of the system software according to the present invention, with a menu item “Virtual Gallery” shown;

FIG. 53 illustrates the Virtual Gallery having been selected by the user by clicking on that item, and with the system user placing a tag on the wall within the field of view of the iPad Mini's camera;

FIG. 54 illustrates the system's “recognition” of the tag of FIG. 53 by the invention system, and its putting a “place holder” onto that tag, which is signaled to the user by a change in the screen's image from that of the tag to the place holder; FIG. 54 also illustrates the user's thumb in the process of its selecting an image of a work of art from the system's database collection;

FIG. 55 illustrates the user having slid a thumbnail image of a stored work of art from the bottom of the screen to and over the place holder on the iPad Mini's screen, such that a larger more clear image of the art work now occupies the place formerly held by the place holder; both the thumbnail image of the selected art work and its larger centrally located image on the iPad's screen can be seen in FIG. 55, thus further illustrating a keying or assignment of that work's image to the tag in question;

FIG. 56 illustrates the system user's ability to now frame the selected art work from a database inventory of frames, shown along the bottom of the iPad screen;

FIG. 57 shows the iPad screen with the art work framed and scaled in size, due to knowledge of the tag's dimensions;

FIG. 58 illustrates an application of what will be referred to here as “Augmented Reality,” which denotes a virtual placing of a dynamically framed an art work on the location of a wall where a tag has been placed, thereby permitting the user to view and photograph the virtual image for real time use or later use by the user and/or an Agent working with her client/Collector;

FIG. 59 illustrates a system user clicking on a camera icon in order to record the augmented reality virtual image of the art work on the wall, as described above;

FIG. 60 illustrates the dynamically virtually framed image resulting from “smart framing.”

### The System's Website & Its Navigation

FIGS. 61 through 141, inclusive, are presented in a form that permits the reader to virtually “browse” the Website associated with the present invention, in much the same way a user may do so. To facilitate this, screen shots are provided with bold red arrows that point to “buttons” or “tabs” on the computer screen, such that the next successive Fig. will illustrate the result of pressing that button or tab. This has been done in order to overcome the restrictions on how the U.S. Patent & Trademark Office would like to see the content of patent applications presented. With this in mind, the reader is invited to the list of the figure descriptions, for specific information as how any of the Figs. presented was arrived at.

The system according to the present invention contemplates variations and embodiments other than the examples provided herein which come within the spirit and scope of our invention, and it is not to be improperly or unduly limited.

1. A mobile-enabled secure, interactive, scalable, multi-platform method capable of managing, organizing, seeking, discovering, sharing, evaluating and/or promoting unique art objects, and the like, and interconnecting members of the art world, such as, without limitation, artists, galleries, museums, collectors, art fairs, and art organizations, the method comprising one or more steps which include: visually identifying through recognition from a database one or more works of art utilizing a mobile device.

2. A mobile-enabled secure, interactive, scalable, multi-platform method of managing, organizing, seeking, discovering, sharing, evaluating and/or promoting unique art objects, and the like, and interconnecting members of the art world, such as, without limitation, artists, galleries, museums, collectors, art fairs, and art organizations, the method comprising one or more steps which include: visually identifying through recognition from a database one or more works of art utilizing a mobile device, and providing the user of the mobile device with a virtual label carrying a predetermined amount of data related to a work of art.

3. The method of claim 2, further comprising the provision of user ability to click on either the image of the work or the virtual label to call up more detailed information relating to the work of art than provided by the label.

4. The method of claim 2, further comprising the provision of user ability to capture said recognized image and label for current or future use.

5. A mobile-enabled secure, interactive, scalable, multi-platform method of managing, organizing, seeking, discovering, sharing, evaluating and/or promoting unique art objects, and the like, and interconnecting members of the art world, such as, without limitation, artists, galleries, museums, collectors, art fairs, and art organizations, the method comprising one or more steps which include: visually identifying through recognition from a database one or more works of art utilizing a mobile device, providing the user of the mobile device with a virtual label carrying a predetermined amount of data related to a work of art, providing the user with the ability to capture said recognized image and label for current or future use, and providing the user with the ability to store the captured information via a cloud-based database.

6. The method of claim 5, further comprising the provision of user ability to transmit said information to others via email or social media.

7. The method of claim 5, further comprising the provision of user ability to save to “Favorites” said captured information.

8. A mobile-enabled secure, interactive, scalable, multi-platform method of managing, organizing, seeking, discovering, sharing, evaluating and/or promoting unique art objects, and the like, and interconnecting members of the art world, such as, without limitation, artists, galleries, museums, collectors, art fairs, and art organizations, the method comprising one or more steps which include: visually identifying through recognition from a database one or more works of art utilizing a mobile device; and providing the user with the ability to virtually place the recognized image upon a real wall in real time.

9. The method of claim 8, further comprising the provision of user ability to create a virtual gallery by virtually placing the recognized image upon a virtual wall obtained from a camera roll database image.

10. The method of claim 8, further comprising the provision of user ability to manually size the image of the art work on the mobile device.

11. The method of claim 8, further comprising the provision of user ability to automatically size the image of the art work on the mobile device through use of a tag of predetermined size related to sizes of works.

12. The method of claim 8, further comprising the provision of user ability to automatically size the image of the art work on the mobile device utilizing camera trigonometric triangulation.

13. The method of claim 8, further comprising the provision of user ability to manually create a virtual perspective of the image.

14. The method of claim 8, further comprising the provision of user ability to automatically create a virtual perspective of the image via tilting of the remote device's camera.

15. The method of claim 8, further comprising the provision of user ability to blend in a coordinated manner the captured image with a virtual ambient background environment.

16. The method of claim 8, further comprising the provision of user ability to create an augmented reality in the form of a virtual gallery.

17. The method of claim 8, further comprising the provision of user ability to manually create framing of the captured art work image, choosing from a plurality of virtual frames stored in a cloud-based database.

18. The method of claim. 8, further comprising the provision of user ability to utilize relatively smart framing of the captured art work image, choosing from a plurality of virtual frames stored in a cloud-based database.

19. The method of claim 8, further comprising the provision of user ability to instantaneously in real time size the work.

20. A mobile-enabled secure, interactive, scalable, multi-platform method of managing, organizing, seeking, discovering, sharing, evaluating and/or promoting unique art objects, and the like, and interconnecting members of the art world, such as, without limitation, artists, galleries, museums, collectors, art fairs, and art organizations, the method comprising one or more steps which include: visually identifying through recognition from a database one or more works of art utilizing a mobile device, utilizing a tag or marker of predetermined size capable of being temporarily placed on a wall, linking an art work with the tag through a database, and providing a place holder function on the mobile device upon recognition of the tag.

21. The method of claim 20, further comprising the provision of user to experience augmented reality in the form of dynamically placing a virtually framed work on a virtual wall.

22. The method of claim 20, further comprising the provision of automatic mirroring between the mobile device and a cloud-based database, through synchronized data transfer.

23. The method of claim 20, further comprising the provision of user ability to on the fly in real time add objects to a database using a mobile device camera in front of a work of art.

24. The method of claim 20, further comprising the provision of user ability to select objects from any location.

25. The method of claim 20, further comprising the provision of user with ability to place art in any location or move art between locations.

26. The method of claim 20, further comprising the provision of user ability to reasonably accurately estimate the size of the work of art.

27. The method of claim 20, further comprising the provision of user ability to accomplish same with multiple objects.

28. The method of claim 20, further comprising the provision of user ability to arrange objects independently of one another.

29. The method of claim 20, further comprising the provision of user ability to interactively communicate data in real time with others such as agents, collectors, gallery representatives, or specialists.

30. The method of claim 20, further comprising the provision of user ability to know the location of a system user with a mobile device through use of GPS or other geo-locating means.

31. The method of claim 20, further comprising the provision of user ability to dynamically and interactively communicate data with a specialist, or the like.

32. The method of claim 20, further comprising the provision of user ability to virtually rotate images of 3D objects.

33. The method of claim 20, further comprising the provision of user ability to track the location of objects.

34. The method of claim 20, further comprising the provision of user ability to access financial and market information or summaries which identify the artist, provide market values, auction results, exhibition data, news, artist biographical, and an historical time line of prior acquisitions, useful from a financial standpoint in addition to general information for enabling calculation of market value and/or insurance value.

35. The method of claim 20, further comprising the provision of user access to automatic currency conversions based upon the time of transaction, including to a home currency.

36. The method of claim 20, further comprising the provision of user ability to search for art objects using one or more filters.

37. The method of claim 20, further comprising the provision of white labeling in a form which permits customized private labeling.

38. The method of claim 20, further comprising the provision of user ability to work with multiple or a plurality of collections, such as would be associated with art fairs.

39. The method of claim 20, further comprising the provision of use of comparables or unique use parameters helpful in arriving at financial estimates of value.

40. The method of claim 38, wherein the images themselves of the works of art may be used as a comparable parameter.

41. The method of claim 20, further comprising the provision of a constantly updating database that is inherently private and confidential.

42. The method of claim 20, further comprising the provision of user ability to create a collector profile based upon the identification of the types of art works viewed and/or acquired over time, as well as the real world tastes of the collector.

43. A business method of providing a secure, interactive, scalable, multi-platform cloud-based system for managing, organizing, seeking, discovering, sharing, evaluating and/or promoting unique art objects, and the like, and interconnecting members of the art world, such as, without limitation, artists, galleries, museums, collectors, art fairs, and art organizations, the system utilizing Web-enabled devices, comprising, in combination, the steps of:
establishing client-definable content relevant to users who are equipped with a smartphone or other Web-enabled communication device, said content designed to be presented in a user visual experience which will induce an anticipated user reaction,
said user visual experience including multi-dimensional visual media having a visual media tag area,
providing a visual tag capable of being mounted on a surface,
recognizing the visual tag utilizing software in combination with a database of stored information,
locating the content on a Web server,
enabling a reaction from the user upon the user's viewing said content, said reaction including using said Web-enabled communication device to communicate with others, and
establishing a real time interactive linking of the user's device to said server via a pre-programmed built-in device browser app,
said real time interactive linking providing the user with access to a Web app on said client Web server, thereby enabling a user-controlled response,
said real time interactive linking thereby facilitating the consummation of a user-driven response.
